(19) United States
(12) Patent Application Publication
(10) Pub. No.: US 2026/0275150 A1
(43) Pub. Date: Sep. 17, 2026

(54) ROMP AND THERMAL INSULATION COMPOSITIONS AND MATERIALS AND USE THEREOF

(71) Applicant: MATERIA, INC., Pasadena, CA (US)

(72) Inventors: Andrew NICKEL, South Pasadena, CA (US); Leanna Columbia ST. ANGELO, Temple City, CA (US); Daryl Paul ALLEN, Pasadena, CA (US); Brian Joseph ROHDE, Houston, TX (US); Edzna S. GARCIA, Pasadena, CA (US)

(21) Appl. No.: 19/167,630

(22) PCT Filed: Mar. 21, 2024
(86) PCT No.: PCT/US2024/020862

§ 371 Date: Sep. 22, 2025

Related U.S. Application Data
(60) Provisional application No. 63/491,437, filed on Mar. 21, 2023.

(51) Int. Cl. C09D 145/00; C09D 4/06; C09D 7/65; F16L 59/02

(52) U.S. Cl. CPC C09D 145/00; C09D 4/06; C09D 7/65; F16L 59/02

(57) ABSTRACT

The invention relates to ROMP compositions, ROMP polymers, ROMP polymer composites, and thermal insulation materials and methods for thermally insulating pipelines and associated equipment, structures, and objects used in offshore drilling. The invention relates to articles of manufacture comprising the ROMP compositions, ROMP polymers, ROMP polymer composites, and thermal insulation materials.

### CROSS REFERENCE TO RELATED APPLICATIONS

The application claims the benefit of U.S. Provisional Patent Application No. 63/491,437, filed Mar. 21, 2023, the entire contents of which is incorporated herein by reference.

### TECHNICAL FIELD

The invention relates to the field of insulated pipelines and structures, particularly to the field of subsea pipelines and structures. More particularly, the invention relates to ring opening metathesis polymerization (ROMP) compositions, and ROMP polymers, ROMP polymer composites, and thermal insulation materials thereof for insulating subsea oil production equipment, particularly subsea pipelines and structures. The invention also relates to methods of using such ROMP compositions. ROMP polymers, ROMP polymer composites, and thermal insulation materials to insulate offshore oil production equipment and structures, and articles of manufacture comprising such ROMP compositions, ROMP polymers, ROMP polymer composites, and thermal insulation materials.

### BACKGROUND

Offshore oil production requires the transportation of hydrocarbons from wellheads positioned underwater to shore or other surface equipment for further distribution. As temperature decreases the resistance to flow of liquids such as oil increases. Pipelines used in the transportation of oil from the underwater wellheads are generally insulated to avoid a substantial decrease in the temperature of the oil. Moreover, the underwater environment exposes pipelines and other oil production equipment to compressive forces, salt water corrosion, near-freezing water temperatures, possible water absorption, undersea currents, and marine life. Most pipes and pipelines used in offshore oil production are constructed of metal, typically some grade of steel.

Installation conditions for subterranean and subsea pipelines and equipment tend to be demanding. As such, it is possible that the material used to thermally insulate offshore production equipment and pipelines, including but not limited to subterranean pipelines and equipment as well as subsea pipelines and equipment may become damaged during installation of the pipeline. For example, during installation pipeline insulation undergo bending (flexural stress) due to pipe sag and reeling, particularly in what are commonly known as S-lay. J-lay, and reel-lay installation processes.

Desirable characteristics and/or properties of thermal insulation materials, in particular thermal insulation materials for subsea applications include: thermal stability above 150° C.; resistance to hydrolysis above 150° C.; flexibility greater than 5% elongation at break at 25° C.; fast cure times; low thermal conductivity; high impact strength; castable (high throughput with low capital expenditure cost); rigid for robust pipe handling without external protection; can be processed in air; can be applied in thick sections without multi-layering; can be applied to complex geometries; rapid full cure underproduction conditions; processable in the presence of trace moisture (water). Furthermore, there has been a need in the industry for thermal insulation materials, particularly thermal insulation materials for subsea applications (e.g., thermal insulation for pipe and pipelines and other subsea equipment and structures, such as coatings for field joints, etc.) that possess all of these desirable characteristics and/or properties. Thermal stability as used herein means that a material maintains its structural integrity when subjected to elevated temperatures.

Polyurethanes have been used for insulating subsea pipelines and equipment due to somewhat general ease in processing and generally good mechanical properties. However, polyurethane insulation may suffer from hydrolytic degradation when exposed to hot-wet environments. In offshore oil fields, particularly fields where the oil temperature is high at the wellhead, there is a possibility of hydrolytic degradation of the polyurethane polymer network, particularly at elevated temperatures where water is able to ingress the polymer network, which would negatively affect the insulation capabilities of the polyurethane polymer.

Polypropylene is another polymer material that is used to insulate subsea pipelines and equipment. However, unlike polyurethanes, the application of polypropylene is a more difficult process generally requiring extrusion of multiple layers. Additionally, polypropylene, such as isotactic polypropylene (iPP) used in polypropylene based insulation products, has a limited use temperature due to the upper limit in the melting point of the thermoplastic polymer. Thermoset polymers, such as pDCPD based thermosets, do not possess such melting point limitation potentially allowing for higher use temperatures.

Polystyrene is another polymer material that is used to insulate subsea pipelines and equipment. However, the relatively low glass transition of the thermoplastic limits the use temperature due to the proclivity of the material to flow above the glass transition. Thermoset materials, such as pDCPD based thermoset, may possess a glass transition, however due to the crosslinked nature of the thermoset, the material does not flow potentially allowing for higher use temperatures.

Another material used for insulating subsea pipelines and equipment is rigid epoxy syntactic foam, where hollow glass or ceramic spheres are combined with the epoxy resin. This material possesses good thermal conductivity, but suffers from being brittle and rigid, making this material susceptible to damage when exposed to high stress forces and/or sudden impacts. Moreover, these materials are difficult to remove and replace as they are attached to the surface mechanically or through the use of adhesives. Epoxy resin in general, in the absence of glass or ceramic microspheres, have poor thermal conductivity, generally require long cure cycles and also suffer from being brittle and rigid, as well as having other limitations. Additionally epoxy based materials are prone to significant water uptake, deleteriously impacting the insulating properties during subsea usage. Depending on the cure chemistry of the base epoxy, epoxy based materials may be prone to severe hydrolysis based degradation that limits the use life of the material.

Silicones and syntactic silicones where hollow glass microspheres are combined with the silicones are another polymer material that is used to insulate subsea pipelines and equipment, however, silicones and syntactic silicones may suffer from hydrolytic degradation when exposed to hot wet environments. Moreover, silicones generally require long cure cycles.

Phenolics are another polymer material that is used to insulate subsea pipelines and equipment; however, phenolics are generally difficult to apply to such objects. These materials also suffer from being brittle and rigid, making this material susceptible to damage when exposed to high stress forces and/or sudden impacts.

Another material for insulating subsea pipelines and equipment is elastomeric amine cured epoxy resins. While elastomeric amine cured epoxy resins may offer some advantages over polyurethanes, these materials possess several limitations, particularly in that at least two steps and specialized equipment are required to prepare such elastomeric amine cured epoxy resins. Moreover, these materials are viscous liquids (e.g., 90.000 cP at 25° C.), making the filling of complex molds difficult.

Rubber materials, including silicone rubber, are examples of other materials used to insulate subsea pipelines and equipment. These materials do not possess attractive thermal and mechanical properties, and generally require long cure cycles, as well as having other limitations.

Dicyclopentadiene polymer (pDCPD) prepared from Telene® 1650 DCPD resin is another example of a material that has been reported for use as a field joint coating material, however, this material (including similar materials such as Metton® DCPD resin and Pentam® DCPD resin) possess several limitations, which are well known in the art. Telene® 1650 DCPD resin (BF Goodrich/Telene SAS) and Metton® DCPD resin (Metton America/Hercules) are both based on a two component system comprising a molybdenum or tungsten pre-catalyst dissolved in DCPD monomer (B-component) and an aluminum alkyl or aluminum alkyl halide co-catalyst dissolved in DCPD monomer (A-component). These molybdenum and tungsten catalyzed DCPD resins are extremely sensitive to chemical functional groups and to air (oxygen) and moisture (water), even at trace levels. As a result of this sensitivity, such molybdenum and tungsten catalyzed DCPD resin are typically limited to being processed using Reaction Injection Molding (RIM) techniques, which require specialized and expensive processing and handling conditions and equipment, including specialized and expensive molds, injection equipment, and storage tanks. Moreover, as a further result of this sensitivity, particularly their sensitivity to chemical functional groups, such molybdenum and tungsten catalyzed DCPD resins are generally not suitable for use to prepare DCPD polymer composites.

Processing issues notwithstanding, pDCPD has many beneficial characteristics for use as subsea insulation materials such as resistance to hydrolysis, creep-resistance under hydrostatic pressure, fast cure times, low thermal conductivity, and high impact strength. However, pDCPD materials tend to be rigid and suffer from low flexibility, which can cause cracking during installation or in service.

In fact, commercially available DCPD monomer resins for use in molding of polymer articles typically contain between 0%-30% by weight of tricyclopentadiene, and lesser amounts of higher oligomers of cyclopentadiene such as tetramers and pentamers of cyclopentadiene (e.g., tetracyclopentadiene and pentacyclopentadiene).

Other ROMP polymer systems have also been described for use as subsea insulation materials. Copolymers of DCPD, TCPD, and cyclic olefin monomers containing monounsaturation have been described in U.S. Pat. No. 10,711,090. These materials are more flexible than copolymers of DCPD and TCPD and therefore are more suitable for subsea installation and service conditions. However, cyclic olefin monomers containing monounsaturation are costly to manufacture.

Therefore, despite the advances achieved in the art, there continues to be need for improvements in the materials, particularly polymer materials and/or polymer composite materials, used for thermally insulating pipelines and associated equipment and structures used in offshore oil production.

### SUMMARY

The invention addresses one or more of the aforementioned concerns and relates to ring opening metathesis polymerization (ROMP) compositions and ROMP polymers, ROMP polymer composites, and thermal insulation materials thereof, and methods for coating, encasing, and/or thermally insulating pipelines and associated equipment, structures, and objects used in offshore drilling. The invention also relates to articles of manufacture comprising the ROMP compositions, ROMP polymers, ROMP polymer composites, and thermal insulation materials of the invention.

More particularly, the invention relates to a ROMP composition comprising, consisting essentially of, or consisting of:
a) a cyclic olefin composition comprising, consisting essentially of, or consisting of at least one multiunsaturated cyclic olefin:
b) a catalyst composition comprising, consisting essentially of, or consisting of at least one metal carbene olefin metathesis catalyst:
c) optionally, at least one adhesion promoter;
d) at least one plasticizer compound; and
e) at least one rubber toughener compound,
wherein the cyclic olefin composition does not contain, or is substantially free of, a monounsaturated cyclic olefin,
wherein the at least one multiunsaturated cyclic olefin may be substituted or unsubstituted.

The invention also relates to a ROMP polymer or a ROMP polymer composite comprising, consisting essentially of, or consisting of a reaction product of the ROMP composition of the invention.

The invention also relates to the use of the ROMP polymer and/or the ROMP polymer composite for thermally insulating an object.

The invention also relates to the use of the ROMP polymer or ROMP polymer composite to thermally insulate an object from a surrounding environment.

The invention also relates to the ROMP polymer or ROMP polymer composite of the invention for use as thermal insulation materials.

The invention also relates to a process for providing a ROMP polymer coating for offshore applications, the process comprising, providing an object surface to be coated, providing the ROMP composition of the invention, contacting the object surface with the ROMP composition or applying the ROMP composition to the object surface, and subjecting the ROMP composition to conditions effective to polymerize the ROMP composition to form the ROMP polymer coating.

The invention also relates to a thermal insulation material comprising, consisting essentially of, or consisting of the ROMP composition, ROMP polymer, or ROMP polymer composite of the invention.

The invention also relates to a thermal insulation material for use in coating, encasing, or insulating (1) an object; (2) at least a portion of an object; and/or (3) at least a portion of at least one surface of an object, wherein the thermal insulation material comprises the ROMP composition, ROMP polymer, or ROMP polymer composite of the invention.

The invention also relates to the use of a thermal insulation material for coating, encasing, or insulating (1) an object; (2) at least a portion of an object; and/or (3) at least a portion of at least one surface of an object, wherein the thermal insulation material comprises the ROMP composition, ROMP polymer, or ROMP polymer composite of the invention.

The invention also relates to a method of thermally insulating an object from a surrounding fluid, the method comprising interposing a thermal insulation material between the object and the fluid where the thermal insulation material comprises the ROMP polymer or ROMP polymer composite of the invention.

The invention also relates to a method for coating, encasing, or insulating (1) an object: (2) at least a portion of an object; and/or (3) at least a portion of at least one surface of an object, with a thermal insulation material, wherein the thermal insulation material is the ROMP polymer or ROMP polymer composite of the invention.

The invention also relates to a method for coating, encasing, or insulating (1) an object: (2) at least a portion of an object; and/or (3) at least a portion of at least one surface of an object, with a thermal insulation material, comprising: contacting the ROMP composition of the invention with, or applying the ROMP composition of the invention to, (1) the object: (2) at least a portion of the object; and/or (3) at least a portion of at least one surface of the object; and subjecting the ROMP composition to conditions effective to promote a ROMP reaction of the ROMP composition to form the ROMP polymer or ROMP polymer composite of the invention, wherein the thermal insulation material is the ROMP polymer or ROMP polymer composite.

The invention also relates to a process for applying a thermal insulation material composition to an object, comprising: placing a mold around an object to define a cavity between an internal surface of the mold and the object; injecting a thermal insulation material composition in the cavity, wherein the thermal insulation material composition comprises the ROMP composition of the invention; and subjecting the thermal insulation material composition to conditions effective to promote a ROMP reaction of the ROMP composition to form the ROMP polymer or ROMP polymer composite of the invention.

The invention also relates to an object at least partially encased and/or coated by a thermal insulation material, where the thermal insulation material comprises the ROMP polymer or ROMP polymer composite of the invention.

The invention also relates to an article of manufacture comprising an object, wherein at least a portion of at least one surface of the object is coated with the ROMP polymer or ROMP polymer composite of the invention.

The invention also relates to an article of manufacture made by any of the methods described herein.

Embodiments herein are not meant to be construed in a limiting sense. Various modifications in form and detail of the embodiments of the invention, as well as other aspects and variations of the invention, will be apparent to the skilled artisan considering the following detailed description and examples.

### DETAILED DESCRIPTION

### Terminology and Definitions

Unless otherwise indicated, the invention is not limited to specific reactants, substituents, catalysts, catalyst compositions, resin compositions, cyclic olefins, reaction conditions, or the like, as such may vary. It is also to be understood that the terminology used herein is for the purpose of describing particular embodiments only and is not to be interpreted as being limiting.

As used in the specification and the appended claims, the singular forms “a,” “an,” and “the” include plural referents unless the context clearly dictates otherwise. Thus, for example, reference to “a substituent” encompasses a single substituent as well as two or more substituents, and the like.

As used in the specification and the appended claims, the terms “for example.” “for instance,” “such as.” or “including” are meant to introduce examples that further clarify more general subject matter. Unless otherwise specified, these examples are provided only as an aid for understanding the invention, and are not meant to be limiting in any fashion.

In this specification and in the claims that follow, reference will be made to a number of terms, which shall be defined to have the following meanings:

The term “alkyl” as used herein refers to a linear, branched, or cyclic saturated hydrocarbon group typically although not necessarily containing 1 to about 24 carbon atoms, such as 1 to about 12 carbon atoms, such as methyl, ethyl, n-propyl, isopropyl, n-butyl, isobutyl, t-butyl, octyl, decyl, and the like, as well as cycloalkyl groups such as cyclopentyl, cyclohexyl, and the like. Generally, although again not necessarily, alkyl groups herein contain 1 to about 12 carbon atoms. The term “lower alkyl” refers to an alkyl group of 1 to 6 carbon atoms, and the specific term “cycloalkyl” refers to a cyclic alkyl group, typically having 4 to 8, such as 5 to 7, carbon atoms. The term “substituted alkyl” refers to alkyl substituted with one or more substituent groups, and the terms “heteroatom-containing alkyl” and “heteroalkyl” refer to alkyl in which at least one carbon atom is replaced with a heteroatom. If not otherwise indicated, the terms “alkyl” and “lower alkyl” include linear, branched, cyclic, unsubstituted, substituted, and/or heteroatom-containing alkyl and lower alkyl, respectively.

The term “alkylene” as used herein refers to a difunctional linear, branched, or cyclic alkyl group, where “alkyl” is as defined above.

The term “alkenyl” as used herein refers to a linear, branched, or cyclic hydrocarbon group of 2 to about 24 carbon atoms (e.g., 2 to about 12 carbon atoms) containing at least one double bond, such as ethenyl, n-propenyl, isopropenyl, n-butenyl, isobutenyl, octenyl, decenyl, tetradecenyl, hexadecenyl, eicosenyl, tetracosenyl, and the like. The term “lower alkenyl” refers to an alkenyl group of 2 to 6 carbon atoms, and the specific term “cycloalkenyl” refers to a cyclic alkenyl group, such as 5 to 8 carbon atoms. The term “substituted alkenyl” refers to alkenyl substituted with one or more substituent groups, and the terms “heteroatom-containing alkenyl” and “heteroalkenyl” refer to alkenyl in which at least one carbon atom is replaced with a heteroatom. If not otherwise indicated, the terms “alkenyl” and “lower alkenyl” include linear, branched, cyclic, unsubstituted, substituted, and/or heteroatom-containing alkenyl and lower alkenyl, respectively.

The term “alkenylene” as used herein refers to a difunctional linear, branched, or cyclic alkenyl group, where “alkenyl” is as defined above.

The term “alkynyl” as used herein refers to a linear or branched hydrocarbon group of 2 to about 24 carbon atoms (e.g., 2 to about 12 carbon atoms) containing at least one triple bond, such as ethynyl, n-propynyl, and the like. The term “lower alkynyl” refers to an alkynyl group of 2 to 6 carbon atoms. The term “substituted alkynyl” refers to alkynyl substituted with one or more substituent groups, and the terms “heteroatom-containing alkynyl” and “heteroalkynyl” refer to alkynyl in which at least one carbon atom is replaced with a heteroatom. If not otherwise indicated, the terms “alkynyl” and “lower alkynyl” include linear, branched, unsubstituted, substituted, and/or heteroatom-containing alkynyl and lower alkynyl, respectively.

The term “alkoxy” as used herein refers to an alkyl group bound through a single, terminal ether linkage; that is, an “alkoxy” group may be represented as —O-alkyl where alkyl is as defined above. A “lower alkoxy” group refers to an alkoxy group containing 1 to 6 carbon atoms. Analogously, “alkenyloxy” and “lower alkenyloxy” respectively refer to an alkenyl and lower alkenyl group bound through a single, terminal ether linkage, and “alkynyloxy” and “lower alkynyloxy” respectively refer to an alkynyl and lower alkynyl group bound through a single, terminal ether linkage.

The term “aryl” as used herein, and unless otherwise specified, refers to an aromatic substituent containing a single aromatic ring or multiple aromatic rings that are fused together, directly linked, or indirectly linked (such that the different aromatic rings are bound to a common group such as a methylene or ethylene moiety). Aryl groups may contain 5 to 24 carbon atoms (e.g., 5 to 14 carbon atoms). Exemplary aryl groups contain one aromatic ring or two fused or linked aromatic rings, e.g., phenyl, naphthyl, biphenyl, diphenylether, diphenylamine, benzophenone, and the like. “Substituted aryl” refers to an aryl moiety substituted with one or more substituent groups, and the terms “heteroatom-containing aryl” and “heteroaryl” refer to aryl substituents in which at least one carbon atom is replaced with a heteroatom, as will be described in further detail infra.

The term “aryloxy” as used herein refers to an aryl group bound through a single, terminal ether linkage, wherein “aryl” is as defined above. An “aryloxy” group may be represented as —O-aryl where aryl is as defined above. Aryloxy groups may contain 5 to 24 carbon atoms (e.g., 5 to 14 carbon atoms). Examples of aryloxy groups include, without limitation, phenoxy, o-halo-phenoxy, m-halo-phenoxy, phalo-phenoxy, o-methoxy-phenoxy, m-methoxy-phenoxy, p-methoxy-phenoxy, 2,4dimethoxy-phenoxy, 3,4,5-trimethoxy-phenoxy, and the like.

The term “alkaryl” refers to an aryl group with an alkyl substituent, and the term “aralkyl” refers to an alkyl group with an aryl substituent, wherein “aryl” and “alkyl” are as defined above. Alkaryl and aralkyl groups may contain 6 to 24 carbon atoms (e.g., 6 to 16 carbon atoms). Alkaryl groups include, without limitation, p-methylphenyl, 2,4-dimethylphenyl, p-cyclohexylphenyl, 2,7dimethylnaphthyl, 7-cyclooctylnaphthyl, 3-ethyl-cyclopenta-1,4-diene, and the like. Examples of aralkyl groups include, without limitation, benzyl, 2-phenyl-ethyl, 3-phenyl-propyl, 4-phenyl-butyl, 5-phenyl-pentyl, 4-phenylcyclohexyl, 4-benzylcyclohexyl, 4phenylcyclohexylmethyl, 4benzylcyclohexylmethyl, and the like. The terms “alkaryloxy” and “aralkyloxy” refer to substituents of the formula —OR wherein R is alkaryl or aralkyl, respectively, as just defined.

The term “acyl” refers to substituents having the formula —(CO)-alkyl, -(CO)-aryl, (CO)-aralkyl, —(CO)-alkaryl, -(CO)-alkenyl, or —(CO)-alkynyl, and the term “acyloxy” refers to substituents having the formula O(CO)-alkyl, O(CO)-aryl, —O(CO)-aralkyl, —O(CO)-alkaryl, —O(CO)-alkenyl, —O(CO)— alkynyl wherein “alkyl,” “aryl,” “aralkyl”, alkaryl, alkenyl, and alkynyl are as defined above.

The terms “cyclic” and “ring” refer to alicyclic or aromatic groups that may or may not be substituted and/or heteroatom containing, and that may be monocyclic, bicyclic, or polycyclic. The term “alicyclic” is used in the conventional sense to refer to an aliphatic cyclic moiety, as opposed to an aromatic cyclic moiety, and may be monocyclic, bicyclic, or polycyclic.

The terms “halo” and “halogen” are used in the conventional sense to refer to a chloro, bromo, fluoro, or iodo substituent.

“Hydrocarbyl” refers to univalent hydrocarbyl radicals containing 1 to about 30 carbon atoms, such as 1 to about 24 carbon atoms, such as I to about 12 carbon atoms, including linear, branched, cyclic, saturated, and unsaturated species, such as alkyl groups, alkenyl groups, alkynyl groups, aryl groups, and the like. The term “lower hydrocarbyl” intends a hydrocarbyl group of 1 to 6 carbon atoms, such as 1 to 4 carbon atoms, and the term “hydrocarbylene” refers to a divalent hydrocarbyl moiety containing 1 to about 30 carbon atoms, such as 1 to about 24 carbon atoms, such as I to about 12 carbon atoms, including linear, branched, cyclic, saturated, and unsaturated species. The term “lower hydrocarbylene” refers to a hydrocarbylene group of 1 to 6 carbon atoms. “Substituted hydrocarbyl” refers to hydrocarbyl substituted with one or more substituent groups, and the terms “heteroatom-containing hydrocarbyl” and “heterohydrocarbyl” refer to hydrocarbyl in which at least one carbon atom is replaced with a heteroatom. Similarly, “substituted hydrocarbylene” refers to hydrocarbylene substituted with one or more substituent groups, and the terms “heteroatom-containing hydrocarbylene” and “heterohydrocarbylene” refer to hydrocarbylene in which at least one carbon atom is replaced with a heteroatom. Unless otherwise indicated, the term “hydrocarbyl” and “hydrocarbylene” are to be interpreted as including substituted and/or heteroatom-containing hydrocarbyl and heteroatom-containing hydrocarbylene moieties, respectively.

The term “heteroatom-containing” as in a “heteroatom-containing hydrocarbyl group” refers to a hydrocarbon molecule or a hydrocarbyl molecular fragment in which one or more carbon atoms is replaced with an atom other than carbon, e.g., nitrogen, oxygen, sulfur, phosphorus, or silicon, typically nitrogen, oxygen, or sulfur. Similarly, the term “heteroalkyl” refers to an alkyl substituent that is heteroatom-containing, the term “heterocyclic” refers to a cyclic substituent that is heteroatom-containing, the terms “heteroaryl” and “heteroaromatic” respectively refer to “aryl” and “aromatic” substituents that are heteroatom-containing, and the like. It should be noted that a “heterocyclic” group or compound may or may not be aromatic, and further that “heterocycles” may be monocyclic, bicyclic, or polycyclic as described above with respect to the term “aryl.” Examples of heteroalkyl groups include without limitation alkoxyaryl, alkylsulfanyl-substituted alkyl, N-alkylated amino alkyl, and the like. Examples of heteroaryl substituents include without limitation pyrrolyl, pyrrolidinyl, pyridinyl, quinolinyl, indolyl, pyrimidinyl, imidazolyl, 1,2,4-triazolyl, tetrazolyl, etc., and examples of heteroatom-containing alicyclic groups include without limitation pyrrolidino, morpholino, piperazino, piperidino, etc.

By “substituted” as in “substituted hydrocarbyl,” “substituted alkyl,” “substituted aryl,” and the like, as alluded to in some of the aforementioned definitions, is meant that in the hydrocarbyl, alkyl, aryl, or other moiety, at least one hydrogen atom bound to a carbon (or other) atom is replaced with one or more non-hydrogen substituents. Examples of such substituents include, without limitation: functional groups referred to herein as “Fn,” such as halo, hydroxyl, sulfhydryl, C₁-C₂₄ alkoxy, C₂-C₂₄alkenyloxy, C₂-C₂₄ alkynyloxy, C₅-C₂₄ aryloxy, C₆-C₂₄ aralkyloxy, C₆-C₂₄ alkaryloxy, acyl (including C₂-C₂₄ alkylcarbonyl (—CO-alkyl) and C₆-C₂₄ arylcarbonyl (—CO-aryl)), acyloxy (—O-acyl, including C₂-C₂₄ alkylcarbonyloxy (—O—CO-alkyl) and C₆-C₂₄ arylcarbonyloxy (—O—CO-aryl)), C₂-C₂₄ alkoxycarbonyl (—(CO)—O-alkyl), C₆-C₂₄ aryloxycarbonyl (—(CO)—O-aryl), halocarbonyl (—CO)—X where X is halo), C₂-C₂₄ alkylcarbonato (—O—(CO)—O-alkyl), C₆-C₂₄ arylcarbonato (—O—(CO)—O-aryl), carboxy (—COOH), carboxylato (COO⁻), carbamoyl (—(CO)—NH₂), mono-(C₁-C₂₄ alkyl)-substituted carbamoyl ((CO)—NH(C₁-C₂₄ alkyl)), di-(C₁-C₂₄ alkyl)-substituted carbamoyl (—(CO)—N(C₁-C₂₄ alkyl)₂), mono-(C₁-C₂₄ haloalkyl)-substituted carbamoyl (—(CO)—NH(C₁-C₂₄ haloalkyl)), di-(C₁-C₂₄ haloalkyl)-substituted carbamoyl (—(CO)—N(C₁-C₂₄ haloalkyl)₂), mono-(C₅-C₂₄ aryl)-substituted carbamoyl ((CO)—NH-aryl), di-(C₅-C₂₄ aryl)-substituted carbamoyl (—(CO)—N(C₅-C₂₄ aryl)₂), di-N—(C₁-C₂₄ alkyl), N—(C₅-C₂₄ aryl)-substituted carbamoyl (—(CO)—N(C₁-C₂₄ alkyl)(C₅-C₂₄ aryl), thiocarbamoyl (—(CS)—NH₂), mono-(C₁-C₂₄ alkyl)-substituted thiocarbamoyl (—(CS)—NH(C₁-C₂₄ alkyl)), di-(C₁-C₂₄ alkyl)-substituted thiocarbamoyl (—(CS)—N(C₁-C₂₄ alkyl)₂), mono-(C₅-C₂₄ aryl)-substituted thiocarbamoyl (—(CS)—NH-aryl), di(C₅-C₂₄ aryl)-substituted thiocarbamoyl (—(CS)—N(C₂-C₂₄ aryl)₂), di-N—(C₁-C₂₄ alkyl). N—(C₅-C₂₄ aryl)-substituted thiocarbamoyl (—(CS)—N(C₁-C₂₄ alkyl)(C₅-C₂₄ aryl), carbamido (—NH—(CO)—NH₂), cyano (—C≡N), cyanato (—O—C≡N), thiocyanato (—S—C≡N), isocyanate (—N═C═O), thioisocyanate (—N═C═S), formyl (—(CO)—H), thioformyl ((CS)—H), amino (—NH₂), mono-(C₁-C₂₄ alkyl)-substituted amino (—NH(C₁-C₂₄ alkyl), di-(C₁-C₂₄ alkyl)-substituted amino (—N(C₁-C₂₄ alkyl)₂), mono-(C₅-C₂₄ aryl)-substituted amino (—NH(C₅-C₂₄ aryl), di-(C₅-C₂₄ aryl)-substituted amino (—N(C₅-C₂₄ aryl)₂), C₂-C₂₄ alkylamido (—NH—(CO)-alkyl), C₆-C₂₄ arylamido (—NH—(CO)-aryl), imino (—CR═NH where R includes without limitation hydrogen, C₁-C₂₄ alkyl, C₅-C₂₄ aryl, C₆C₂₄ alkaryl, C₆-C₂₄ aralkyl, etc.), C₂-C₂₀ alkylimino (CR═N(alkyl), where R includes without limitation hydrogen, C₁C₂₄ alkyl, C₅-C₂₄ aryl, C₆-C₂₄ alkaryl, C₆-C₂₄ aralkyl, etc.), arylimino (—CR═N(aryl), where R includes without limitation hydrogen, C₁-C₂₀ alkyl, C₅-C₂₄ aryl, C₆-C₂₄ alkaryl, C₆-C₂₄ aralkyl, etc.), nitro (—NO₂), nitroso (NO), sulfo (—SO₂—OH), sulfonato (—SO₂—O—), C₁-C₂₄ alkylsulfanyl (—S-alkyl: also termed “alkylthio”), C₅-C₂₄ arylsulfanyl (—S-aryl; also termed “arylthio”), C₁-C₂₄ alkylsulfinyl (—(SO)-alkyl), C₅-C₂₄arylsulfinyl (—(SO)-aryl), C₁-C₂₄ alkylsulfonyl (SO₂-alkyl), C₁-C₂₄ monoalkylaminosulfonyl (—SO₂—N(H) alkyl), C₁-C₂₄ dialkylaminosulfonyl (—SO₂—N(alkyl)₂). C₅-C₂₄ arylsulfonyl (—SO₂-aryl), boryl (—BH₂), borono (—B(OH)₂), boronato (—B(OR)₂ where R includes without limitation alkyl or other hydrocarbyl), phosphono (—P(O)(OH)₂), phosphonato (—P(O)(O⁻)₂), phosphinato (P(O)(O⁻)), phospho (—PO₂), and phosphino (—PH₂); and the hydrocarbyl moieties C₁-C₂₄ alkyl (e.g., C₁-C₁₂ alkyl, C₁-C₆ alkyl), C₂-C₂₄ alkenyl (e.g., C₂-C₁₂ alkenyl, C₂-C₆ alkenyl), C₂-C₂₄ alkynyl (e.g., C₂-C₁₂ alkynyl, C₂-C₆ alkynyl), C₅-C₂₄ aryl (e.g., C₅-C₁₄ aryl), C₆-C₂₄ alkaryl (e.g., C₆-C₁₆ alkaryl), and C₆-C₂₄ aralkyl (e.g., C₆-C₁₆ aralkyl).

By “functionalized” as in “functionalized hydrocarbyl,” “functionalized alkyl,” “functionalized olefin,” “functionalized cyclic olefin,” and the like, is meant that in the hydrocarbyl, alkyl, olefin, cyclic olefin, or other moiety, at least one hydrogen atom bound to a carbon (or other) atom is replaced with one or more functional groups such as those described hereinabove. The term “functional group” is meant to include any functional species that is suitable for the uses described herein. In particular, as used herein, a functional group would necessarily possess the ability to react with or bond to corresponding functional groups on a substrate surface.

In addition, the aforementioned functional groups may, if a particular group permits, be further substituted with one or more additional functional groups or with one or more hydrocarbyl moieties such as those specifically mentioned above. Analogously, the above-mentioned hydrocarbyl moieties may be further substituted with one or more functional groups or additional hydrocarbyl moieties as noted above.

“Optional” or “optionally” means that the subsequently described circumstance may or may not occur, so that the description includes instances where the circumstance occurs and instances where it does not. For example, the phrase “optionally substituted” means that a nonhydrogen substituent may or may not be present on a given atom, and, thus, the description includes structures wherein a non-hydrogen substituent is present and structures wherein a nonhydrogen substituent is not present.

The term “substrate material” as used herein, is intended to generally mean any material that the ROMP composition of the invention may be contacted with, applied to, or have the substrate material incorporated into the ROMP composition. Without limitation, such materials include reinforcing materials, such as filaments, fibers, rovings, mats, weaves, fabrics, knitted material, cloth or other known structures, glass fibers and fabrics, carbon fibers and fabrics, aramid fibers and fabrics, and polyolefin or other polymer fibers or fabrics. Other suitable substrate materials include metallic density modulators, microparticulate density modulators, such as microspheres, glass microspheres, ceramic microspheres, microballons, cenospheres, and macroparticulate density modulators, such as glass or ceramic beads. A ROMP polymer composite may be comprised of one substrate material or a mixture of different substrate materials.

The term “polymer backbone” is intended to mean the chains of atoms in a polymer that comprise the main chain and any crosslinks, if it is a crosslinked polymer.

The term “field joint” as used herein, is intended to generally mean a connection between adjoining members or parts, made at the time of installation (i.e., in the field). The term “field joint” is a term of art often used to describe the welded ends of individual lengths of pipe. For example, pipelines used to transport oil and/or gas is most often formed from many individual pieces of pipe, for example steel pipe. During the manufacturing of individual pieces of pipe, an anti-corrosion coating is often applied to the exterior surface of the pipe in such a manner that the exterior surface of the pipe ends remains uncoated. Furthermore, the pipe may be subsequently coated with an insulation material; however, the exterior surface of the pipe ends still remains uncoated. The pipeline is formed by connecting the individual pieces of pipe by welding together the uncoated pipe ends. At least part of this welding process may take place at an onshore facility prior to loading the pipe on a lay barge or reel ship, with the remainder of the connections made offshore prior to the pipeline being deployed in offshore use. In the alternative, during the manufacturing of individual pieces of pipe, an anti-corrosion coating may be applied to the exterior surface of the pipe in such a manner that the exterior surface of the pipe ends are also coated. In this instance, the anti-corrosion coating must be removed from the pipe ends prior to welding.

As is known in the art, weight percent (wt. %) can be represented by gas chromatography (GC) percent area (area %). Hence, GC area % obtained from the GC was reported as wt. %. Weight percent (wt. %) and percent by weight are used interchangeably herein. Mol percent (mol %) was calculated from the weight percent (wt. %) as is known in the art.

### Cyclic Olefin Composition

The cyclic olefin compositions used in the ROMP compositions of the invention disclosed herein comprise, consist essentially of, or consist of at least one multiunsaturated cyclic olefin, and wherein the cyclic olefin composition does not contain, or is substantially free of (e.g., 10 wt. % or less, 9 wt. % or less, 8 wt. % or less, 7 wt. % or less, 6 wt. % or less, 5 wt. % or less, 4 wt. % or less, 3 wt. % or less, 2 wt. % or less, 1 wt. % or less, 0.5 wt. % or less, 0.1 wt. % or less, 0.01 wt. % or less; based on the total weight of the cyclic olefin composition), a monounsaturated cyclic olefin, wherein the monounsaturated cyclic olefin is selected from 5-octyl-2-norbornene (ONB). For example, the cyclic olefin composition may comprise, consist essentially of, or consist of at least one multiunsaturated cyclic olefin, and wherein the cyclic olefin composition does not contain a monounsaturated cyclic olefin, wherein the monounsaturated cyclic olefin is selected from ONB. For example, the cyclic olefin composition may comprise, consist essentially of, or consist of at least one multiunsaturated cyclic olefin, and wherein the cyclic olefin composition is substantially free of (e.g., 10 wt. % or less, 9 wt. % or less, 8 wt. % or less, 7 wt. % or less, 6 wt. % or less, 5 wt. % or less, 4 wt. % or less, 3 wt. % or less, 2 wt. % or less, 1 wt. % or less, 0.5 wt. % or less, 0.1 wt. % or less, 0.01 wt. % or less: based on the total weight of the cyclic olefin composition), a monounsaturated cyclic olefin, wherein the monounsaturated cyclic olefin is selected from ONB.

The cyclic olefin compositions used in the ROMP compositions of the invention disclosed herein may also comprise, consist essentially of, or consist of at least one multiunsaturated cyclic olefin, and wherein the cyclic olefin composition does not contain, or is substantially free of (e.g., 10 wt. % or less, 9 wt. % or less, 8 wt. % or less, 7 wt. % or less, 6 wt. % or less, 5 wt. % or less, 4 wt. % or less, 3 wt. % or less, 2 wt. % or less, I wt. % or less, 0.5 wt. % or less, 0.1 wt. % or less, 0.01 wt. % or less; based on the total weight of the cyclic olefin composition), a monounsaturated cyclic olefin, wherein the monounsaturated cyclic olefin is selected from at least one substituted norbornene, including, but not limited to, the monounsaturated substituted norbornenes encompassed by cyclic olefin structures (D), (E), or (F) (as defined below). For example, the cyclic olefin composition may comprise, consist essentially of, or consist of at least one multiunsaturated cyclic olefin, and wherein the cyclic olefin composition does not contain a monounsaturated cyclic olefin, wherein the monounsaturated cyclic olefin is selected from at least one substituted norbornene, including, but not limited to, the monounsaturated substituted norbornenes encompassed by cyclic olefin structures (D), (E), or (F) (as defined below). For example, the cyclic olefin composition may comprise, consist essentially of, or consist of at least one multiunsaturated cyclic olefin, and wherein the cyclic olefin composition is substantially free of (e.g., 10 wt. % or less, 9 wt. % or less, 8 wt. % or less, 7 wt. % or less, 6 wt. % or less, 5 wt. % or less, 4 wt. % or less, 3 wt. % or less, 2 wt. % or less, 1 wt. % or less, 0.5 wt. % or less, 0.1 wt. % or less, 0.01 wt. % or less: based on the total weight of the cyclic olefin composition), a monounsaturated cyclic olefin, wherein the monounsaturated cyclic olefin is selected from at least one substituted norbornene, including, but not limited to, the monounsaturated substituted norbornenes encompassed by cyclic olefin structures (D), (E), or (F) (as defined below).

The cyclic olefin compositions used in the ROMP compositions of the invention disclosed herein may also comprise, consist essentially of, or consist of at least one multiunsaturated cyclic olefin, and wherein the cyclic olefin composition does not contain, or is substantially free of (e.g., 10 wt. % or less, 9 wt. % or less, 8 wt. % or less, 7 wt. % or less, 6 wt. % or less, 5 wt. % or less, 4 wt. % or less, 3 wt. % or less, 2 wt. % or less, 1 wt. % or less, 0.5 wt. % or less, 0.1 wt. % or less, 0.01 wt. % or less; based on the total weight of the cyclic olefin composition), a monounsaturated cyclic olefin. For example, the cyclic olefin composition may comprise, consist essentially of, or consist of at least one multiunsaturated cyclic olefin, and wherein the cyclic olefin composition does not contain a monounsaturated cyclic olefin. For example, the cyclic olefin composition may comprise, consist essentially of, or consist of at least one multiunsaturated cyclic olefin, and wherein the cyclic olefin composition is substantially free of (e.g., 10 wt. % or less, 9 wt. % or less, 8 wt. % or less, 7 wt. % or less, 6 wt. % or less, 5 wt. % or less, 4 wt. % or less, 3 wt. % or less, 2 wt. % or less, 1 wt. % or less, 0.5 wt. % or less, 0.1 wt. % or less, 0.01 wt. % or less: based on the total weight of the cyclic olefin composition), a monounsaturated cyclic olefin.

The at least one multiunsaturated cyclic olefin and the at least one monounsaturated cyclic olefin, if present, may be, independent of one another, substituted or unsubstituted.

The at least one multiunsaturated cyclic olefin and the at least one monounsaturated cyclic olefin, if present, may be, independent of one another, substituted by hydrogen, hydrocarbyl, substituted hydrocarbyl, heteroatom-containing hydrocarbyl, substituted heteroatom-containing hydrocarbyl, —(Z*)ₙ-Fn wherein n is 0 or 1, Fn is the functional group, and Z* is a hydrocarbylene linking group such as an alkylene, substituted alkylene, heteroalkylene, substituted heteroalkene, arylene, substituted arylene, heteroarylene, or substituted heteroarylene linkage, and functional groups (Fn).

The cyclic olefin composition may contain at least one multiunsaturated cyclic olefin in an amount ranging from 90 to 100 wt. % (e.g., 91 to 99.9 wt. %, 92 to 99 wt. %, 93 to 98 wt. %, 94 to 97 wt. %, 95 to 96 wt. %), and the at least one monounsaturated cyclic olefin in an amount of 10 wt. % or less (e.g., 9 wt. % or less, 8 wt. % or less, 7 wt. % or less, 6 wt. % or less, 5 wt. % or less, 4 wt. % or less, 3 wt. % or less, 2 wt. % or less, 1 wt. % or less, 0.5 wt. % or less, 0.1 wt. % or less, 0.01 wt. % or less, 0 wt. %), based on the total weight of the cyclic olefin composition.

The ROMP composition of the invention disclosed herein also may not contain, or may be substantially free of (e.g., 10 wt. % or less, 9 wt. % or less, 8 wt. % or less, 7 wt. % or less, 6 wt. % or less, 5 wt. % or less, 4 wt. % or less, 3 wt. % or less, 2 wt. % or less, 1 wt. % or less, 0.5 wt. % or less, 0.1 wt. % or less, 0.01 wt. % or less; based on the total weight of the ROMP composition), a monounsaturated cyclic olefin. The monounsaturated cyclic olefin may be selected from ONB. Alternatively, the monounsaturated cyclic olefin may be selected from at least one substituted norbornene, including, but not limited to, the monounsaturated substituted norbornenes encompassed by cyclic olefin structures (D), (E), or (F) (as defined below). Alternatively, the monounsaturated cyclic olefin may be selected from any monounsaturated cyclic olefin. For example, the ROMP composition of the invention may not contain a monounsaturated cyclic olefin, wherein the monounsaturated cyclic olefin is selected from ONB, or wherein the monounsaturated cyclic olefin is selected from at least one substituted norbornene, including, but not limited to, the monounsaturated substituted norbornenes encompassed by cyclic olefin structures (D), (E), or (F) (as defined below), or wherein the monounsaturated cyclic olefin is selected from any monounsaturated cyclic olefin. For example, the ROMP composition of the invention may be substantially free of (e.g., 10 wt. % or less, 9 wt. % or less, 8 wt. % or less, 7 wt. % or less, 6 wt. % or less, 5 wt. % or less, 4 wt. % or less, 3 wt. % or less, 2 wt. % or less, 1 wt. % or less, 0.5 wt. % or less, 0.1 wt. % or less, 0.01 wt. % or less; based on the total weight of the ROMP composition), a monounsaturated cyclic olefin, wherein the monounsaturated cyclic olefin is selected from ONB, or wherein the monounsaturated cyclic olefin is selected from at least one substituted norbornene, including, but not limited to, the monounsaturated substituted norbornenes encompassed by cyclic olefin structures (D), (E), or (F) (as defined below), or wherein the monounsaturated cyclic olefin is selected from any monounsaturated cyclic olefin.

In other embodiments, the cyclic olefin compositions used in the ROMP compositions of the invention disclosed herein may comprise, consist essentially of, or consist of 70 to 90 wt. % (e.g., 72 to 88 wt. %, 74 to 86 wt. %, 76 to 84 wt. %, 78 to 82 wt. %) of at least one multiunsaturated cyclic olefin, and 25 wt. % or less (e.g., 20 wt. % or less, 15 wt. % or less, 10 wt. % or less, 9 wt. % or less, 8 wt. % or less, 7 wt. % or less, 6 wt. % or less, 5 wt. % or less, 4 wt. % or less, 3 wt. % or less, 2 wt. % or less, 1 wt. % or less, 0.5 wt. % or less, 0.1 wt. % or less, 0.01 wt. % or less, 0 wt. %) of a monounsaturated cyclic olefin, wherein the monounsaturated cyclic olefin is selected from ONB, or wherein the monounsaturated cyclic olefin is selected from at least one substituted norbornene, including, but not limited to, the monounsaturated substituted norbornenes encompassed by cyclic olefin structures (D), (E), or (F) (as defined below), or wherein the monounsaturated cyclic olefin is selected from any monounsaturated cyclic olefin. For example, the cyclic olefin composition may also comprise, consist essentially of, or consist of 70 to 80 wt. % dicyclopentadiene (e.g., 70 wt. %, 71 wt. %, 72 wt. %, 73 wt. %, 74 wt. %, 75 wt. %, 76 wt. %, 77 wt. %, 78 wt. %, 79 wt. %, 80 wt. %), 0.1 to 10 wt. % tricyclopentadiene (e.g., 0.1 wt. %, 1 wt. %, 2 wt. %, 3 wt. %, 4 wt. %, 5 wt. %, 6 wt. %, 7 wt. %, 8 wt. %, 9 wt. %, 10 wt. %), and 25 wt. % or less of the monounsaturated cyclic olefin (e.g., 20 wt. % or less, 15 wt. % or less, 10 wt. % or less, 9 wt. % or less, 8 wt. % or less, 7 wt. % or less, 6 wt. % or less, 5 wt. % or less, 4 wt. % or less, 3 wt. % or less, 2 wt. % or less, I wt. % or less, 0.5 wt. % or less, 0.1 wt. % or less, 0.01 wt. % or less, 0 wt. %), based on the total weight of the cyclic olefin composition, wherein the monounsaturated cyclic olefin is selected from ONB, or wherein the monounsaturated cyclic olefin is selected from at least one substituted norbornene, including, but not limited to, the monounsaturated substituted norbornenes encompassed by cyclic olefin structures (D), (E), or (F) (as defined below), or wherein the monounsaturated cyclic olefin is selected from any monounsaturated cyclic olefin.

In general, any cyclic olefin suitable for the metathesis reactions disclosed herein may be used in the cyclic olefin composition. Such cyclic olefins may be optionally substituted, optionally heteroatom-containing, mono-unsaturated, di-unsaturated, or poly-unsaturated C₅ to C₂₄ hydrocarbons that may be mono-, di-, or poly-cyclic. The cyclic olefin may generally be any strained or unstrained cyclic olefin, provided the cyclic olefin is able to participate in a ROMP reaction either individually or as part of the ROMP composition. While certain unstrained cyclic olefins such as cyclohexene are generally understood to not undergo ROMP reactions by themselves, under appropriate circumstances, such unstrained cyclic olefins may nonetheless be ROMP active. For example, when present as a co-monomer in a ROMP composition, unstrained cyclic olefins may be ROMP active. Accordingly, as used herein and as would be appreciated by the skilled artisan, the term “unstrained cyclic olefin” is intended to refer to those unstrained cyclic olefins that may undergo a ROMP reaction under any conditions, or in any ROMP composition, provided the unstrained cyclic olefin is ROMP active.

In general, the cyclic olefin may be represented by the structure of formula (A)

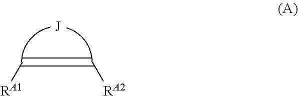

wherein J, R^{A1}, and R^{A2} are as follows:
R^{A1} and R^{A2} is selected independently from the group consisting of hydrogen, hydrocarbyl (e.g., C₁-C₂₀ alkyl, C₅-C₂₀ aryl, C₅-C₃₀ aralkyl, or C₅-C₃₀ alkaryl), substituted hydrocarbyl (e.g., substituted C₁-C₂₀ alkyl, C₅-C₂₀ aryl, C₅-C₃₀ aralkyl, or C₅-C₃₀ alkaryl), heteroatom-containing hydrocarbyl (e.g., C₁-C₂₀ heteroalkyl, C₅-C₂₀ heteroaryl, heteroatom-containing C₅-C₃₀ aralkyl, or heteroatom-containing C₅-C₃₀ alkaryl), and substituted heteroatom-containing hydrocarbyl (e.g., substituted C₁-C₂₀ heteroalkyl, C₅-C₂₀ heteroaryl, heteroatom-containing C₅-C₃₀ aralkyl, or heteroatom-containing C₅-C₃₀ alkaryl) and, if substituted hydrocarbyl or substituted heteroatom-containing hydrocarbyl, wherein the substituents may be functional groups (Fn) such as phosphonato, phosphoryl, phosphanyl, phosphino, sulfonato, C₁-C₂₀ alkylsulfanyl, C₅-C₂₀ arylsulfanyl, C₁-C₂₀ alkylsulfonyl, C₅-C₂₀ arylsulfonyl, C₁-C₂₀ alkylsulfinyl, C₅-C₂₀ arylsulfinyl, sulfonamido, amino, amido, imino, nitro, nitroso, hydroxyl, C₁-C₂₀ alkoxy, C₅-C₂₀ aryloxy, C₂-C₂₀ alkoxycarbonyl, C₅-C₂₀ aryloxycarbonyl, carboxyl, carboxylato, mercapto, formyl, C₁-C₂₀ thioester, cyano, cyanato, thiocyanato, isocyanate, thioisocyanate, carbamoyl, epoxy, styrenyl, silyl, silyloxy, silanyl, siloxazanyl, boronato, boryl, or halogen, or a metal-containing or metalloid-containing group (wherein the metal may be, for example, Sn or Ge). R^{A1} and R^{A2} may itself be one of the aforementioned groups, such that the Fn moiety is directly bound to the olefinic carbon atom indicated in the structure. In the latter case, however, the functional group will generally not be directly bound to the olefinic carbon through a heteroatom containing one or more lone pairs of electrons, e.g., an oxygen, sulfur, nitrogen, or phosphorus atom, or through an electron-rich metal or metalloid such as Ge, Sn, As, Sb, Se, Te, etc. With such functional groups, there will normally be an intervening linkage Z*, such that R^{A1} and/or R^{A2} then has the structure —(Z*)ₙ-Fn wherein n is 0 or 1, Fn is the functional group, and Z* is a hydrocarbylene linking group such as an alkylene, substituted alkylene, heteroalkylene, substituted heteroalkene, arylene, substituted arylene, heteroarylene, or substituted heteroarylene linkage.

J is a saturated or unsaturated hydrocarbylene, substituted hydrocarbylene, heteroatom-containing hydrocarbylene, or substituted heteroatom-containing hydrocarbylene linkage, wherein when J is substituted hydrocarbylene or substituted heteroatom-containing hydrocarbylene, the substituents may include one or more —(Z*)ₙ-Fn groups, wherein n is 0 or 1, and Fn and Z* are as defined previously. Additionally, two or more substituents attached to ring carbon (or other) atoms within J may be linked to form a bicyclic or polycyclic olefin. J will generally contain in the range of approximately 5 to 14 ring atoms, typically 5 to 8 ring atoms, for a monocyclic olefin, and, for bicyclic and polycyclic olefins, each ring will generally contain 4 to 8, typically 5 to 7, ring atoms.

Mono-unsaturated cyclic olefins encompassed by structure (A) may be represented by the structure (B)

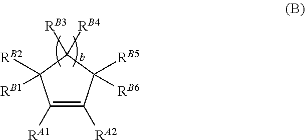

wherein b is an integer generally although not necessarily in the range of 1 to 10, typically 1 to 5, R^{A1} and R^{A2} are as defined above for structure (A), and R^{B1}, R^{B2}, R^{B3}, R^{B4}, R^{B5}, and R^{B6} are independently selected from the group consisting of hydrogen, hydrocarbyl, substituted hydrocarbyl, heteroatom-containing hydrocarbyl, substituted heteroatom-containing hydrocarbyl and —(Z*)ₙ-Fn where n, Z*, and Fn are as defined previously, and wherein if any of the R^{B1} through R^{B6} moieties is substituted hydrocarbyl or substituted heteroatom-containing hydrocarbyl, the substituents may include one or more —(Z*)ₙ-Fn groups. Accordingly, R^{B1}, R^{B2}, R^{B3}, R^{B4}, R^{B5}, and R^{B6} may be, for example, hydrogen, hydroxyl, C₁-C₂₀ alkyl, C₅-C₂₀ aryl, C₁-C₂₀ alkoxy, C₅-C₂₀ aryloxy, C₂-C₂₀ alkoxycarbonyl, C₅-C₂₀ aryloxycarbonyl, amino, amido, nitro, etc.

Furthermore, any of the R^{B1}, R^{B2}, R^{B3}, R^{B4}, R^{B5}, and R^{B6} moieties can be linked to any of the other R^{B1}, R^{B2}, R^{B3}, R^{B4}, R^{B5}, and R^{B6} moieties to provide a substituted or unsubstituted alicyclic group containing 4 to 30 ring carbon atoms or a substituted or unsubstituted aryl group containing 6 to 18 ring carbon atoms or combinations thereof and the linkage may include heteroatoms or functional groups, e.g., the linkage may include without limitation an ether, ester, thioether, amino, alkylamino, imino, or anhydride moiety. The alicyclic group can be monocyclic, bicyclic, or polycyclic. When unsaturated the cyclic group can contain monounsaturation or multiunsaturation. When substituted, the rings contain monosubstitution or multisubstitution wherein the substituents are independently selected from hydrogen, hydrocarbyl, substituted hydrocarbyl, heteroatom-containing hydrocarbyl, substituted heteroatom-containing hydrocarbyl, —(Z*)ₙ-Fn where n is 0 or 1, Z* and Fn are as defined previously, and functional groups (Fn) provided above.

Examples of monounsaturated, monocyclic olefins encompassed by structure (B) include, without limitation, cyclopentene, cyclohexene, cycloheptene, cyclooctene, cyclononene, cyclodecene, cycloundecene, cyclododecene, tricyclodecene, tetracyclodecene, octacyclodecene, and cycloeicosene, and substituted versions thereof such as 1-methylcyclopentene, lethylcyclopentene, lisopropylcyclohexene, l-chloropentene, 1-fluorocyclopentene, 4methylcyclopentene, 4-methoxy-cyclopentene, 4-ethoxy-cyclopentene, cyclopent-3-ene-thiol, cyclopent-3-ene, 4-methylsulfanyl-cyclopentene, 3-methylcyclohexene, 1-methylcyclooctene, 1,5-dimethylcyclooctene, etc.

Monocyclic diene reactants encompassed by structure (A) may be generally represented by the structure (C)

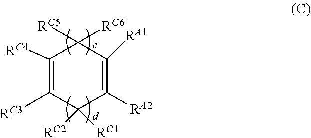

wherein c and d are independently integers in the range of 1 to about 8, typically 2 to 4, such as 2 (such that the reactant is a cyclooctadiene), R^{A1} and R^{A2} are as defined above for structure (A), and R^{C1}, R^{C2}, R^{C3}, R^{C4}, R^{C5}, and R^{C6} are defined as for R^{B1} through R^{B6}. In this case, R^{C3} and R^{C4} may be non-hydrogen substituents, in which case the second olefinic moiety is tetrasubstituted. Examples of monocyclic diene reactants include, without limitation, 1,3-cyclopentadiene, 1,3-cyclohexadiene, 1,4-cyclohexadiene, 5-ethyl-1,3-cyclohexadiene, 1,3-cycloheptadiene, cyclohexadiene, 1,5-cyclooctadiene, 1,3-cyclooctadiene, and substituted analogs thereof. Triene reactants are analogous to the diene structure (C), and will generally contain at least one methylene linkage between any two olefinic segments.

Bicyclic and polycyclic olefins encompassed by structure (A) may be generally represented by the structure (D)

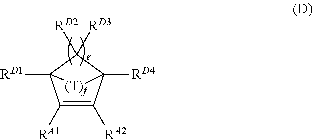

wherein R^{A1} and R^{A2} are as defined above for structure (A), R^{D1}, R^{D2}, R^{D3}, and R^{D4} are as defined for RB through R^{B6}, e is an integer in the range of 1 to 8 (typically 2 to 4) f is generally 1 or 2; T is lower alkylene or alkenylene (generally substituted or unsubstituted methyl or ethyl). CHR^{G1}, C(R^{G1}), O, S, N—R^{G1}, P—R^{G1}O═P—R^{G1}, Si(R^{G1})₂, B—R^{G1}, or As-R^{G1} where R^{G1} is alkyl, alkenyl, cycloalkyl, cycloalkenyl, aryl, alkaryl, aralkyl, or alkoxy. Furthermore, any of the R^{D1}, R^{D2}, R^{D3}, and R^{D4} moieties can be linked to any of the other R^{D1}, R^{D2}, R^{D3} and R^{D4} moieties to provide a substituted or unsubstituted alicyclic group containing 4 to 30 ring carbon atoms or a substituted or unsubstituted aryl group containing 6 to 18 ring carbon atoms or combinations thereof and the linkage may include heteroatoms or functional groups, e.g., the linkage may include without limitation an ether, ester, thioether, amino, alkylamino, imino, or anhydride moiety.

The cyclic group can be monocyclic, bicyclic, or polycyclic. When unsaturated the cyclic group can contain monounsaturation or multiunsaturation. When substituted, the rings contain monosubstitution or multisubstitution wherein the substituents are independently selected from hydrogen, hydrocarbyl, substituted hydrocarbyl, heteroatom-containing hydrocarbyl, substituted heteroatom-containing hydrocarbyl, —(Z*)ₙ-Fn where n is 0 or 1, Z* and Fn are as defined previously, and functional groups (Fn) provided above.

Cyclic olefins encompassed by structure (D) are in the norbornene family. As used herein, norbornene means any compound that includes at least one norbornene or substituted norbornene moiety, including without limitation norbornene, substituted norbornene(s), norbornadiene, substituted norbornadiene(s), polycyclic norbornenes, and substituted polycyclic norbornene(s). Norbornenes within this group may be generally represented by the structure (E)

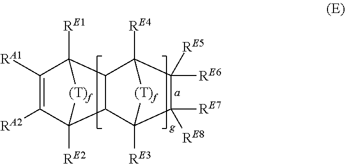

wherein R^{A1} and R^{A2} are as defined above for structure (A), T is as defined above for structure (D), R^{E1}, R^{E2}, R^{E3}, R^{E4}, R^{ES}, R^{E6}, R^{E7}, and R^{E8} are as defined for R^{B1} through R^{B6}, and “a” represents a single bond or a double bond, f is generally 1 or 2, “g” is an integer from 0 to 5, and when “a” is a double bond one of R^{E5}R^{E6} and one of R^{E7}, R^{E8} is not present.

Furthermore, any of the R^{ES}, R^{E6}, R^{E7}, and R^{E8} moieties can be linked to any of the other R^{E}s R^{E6}, R^{E7}, and R^{E8} moieties to provide a substituted or unsubstituted alicyclic group containing 4 to 30 ring carbon atoms or a substituted or unsubstituted aryl group containing 6 to 18 ring carbon atoms or combinations thereof and the linkage may include heteroatoms or functional groups, e.g., the linkage may include without limitation an ether, ester, thioether, amino, alkylamino, imino, or anhydride moiety. The cyclic group can be monocyclic, bicyclic, or polycyclic. When unsaturated the cyclic group can contain monounsaturation or multiunsaturation. When substituted, the rings contain monosubstitution or multisubstitution wherein the substituents are independently selected from hydrogen, hydrocarbyl, substituted hydrocarbyl, heteroatom-containing hydrocarbyl, substituted heteroatom-containing hydrocarbyl, —(Z*)ₙ-Fn where n is 0 or 1, Z* and Fn are as defined previously, and functional groups (Fn) provided above.

Cyclic olefins possessing at least one norbornene moiety have the structure (F):

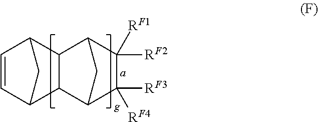

wherein R^{F1}, R^{F2}, R^{F3}, and R^{F4}, are as defined for R^{B1} through R^{B6}, and “a” represents a single bond or a double bond, “g” is an integer from 0 to 5, and when “a” is a double bond one of R^{F1}, R^{F2} and one of R^{F3} R^{F4} is not present.

Furthermore, any of the R^{F1}, R^{F2} R^{F3}, and R^{F4} moieties can be linked to any of the other R^{F1}, R^{F2}, R^{F3}, and R^{F4} moieties to provide a substituted or unsubstituted alicyclic group containing 4 to 30 ring carbon atoms or a substituted or unsubstituted aryl group containing 6 to 18 ring carbon atoms or combinations thereof and the linkage may include heteroatoms or functional groups, e.g., the linkage may include without limitation an ether, ester, thioether, amino, alkylamino, imino, or anhydride moiety. The alicyclic group can be monocyclic, bicyclic, or polycyclic. When unsaturated the cyclic group can contain monounsaturation or multiunsaturation. When substituted, the rings contain monosubstitution or multisubstitution wherein the substituents are independently selected from hydrogen, hydrocarbyl, substituted hydrocarbyl, heteroatom-containing hydrocarbyl, substituted heteroatom-containing hydrocarbyl, —(Z*)ₙ-Fn where n is 0 or 1, Z* and Fn are as defined previously, and functional groups (Fn) provided above

One route for the preparation of hydrocarbyl substituted and functionally substituted norbornenes employs the Diels-Alder cycloaddition reaction in which cyclopentadiene or substituted cyclopentadiene is reacted with a suitable dienophile at elevated temperatures to form the substituted norbornene adduct generally shown by the following reaction Scheme 1:

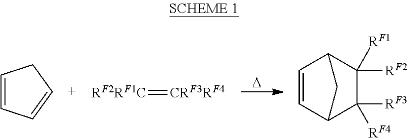

wherein R^{F1} to R^{F4} are as previously defined for structure (F).

Other norbornene adducts can be prepared by the thermal pyrolysis of dicyclopentadiene in the presence of a suitable dienophile. The reaction proceeds by the initial pyrolysis of dicyclopentadiene to cyclopentadiene followed by the Diels-Alder cycloaddition of cyclopentadiene and the dienophile to give the adduct shown below in Scheme 2:

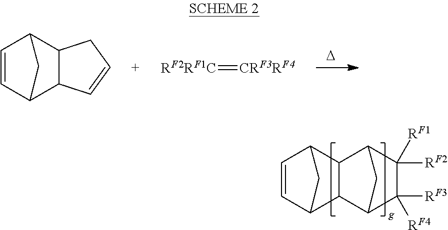

wherein “g” is an integer from 0 to 5, and R^{F1} to R^{F4} are as previously defined for structure (F).

Norbornadiene and higher Diels-Alder adducts thereof similarly can be prepared by the thermal reaction of cyclopentadiene and dicyclopentadiene in the presence of an acetylenic reactant as shown below in Scheme 3:

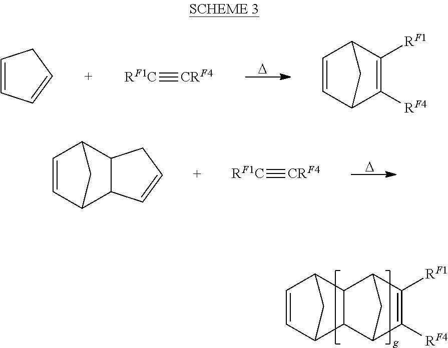

wherein “g” is an integer from 0 to 5, R^{F1} and R^{F4} are as previously defined for structure (F)

Examples of bicyclic and polycyclic olefins thus include, without limitation, dicyclopentadiene (DCPD); trimer and other higher order oligomers of cyclopentadiene including without limitation tricyclopentadiene (cyclopentadiene trimer), cyclopentadiene tetramer, and cyclopentadiene pentamer; ethylidenenorbornene; dicyclohexadiene; norbornene; 5-methyl-2-norbornene; 5-ethyl-2-norbornene; 5-isobutyl-2-norbornene; 5,6-dimethyl-2-norbornene; 5-phenylnorbornene; 5-benzylnorbornene; 5-acetylnorbornene: 5-methoxycarbonylnorbornene; 5-ethyoxycarbonyl-1-norbornene; 5-methyl-5-methoxy-carbonylnorbornene; 5-cyanonorbornene; 5,5,6-trimethyl-2-norbornene; cyclo-hexenylnorbornene; endo, exo-5,6-dimethoxynorbornene; endo, endo-5,6-dimethoxynorbornene; endo, exo-5,6-dimethoxycarbonylnorbornene; endo,endo-5,6-dimethoxycarbonylnorbornene; 2,3-dimethoxynorbornene; norbornadiene; tricycloundecene; tetracyclododecene; 8-methyltetracyclododecene; 8-ethyltetracyclododecene; 8-methoxycarbonyltetracyclododecene; 8-methyl-8-tetracyclododecene; 8-cyanotetracyclododecene; pentacyclopentadecene; pentacyclohexadecene; and the like, and their structural isomers, stereoisomers, and mixtures thereof. Additional examples of bicyclic and polycyclic olefins include, without limitation, C₂-C₁₂ hydrocarbyl substituted norbornenes such as 5-butyl-2-norbornene, 5-hexyl-2-norbornene, 5-octyl-2-norbornene, 5-decyl-2-norbornene, 5-dodecyl-2-norbornene, 5-vinyl-2-norbornene, 5-ethylidene-2-norbornene, 5-isopropenyl-2-norbornene, 5-propenyl-2-norbornene, and 5-butenyl-2-norbornene, and the like. It is well understood by one in the art that bicyclic and polycyclic olefins as disclosed herein may consist of a variety of structural isomers and/or stereoisomers, any and all of which are suitable for use in the invention. Any reference herein to such bicyclic and polycyclic olefins unless specifically stated includes mixtures of any and all such structural isomers and/or stereoisomers.

Cyclic olefins may include C₅ to C₂₄ unsaturated hydrocarbons, as well as C₅ to C₂₄ cyclic hydrocarbons that contain one or more (typically 2 to 12) heteroatoms such as O, N, S, or P. For example, crown ether cyclic olefins may include numerous O heteroatoms throughout the cycle, and these are within the scope of the invention. In addition, cyclic olefins may be C₉ to C₂₄ hydrocarbons that contain one or more (typically 2 or 3) olefins. For example, the cyclic olefin may be mono-, di-, or tri-unsaturated. Examples of cyclic olefins include without limitation cyclooctene, cyclododecene, and (c,t,t)-1,5,9-cyclododecatriene.

The cyclic olefins may also comprise multiple (typically 2 or 3) rings. For example, the cyclic olefin may be mono-, di-, or tri-cyclic. When the cyclic olefin comprises more than one ring, the rings may or may not be fused. Examples of cyclic olefins that comprise multiple rings include norbornene, dicyclopentadiene, tricyclopentadiene, and 5-ethylidene-2-norbornene.

The cyclic olefin may also be substituted, for example, a C₅ to C₂₄ cyclic hydrocarbon wherein one or more (typically 2, 3, 4, or 5) of the hydrogens are replaced with non-hydrogen substituents. Suitable non-hydrogen substituents may be chosen from the substituents described hereinabove. For example, functionalized cyclic olefins, i.e., C₅ to C₂₄ cyclic hydrocarbons wherein one or more (typically 2, 3, 4, or 5) of the hydrogens are replaced with functional groups, are within the scope of the invention. Suitable functional groups may be chosen from the functional groups described hereinabove. For example, a cyclic olefin functionalized with an alcohol group may be used to prepare a telechelic polymer comprising pendent alcohol groups. Functional groups on the cyclic olefin may be protected in cases where the functional group interferes with the metathesis catalyst, and any of the protecting groups commonly used in the art may be employed. Acceptable protecting groups may be found, for example, in Greene et al., Protective Groups in Organic Synthesis, 3rd Ed. (New York: Wiley, 1999). Examples of functionalized cyclic olefins include without limitation 2-hydroxymethyl-5-norbornene, 2-[(2-hydroxyethyl)carboxylate]-5-norbornene, cydecanol, 5-n-hexyl-2-norbornene, 5-n-butyl-2-norbornene.

Cyclic olefins incorporating any combination of the abovementioned features (i.e., heteroatoms, substituents, multiple olefins, multiple rings) are suitable for the methods disclosed herein. Additionally, cyclic olefins incorporating any combination of the abovementioned features (i.e., heteroatoms, substituents, multiple olefins, multiple rings) are suitable for the invention disclosed herein.

The cyclic olefins useful in the methods disclosed herein may be strained or unstrained. It will be appreciated that the amount of ring strain varies for each cyclic olefin compound, and depends upon a number of factors including the size of the ring, the presence and identity of substituents, and the presence of multiple rings. Ring strain is one factor in determining the reactivity of a molecule towards ring-opening olefin metathesis reactions. Highly strained cyclic olefins, such as certain bicyclic compounds, readily undergo ring opening reactions with olefin metathesis catalysts. Less strained cyclic olefins, such as certain unsubstituted hydrocarbon monocyclic olefins, are generally less reactive. In some cases, ring opening reactions of relatively unstrained (and therefore relatively unreactive) cyclic olefins may become possible when performed in the presence of the olefinic compounds disclosed herein. Additionally, cyclic olefins useful in the invention disclosed herein may be strained or unstrained.

The ROMP compositions and/or cyclic olefin compositions of the invention may comprise a plurality of cyclic olefins. A plurality of cyclic olefins may be used to prepare metathesis polymers from the olefinic compound. For example, two cyclic olefins selected from the cyclic olefins described hereinabove may be employed to form metathesis products that incorporate both cyclic olefins. Where two or more cyclic olefins are used, one example of a second cyclic olefin is a cyclic alkenol, i.e., a C₅-C₄ cyclic hydrocarbon wherein at least one of the hydrogen substituents is replaced with an alcohol or protected alcohol moiety to yield a functionalized cyclic olefin.

The use of a plurality of cyclic olefins, and in particular when at least one of the cyclic olefins is functionalized, allows for further control over the positioning of functional groups within the products. For example, the density of cross-linking points can be controlled in polymers and macromonomers prepared using the methods disclosed herein. Control over the quantity and density of substituents and functional groups also allows for control over the physical properties (e.g., melting point, tensile strength, glass transition temperature, etc.) of the products. Control over these and other properties is possible for reactions using only a single cyclic olefin, but it will be appreciated that the use of a plurality of cyclic olefins further enhances the range of possible metathesis products and polymers formed.

Non-limiting examples of cyclic olefins include dicyclopentadiene; tricyclopentadiene: dicyclohexadiene; norbornene; 5-methyl-2-norbornene; 5-ethyl-2-norbornene; 5-isobutyl-2-norbornene; 5,6-dimethyl-2-norbornene; 5-tolyl-2-norbornene; 5-phenyl-2-norbornene; 5-benzylnorbornene; 5-acetylnorbornene; 5-methoxycarbonylnorbornene; 5-ethoxycarbonyl-1-norbornene: 5-methyl-5-methoxy-carbonylnorbornene; 5-cyanonorbornene: 5,5,6-trimethyl-2-norbornene; cyclo-hexenylnorbornene: endo, exo-5,6-dimethoxynorbornene: endo, endo-5,6-dimethoxynorbornene: endo, exo-5-6-dimethoxycarbonylnorbornene; endo, endo-5,6-dimethoxycarbonylnorbornene; 2,3-dimethoxynorbornene: norbornadiene; tricycloundecene; tetracyclododecene; 8-methyltetracyclododecene: 8-ethyl-tetracyclododecene; 8-methoxycarbonyltetracyclododecene; 8-methyl-8-tetracyclo-dodecene; 8-cyanotetracyclododecene; pentacyclopentadecene; pentacyclohexadecene: higher order oligomers of cyclopentadiene such as cyclopentadiene tetramer, cyclopentadiene pentamer, and the like; and C₁-C₂ hydrocarbyl substituted norbornenes such as 5-butyl-2-norbornene; 5-hexyl-2-norbornene; 5-octyl-2-norbornene; 5-decyl-2-norbornene: 5-dodecyl-2-norbornene; 5-vinyl-2-norbornene; 5-ethylidene-2-norbornene; 5-isopropenyl-2-norbornene; 5-propenyl-2-norbornene; and 5-butenyl-2-norbornene, and the like.

In one embodiment, multiunsaturated cyclic olefins include dicyclopentadiene, tricyclopentadiene, and 5-vinyl-2-norbornene, 5-ethylidene-2-norbornene, 5-isopropenyl-2-norbornene, 5-propenyl-2-norbornene, 5-butenyl-2-norbornene, and the like.

In another embodiment, multiunsaturated cyclic olefins include dicyclopentadiene, tricyclopentadiene, and 5-ethylidene-2-norbornene.

An example of a multiunsaturated cyclic olefin is dicyclopentadiene.

An example of a multiunsaturated cyclic olefin is tricyclopentadiene.

An example of a multiunsaturated cyclic olefin is 5-ethylidene-2-norbornene.

The cyclic olefin composition may comprise multiunsaturated cyclic olefins selected from dicyclopentadiene, tricyclopentadiene, 5-ethylidene-2-norbornene, and mixtures thereof, wherein the dicyclopentadiene may be present in an amount of 90 wt. % or greater (e.g., 91 wt. % or greater, 92 wt. % or greater, 93 wt. % or greater, 94 wt. % or greater, 95 wt. % or greater, 96 wt. % or greater, 97 wt. % or greater, 98 wt. % or greater, 99 wt. % or greater, 99.9 wt. % or greater), and the tricyclopentadiene and/or 5-ethylidene-2-norbornene may be present in an amount of 0.1 wt. % or greater (e.g., I wt. % or greater, 2 wt. % or greater, 3 wt. % or greater, 4 wt. % or greater, 5 wt. % or greater, 6 wt. % or greater, 7 wt. % or greater, 8 wt. % or greater, 9 wt. % or greater), based on the total weight of the cyclic olefin composition. For example, cyclic olefin compositions may comprise 90 to 100 wt. % dicyclopentadiene (e.g., 91 to 99.9 wt. % dicyclopentadiene, 92 to 99 wt. %, 93 to 98 wt. %, 94 to 97 wt. %, 95 to 96 wt. %) and 0 to 10 wt. % tricyclopentadiene and/or 5-ethylidene-2-norbornene (e.g., 0.1 to 9 wt. %, 1 to 8 wt. %, 2 to 7 wt. %, 3 to 6 wt. %, 4 to 5 wt. %), based on the total weight of the cyclic olefin composition.

Monounsaturated cyclic olefins, if present, include C₂-C₁₂hydrocarbyl substituted norbornenes (e.g., C₄-C₁₂ hydrocarbyl substituted norbornenes, C₆-C₁₂ hydrocarbyl substituted norbornenes, C₆-C₁₀ hydrocarbyl substituted norbornenes). Monounsaturated cyclic olefins include, for example, 5-tolyl-2-norbornene, 5-phenyl-2-norbornene, 5-butyl-2-norbornene, 5-hexyl-2-norbornene, 5-octyl-2-norbornene, 5-decyl-2-norbornene, 5-dodecyl-2-norbornene.

### Catalyst Composition

The catalyst compositions used in the ROMP composition of the invention disclosed herein comprise, consist essentially of, or consist of at least one metal carbene olefin metathesis catalyst.

A metal carbene olefin metathesis catalyst that may be used in the catalyst composition of the invention disclosed herein is a Group 8 transition metal complex having the structure of formula (I)

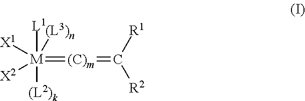

wherein:
M is a Group 8 transition metal;
L¹, L², and L³ are neutral electron donor ligands;
n is 0 or 1, such that L³ may or may not be present;
m is 0, 1, or 2;
k is 0 or 1;
X¹ and X² are anionic ligands; and
R¹ and R² are independently selected from hydrogen, hydrocarbyl, substituted hydrocarbyl, heteroatom-containing hydrocarbyl, substituted heteroatom-containing hydrocarbyl, and functional groups,
wherein any two or more of X¹, X², L¹, L², L³, R¹, and R² can be taken together to form one or more cyclic groups, and further wherein any one or more of X¹, X², L¹, L², L³, R, and R² may be attached to a support.

Additionally, in formula (I), one or both of R¹ and R² may have the structure —(W)ₙ—U⁺V⁻, wherein W is selected from hydrocarbylene, substituted hydrocarbylene, heteroatom-containing hydrocarbylene, or substituted heteroatom-containing hydrocarbylene; U is a positively charged Group 15 or Group 16 element substituted with hydrogen, hydrocarbyl, substituted hydrocarbyl, heteroatom-containing hydrocarbyl, or substituted heteroatom-containing hydrocarbyl; V is a negatively charged counterion; and n is 0 or 1. Furthermore, R¹ and R² may be taken together to form an indenylidene moiety.

Catalysts may contain Ru or Os as the Group 8 transition metal, with Ru preferred.

Numerous embodiments of the catalysts useful in the reactions disclosed herein are described in more detail infra. For the sake of convenience, the catalysts are described in groups, but it should be emphasized that these groups are not meant to be limiting in any way. That is, any of the catalysts useful in the invention may fit the description of more than one of the groups described herein.

A first group of catalysts, then, are commonly referred to as First Generation Grubbs-type catalysts, and have the structure of formula (I). For the first group of catalysts, M is a Group 8 transition metal, m is 0, 1, or 2, and n, X¹, X², L¹, L², L³, R¹, and R² are described as follows.

For the first group of catalysts, n is 0, and L¹ and L² are independently selected from phosphine, sulfonated phosphine, phosphite, phosphinite, phosphonite, arsine, stibine, ether, (including cyclic ethers), imidazole, pyrazine, substituted pyrazine and thioether. Exemplary ligands are trisubstituted phosphines. Trisubstituted phosphines may be of the formula PR^{H1}R^{H2}R^{H3}, where R^{H1}, R^{H2}, and R^{H3} are each independently substituted or unsubstituted aryl or C₁-C₁₀ alkyl, particularly primary alkyl, secondary alkyl, or cycloalkyl. L¹ and L² may be independently selected from the group consisting of trimethylphosphine (PMe₃), triethylphosphine (PEt₃), tri-n-butylphosphine (PBu₃), tri(ortho-tolyl)phosphine (P-o-tolyl₃), tri-tert-butylphosphine (P-tert-Bu₃), tricyclopentylphosphine (PCyclopentyl₃), tricyclohexylphosphine (PCv₃), triisopropylphosphine (P-i-Pr₃), trioctylphosphine (POct₃), triisobutylphosphine, (P-i-Bu₃), triphenylphosphine (PPh₃), tri(pentafluorophenyl)phosphine (P(C₆F)₃), methyldiphenylphosphine (PMePh₂), dimethylphenylphosphine (PMe₂Ph), and diethylphenylphosphine (PEt₂Ph). Alternatively, L¹ and L² may be independently selected from phosphabicycloalkane (e.g., monosubstituted 9-phosphabicyclo-[3.3.1]nonane, or monosubstituted 9-phosphabicyclo[4.2.1]nonane] such as cyclohexylphoban, isopropylphoban, ethylphoban, methylphoban, butylphoban, pentylphoban and the like).

X¹ and X² are anionic ligands, and may be the same or different, or are linked together to form a cyclic group, typically although not necessarily a five- to eight-membered ring. X¹ and X² may be each independently hydrogen, halide, or one of the following groups: C₁-C₂(, alkyl, C₅-C₂₄ aryl, C₁-C₂₀ alkoxy, C₅-C₂₄ aryloxy, C₂-C₂₀ alkoxycarbonyl, C₆-C₂₄ aryloxycarbonyl, C₂-C₂₄ acyl, C₂-C₂₄ acyloxy, C₁-C₂₀ alkylsulfonato, C₅C₂₄ arylsulfonato, C₁-C₂₀ alkylsulfanyl, C₅-C₂₄ arylsulfanyl, C₁-C₂₀ alkylsulfinyl, NO₃, —N═C═O, —N═C═S, or C₅-C₂₄ arylsulfinyl. Optionally, X¹ and X² may be substituted with one or more moieties selected from C₁-C₁₂ alkyl, C₁-C₁₂ alkoxy, C₅-C₂₄ aryl, and halide, which may, in turn, with the exception of halide, be further substituted with one or more groups selected from halide, C₁-C₆ alkyl, C₁-C₆ alkoxy, and phenyl. X¹ and X² may be halide, benzoate, C₂-C₆ acyl, C₂-C₆ alkoxycarbonyl, C₁-C₆ alkyl, phenoxy, C₁-C₆ alkoxy, C₁-C₆ alkylsulfanyl, aryl, or C₁-C₆ alkylsulfonyl. X¹ and X² may each be halide, CF₃CO₂, CH₃CO₂, CFH₂CO₂, (CH₃)₃CO, (CF₃)₂(CH₃)CO. (CF₃)(CH₃)₂CO, PhO, MeO, EtO, tosylate, mesylate, or trifluoromethane-sulfonate. X¹ and X² may each be chloride.

R¹ and R² are independently selected from hydrogen, hydrocarbyl (e.g., C₁-C₂₀ alkyl, C₂-C₂₀ alkenyl, C₂-C₂₀ alkynyl, C₅-C₂₄ aryl, C₆-C₂₄ alkaryl, C₆-C₂₄ aralkyl, etc.), substituted hydrocarbyl (e.g., substituted C₁-C₂₀ alkyl, C₂-C₂₀ alkenyl, C₂-C₂₀ alkynyl, C₅-C₂₄ aryl, C₆-C₂₄ alkaryl, C₆-C₂₄ aralkyl, etc.), heteroatom-containing hydrocarbyl (e.g., heteroatom-containing C₁-C₂(alkyl, C₂-C₂₀ alkenyl, C₂-C₂₀ alkynyl, C₅-C₂₄ aryl, C₆-C₂₄ alkaryl, C₆-C₂₄ aralkyl, etc.), and substituted heteroatom-containing hydrocarbyl (e.g., substituted heteroatom-containing C₁C₂₀ alkyl, C₂-C₂₀ alkenyl, C₂-C₂₀ alkynyl, C₅-C₂₄ aryl, CO—C₂₄ alkaryl, C₆-C₂₄ aralkyl, etc.), and functional groups. R¹ and R² may also be linked to form a cyclic group, which may be aliphatic or aromatic, and may contain substituents and/or heteroatoms. Generally, such a cyclic group will contain 4 to 12, such as 5, 6, 7, or 8 ring atoms.

In certain catalysts, R¹ is hydrogen and R² is selected from C₁-C₂₀ alkyl, C₂-C₂₀ alkenyl, and C₅-C₂₄ aryl, such as C₁-C₆ alkyl, C₂-C₆ alkenyl, and C₅-C₁₄ aryl. R² may be phenyl, vinyl, methyl, isopropyl, or t-butyl, optionally substituted with one or more moieties selected from C₁-C₆ alkyl, C₁-C₆ alkoxy, phenyl, and a functional group Fn as defined earlier herein. R²may be phenyl or vinyl substituted with one or more moieties selected from methyl, ethyl, chloro, bromo, iodo, fluoro, nitro, dimethylamino, methyl, methoxy, and phenyl. R² may be phenyl or —CH═C(CH₃)₂.

Any two or more (typically two, three, or four) of X¹, X², L¹, L², L³, R¹, and R² can be taken together to form a cyclic group, including bidentate or multidentate ligands, as disclosed, for example, in U.S. Pat. No. 5,312,940, the disclosure of which is incorporated herein by reference. When any of X¹, X², L¹, L², L³, R¹, and R² are linked to form cyclic groups, those cyclic groups may contain 4 to 12, such as 4, 5, 6, 7 or 8 atoms, or may comprise two or three of such rings, which may be either fused or linked. The cyclic groups may be aliphatic or aromatic, and may be heteroatom-containing and/or substituted. The cyclic group may, in some cases, form a bidentate ligand or a tridentate ligand. Examples of bidentate ligands include, but are not limited to, bisphosphines, dialkoxides, alkyldiketonates, and aryldiketonates.

A second group of catalysts, commonly referred to as Second Generation Grubbs-type catalysts, have the structure of formula (I), wherein L¹ is a carbene ligand having the structure of formula (II)

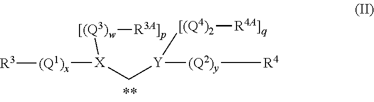

such that the complex may have the structure of formula (III)

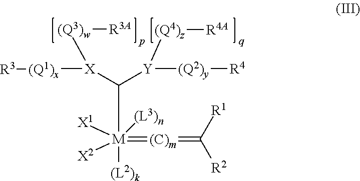

wherein M, m, n, X¹, X², L², L³, R¹, and R² are as defined for the first group of catalysts, and the remaining substituents are as follows:
   X and Y are heteroatoms typically selected from N, O, S, and P. Since O and S are divalent, p is necessarily 0 when X is O or S, q is necessarily 0 when Y is O or S, and k is 0 or 1. However, when X is N or P, then p is 1, and when Y is N or P, then q is 1. Both X and Y may be N;
   Q¹, Q², Q³, and Q⁴ are linkers, e.g., hydrocarbylene (including substituted hydrocarbylene, heteroatom-containing hydrocarbylene, and substituted heteroatom-containing hydrocarbylene, such as substituted and/or heteroatom-containing alkylene) or —(CO)—, and w, x, y, and z are independently 0 or 1, meaning that each linker is optional, w, x, y, and z may all be 0. Further, two or more substituents on adjacent atoms within Q¹, Q², Q³, and Q⁴ may be linked to form an additional cyclic group; and
   R³, R^{3A}, R⁴, and R^{4A} are independently selected from hydrogen, hydrocarbyl, substituted hydrocarbyl, heteroatom-containing hydrocarbyl, and substituted heteroatom-containing hydrocarbyl. In addition, X and Y may be independently selected from carbon and one of the heteroatoms mentioned above, no more than one of X or Y may be carbon. Also, L² and L³ may be taken together to form a single bindentate electron-donating heterocyclic ligand. Furthermore, R¹ and R² may be taken together to form an indenylidene moiety. Moreover, X¹, X², L², L³, X and Y may be further coordinated to boron or to a carboxylate.

In addition, any two or more of X¹, X², L¹, L², L³, R¹, R², R³, R^{3A}, R⁴, R^{4A}, Q¹, Q², Q³, and Q⁴ can be taken together to form a cyclic group, and any one or more of X¹, X², L², L³, Q¹, Q², Q³, Q⁴, R, R². R³, R^{3A}, R⁴, and R^{4A} may be attached to a support. Any two or more of X¹, X², L¹, L², L³, R¹, R², R³, R^{3A}, R⁴, and R^{4A} can also be taken to be -A-Fn, wherein “A” is a divalent hydrocarbon moiety selected from alkylene and arylalkylene, wherein the alkyl portion of the alkylene and arylalkylene groups can be linear or branched, saturated or unsaturated, cyclic or acyclic, and substituted or unsubstituted, wherein the aryl portion of the of arylalkylene can be substituted or unsubstituted, and wherein hetero atoms and/or functional groups may be present in either the aryl or the alkyl portions of the alkylene and arylalkylene groups, and Fn is a functional group, or together to form a cyclic group, and any one or more of X¹, X², L². L³ Q Q² Q³ Q⁴, R¹, R², R³, R^{3A}, R⁴, and R^{4A} may be attached to a support.

A particular class of carbene ligands having the structure of formula (II), where R^{3A} and R^{4A}are linked to form a cyclic group and at least one of X or Y is a nitrogen, or at least one of Q³ or Q⁴ is a heteroatom-containing hydrocarbylene or substituted heteroatom-containing hydrocarbylene, where at least one heteroatom is a nitrogen, are commonly referred to as N-heterocyclic carbene (NHC) ligands.

R^{3A} and R^{4A} may be linked to form a cyclic group so that the carbene ligand has the structure of formula (IV)

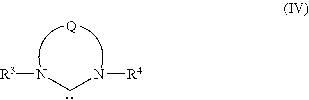

wherein R³ and R⁴ are as defined for the second group of catalysts above, with at least one of R³ and R⁴, such as both R³ and R⁴, being alicyclic or aromatic of one to about five rings, and optionally containing one or more heteroatoms and/or substituents. Q is a linker, typically a hydrocarbylene linker, including substituted hydrocarbylene, heteroatom-containing hydrocarbylene, and substituted heteroatom-containing hydrocarbylene linkers, wherein two or more substituents on adjacent atoms within Q may also be linked to form an additional cyclic structure, which may be similarly substituted to provide a fused polycyclic structure of two to about five cyclic groups. Q is often, although not necessarily, a two-atom linkage or a three-atom linkage.

Examples of N-heterocyclic carbene (NHC) ligands and acyclic diaminocarbene ligands suitable as L¹ thus include, but are not limited to, the following where DIPP or DiPP is diisopropylphenyl and Mes is 2,4,6trimethylphenyl:

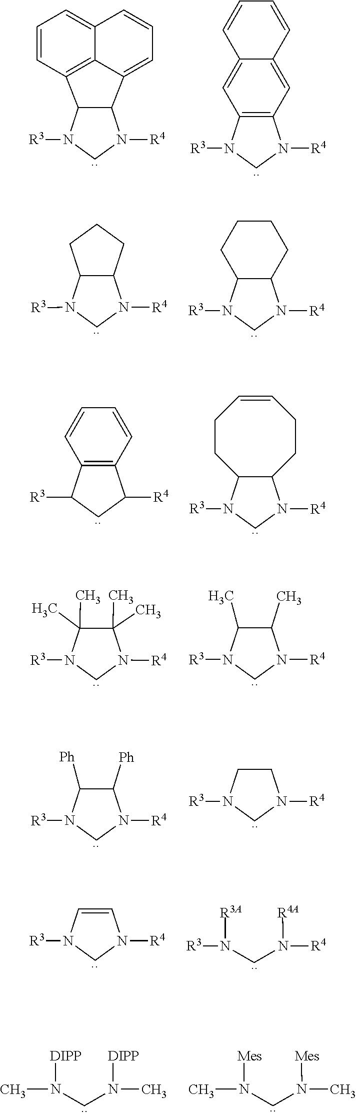

Additional examples of N-heterocyclic carbene (NHC) ligands and acyclic diaminocarbene ligands suitable as L¹ thus include, but are not limited to the following:

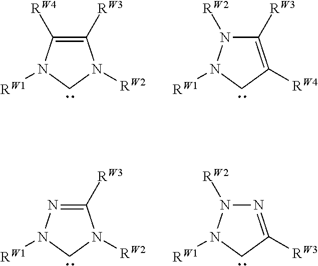

wherein R^{W1}, R^{W2}, R^{W3}, R^{W4} are independently hydrogen, unsubstituted hydrocarbyl, substituted hydrocarbyl, or heteroatom containing hydrocarbyl, and where one or both of R^{W3} and R^{W4} may be in independently selected from halogen, nitro, amido, carboxyl, alkoxy, aryloxy, sulfonyl, carbonyl, thio, or nitroso groups.

Additional examples of N-heterocyclic carbene (NHC) ligands suitable as L¹ are further described in U.S. Pat. Nos. 7,378,528; 7,652,145; 7,294,717; 6,787,620; 6,635,768; and 6,552,139, the disclosure of each of which is incorporated herein by reference.

Additionally, thermally activated N-Heterocyclic Carbene Precursors as disclosed in U.S. Pat. No. 6,838,489, the disclosure of which is incorporated herein by reference, may also be used with the invention.

When M is ruthenium, then, the complexes may have the structure of formula (V)

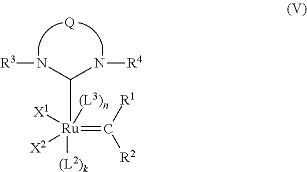

wherein n, X¹, X², L², L³, R¹, and R² are as defined for the first group of catalysts, and k, R³, R⁴, and Q are as defined for the second group of catalysts.

More preferably, Q is a two-atom linkage having the structure —CR¹¹R¹²—CR¹³R¹⁴— or —CR¹¹═CR¹³—, such as —CR¹¹R¹²—CR¹³R¹⁴—, wherein R¹¹, R¹², R¹³, and R¹⁴ are independently selected from hydrogen, hydrocarbyl, substituted hydrocarbyl, heteroatom-containing hydrocarbyl, substituted heteroatom-containing hydrocarbyl, and functional groups. Examples of functional groups here include without limitation carboxyl, C₁-C₂₀ alkoxy, C₅-C₂₄ aryloxy, C₂-C₂₀ alkoxycarbonyl, C₅-C₂₄ alkoxycarbonyl, C₂-C₂₄ acyloxy, C₁-C₂₀ alkylthio, C₅-C₂₄ arylthio, C₁C₂₀ alkylsulfonyl, and C₁-C₂₀ alkylsulfinyl, optionally substituted with one or more moieties selected from C₁-C₁₂ alkyl, C₁-C₁₂ alkoxy, C₅-C₁₄ aryl, hydroxyl, sulfhydryl, formyl, and halide. R¹¹, R¹², R¹³, and R¹⁴ may be independently selected from hydrogen, C₁-C₁₂ alkyl, substituted C₁-C₁₂ alkyl, C₁-C₁₂ heteroalkyl, substituted C₁-C₁₂ heteroalkyl, phenyl, and substituted phenyl. Alternatively, any two of R¹¹, R¹², R¹³, and R¹⁴ may be linked together to form a substituted or unsubstituted, saturated or unsaturated ring structure, e.g., a C₄-C₁₂ alicyclic group or a C₅ or C₆ aryl group, which may itself be substituted, e.g., with linked or fused alicyclic or aromatic groups, or with other substituents. In one further aspect, any one or more of R¹¹, R¹², R¹³, and R¹⁴ comprises one or more of the linkers. Additionally, R³ and R⁴ may be unsubstituted phenyl or phenyl substituted with one or more substituents selected from C₁-C₂₀ alkyl, substituted C₁-C₂₀ alkyl, C₁-C₂₀ heteroalkyl, substituted C₁-C₂₀ heteroalkyl, C₅-C₂₄ aryl, substituted C₅-C₂₄ aryl, C₅-C₂₄ heteroaryl, C₆-C₂₄ aralkyl, C₆-C₂₄ alkaryl, or halide. Furthermore, X¹ and X² may be halogen.

When R³ and R⁴ are aromatic, they are typically although not necessarily composed of one or two aromatic rings, which may or may not be substituted, e.g., R³ and R⁴ may be phenyl, substituted phenyl, biphenyl, substituted biphenyl, or the like. R³ and R⁴ may be the same and are each unsubstituted phenyl or phenyl substituted with up to three substituents selected from C₁-C₂₀ alkyl, substituted C₁-C₂₀ alkyl, C₁-C₂₀ heteroalkyl, substituted C₁-C₂₀ heteroalkyl, C₅-C₂₄ aryl, substituted C₅-C₂₄ aryl, C₅-C₂₄ heteroaryl, C₆-C₂₄ aralkyl, C₆-C₂₄ alkaryl, or halide. Any substituents present may be hydrogen, C₁-C₁₂ alkyl, C₁-C₁₂ alkoxy, C₅-C₁₄ aryl, substituted C₅-C₁₄ aryl, or halide. As an example, R³ and R⁴ are mesityl (i.e., Mes as defined herein).

In a third group of catalysts having the structure of formula (I), M, m, n, X¹, X², R¹, and R² are as defined for the first group of catalysts, L¹ is a strongly coordinating neutral electron donor ligand such as any of those described for the first and second group of catalysts, and L² and L³ are weakly coordinating neutral electron donor ligands in the form of optionally substituted heterocyclic groups. Again, n is 0 or 1, such that L³ may or may not be present. Generally, in the third group of catalysts, L² and L³ are optionally substituted five- or six-membered monocyclic groups containing 1 to 4 (e.g., 1 to 3, I to 2) heteroatoms, or are optionally substituted bicyclic or polycyclic structures composed of 2 to 5 such five- or six-membered monocyclic groups. If the heterocyclic group is substituted, it should not be substituted on a coordinating heteroatom, and any one cyclic moiety within a heterocyclic group will generally not be substituted with more than 3 substituents.

For the third group of catalysts, examples of L² and L³ include, without limitation, heterocycles containing nitrogen, sulfur, oxygen, or a mixture thereof.

Examples of nitrogen-containing heterocycles appropriate for L² and L³ include pyridine, bipyridine, pyridazine, pyrimidine, bipyridamine, pyrazine, 1,3,5-triazine, 1,2,4triazine, 1,2,3-triazine, pyrrole, 2H-pyrrole, 3H-pyrrole, pyrazole, 2H-imidazole, 1,2,3triazole, 1,2,4-triazole, indole, 3H-indole, 1H-isoindole, cyclopenta(b)pyridine, indazole, quinoline, bisquinoline, isoquinoline, bisisoquinoline, cinnoline, quinazoline, naphthyridine, piperidine, piperazine, pyrrolidine, pyrazolidine, quinuclidine, imidazolidine, picolylimine, purine, benzimidazole, bisimidazole, phenazine, acridine, and carbazole. Additionally, the nitrogen-containing heterocycles may be optionally substituted on a non-coordinating heteroatom with a non-hydrogen substitutent.

Examples of sulfur-containing heterocycles appropriate for L² and L³ include thiophene, 1,2-dithiole. 1,3-dithiole, thiepin, benzo(b)thiophene, benzo(c)thiophene, thionaphthene, dibenzothiophene, 2H-thiopyran, 4H-thiopyran, and thioanthrene.

Examples of oxygen-containing heterocycles appropriate for L² and L³ include 2Hpyran, 4H-pyran, 2-pyrone, 4-pyrone, 1,2-dioxin, 1,3-dioxin, oxepin, furan, 2H1benzopyran, coumarin, coumarone, chromene, chroman-4-one, isochromen-1-one, isochromen-3-one, xanthene, tetrahydrofuran, 1,4-dioxan, and dibenzofuran.

Examples of mixed heterocycles appropriate for L² and L³ include isoxazole, oxazole, thiazole, isothiazole, 1,2,3-oxadiazole, 1,2,4-oxadiazole, 1,3,4-oxadiazole, 1,2,3,4-oxatriazole, 1,2,3,5-oxatriazole, 3H-1,2,3-dioxazole, 3H-1,2-oxathiole, 1,3-oxathiole, 4H-1,2-oxazine, 2H1,3-oxazine, 1,4-oxazine, 1,2,5-oxathiazine, o-isooxazine, phenoxazine, phenothiazine, pyrano[3,4-b]pyrrole, indoxazine, benzoxazole, anthranil, and morpholine.

L² and L³ ligands may be aromatic nitrogen-containing and oxygen-containing heterocycles, such as monocyclic N-heteroaryl ligands that are optionally substituted with 1 to 3 (e.g., 1 or 2) substituents. Specific examples of L² and L³ ligands are pyridine and substituted pyridines, such as 3bromopyridine, 4-bromopyridine, 3,5-dibromopyridine, 2,4,6-tribromopyridine, 2,6dibromopyridine, 3-chloropyridine, 4-chloropyridine, 3,5-dichloropyridine, 2,4,6trichloropyridine, 2,6-dichloropyridine, 4-iodopyridine, 3,5-diiodopyridine, 3,5-dibromo-4-methylpyridine, 3,5-dichloro-4-methylpyridine, 3,5-dimethyl-4-bromopyridine, 3,5dimethylpyridine, 4-methylpyridine, 3,5-diisopropylpyridine, 2,4,6-trimethylpyridine, 2,4,6triisopropylpyridine, 4-(tert-butyl)pyridine, 4-phenylpyridine, 3,5-diphenylpyridine, 3,5dichloro-4-phenylpyridine, and the like.

In general, any substituents present on L² and/or L³ are selected from halo, C₁-C₂₀ alkyl, substituted C₁-C₂₀ alkyl, C₁-C₂₀ heteroalkyl, substituted C₁-C₂₀ heteroalkyl, C₅-C₂₄ aryl, substituted C₅-C₂₄ aryl, C₅-C₂₄ heteroaryl, substituted C₅-C₂₄ heteroaryl, C₆-C₂₄ alkaryl, substituted C₆-C₂₄ alkaryl, C₆-C₂₄ heteroalkaryl, substituted C₆-C₂₄ heteroalkaryl, C₆-C₂₄ aralkyl, substituted C₆-C₂₄ aralkyl, C₆-C₂₄ heteroaralkyl, substituted C₆-C₂₄ heteroaralkyl, and functional groups, with suitable functional groups including, without limitation, C₁-C₂₀ alkoxy, C₅-C₂₄ aryloxy, C₂-C₂₀ alkylcarbonyl, C₆-C₂₄ arylcarbonyl, C₂-C₂₀ alkylcarbonyloxy, C₆-C₂₄ arylcarbonyloxy, C₂-C₂₀ alkoxycarbonyl, C₆-C₂₄ aryloxycarbonyl, halocarbonyl, C₂-C₂₀ alkylcarbonato, C₆-C₂₄ arylcarbonato, carboxy, carboxylato, carbamoyl, mono-(C₁-C₂₀ alkyl)-substituted carbamoyl, di-(C₁-C₂₀ alkyl)-substituted carbamoyl, di-N—(C₁-C₂₀ alkyl). N—(C₅-C₂₄ aryl)-substituted carbamoyl, mono-(C₅-C₂₄ aryl)-substituted carbamoyl, di-(Co-C₂₄ aryl)-substituted carbamoyl, thiocarbamoyl, mono-(C₁-C₂₀ alkyl)-substituted thiocarbamoyl, di(C₁C₂₀ alkyl)-substituted thiocarbamoyl, di-N—(C₁-C₂₀ alkyl)-N-(C₆-C₂₄ aryl)-substituted thiocarbamoyl, mono-(Co-C₂₄ aryl)-substituted thiocarbamoyl, di-(Co-C₂₄ aryl)-substituted thiocarbamoyl, carbamido, formyl, thioformyl, amino, mono-(C₁-C₂₀ alkyl)-substituted amino, di-(C₁-C₂₀ alkyl)-substituted amino, mono-(C₅-C₂₄ aryl)-substituted amino, di-(C₅-C₂₄ aryl)-substituted amino, di-N—(C₁-C₂₀ alkyl), N—(C₅-C₂₄ aryl)-substituted amino, C₂-C₂₀ alkylamido, C₆C₂₄ arylamido, imino, C₁-C₂₀ alkylimino, C₅-C₂₄ arylimino, nitro, and nitroso. In addition, two adjacent substituents may be taken together to form a ring, generally a five- or six-membered alicyclic or aryl ring, optionally containing 1 to 3 heteroatoms and 1 to 3 substituents as above.

Substituents on L² and L³ include, without limitation, halo, C₁-C₁₂ alkyl, substituted C₁-C₁₂ alkyl, C₁-C₁₂ heteroalkyl, substituted C₁-C₁₂ heteroalkyl, C₅-C₁₄ aryl, substituted C₅-C₁₄ aryl, C₅-C₁₄ heteroaryl, substituted C₅-C₁₄ heteroaryl, C₆-C₁₆ alkaryl, substituted C₆-C₁₆ alkaryl, C₆-C₁₆ heteroalkaryl, substituted C₆-C₁₆heteroalkaryl, C₆-C₁₆ aralkyl, substituted C₆-C₁₆ aralkyl, C₆-C₁₆ heteroaralkyl, substituted C₆-C₁₆ heteroaralkyl, C₁-C₁₂ alkoxy, C₅-C₁₄ aryloxy, C₂-C₁₂ alkylcarbonyl, C₆-C₁₄ arylcarbonyl, C₂-C₁₂ alkylcarbonyloxy, C₆-C₁₄ arylcarbonyloxy, C₂-C₁₂ alkoxycarbonyl, C₆-C₁₄ aryloxycarbonyl, halocarbonyl, formyl, amino, mono-(C₁-C₁₂ alkyl)-substituted amino, di-(C₁C₁₂alkyl)-substituted amino, mono-(C₅-C₁₄ aryl)-substituted amino, di-(C₅-C₁₄ aryl)-substituted amino, and nitro.

In another embodiment, the substituents are halo, C₁-C₆ alkyl, C₁-C₆ haloalkyl, C₁-C₆ alkoxy, phenyl, substituted phenyl, formyl, N,N-di(C₁-C₆ alkyl)amino, nitro, and nitrogen heterocycles as described above (including, for example, pyrrolidine, piperidine, piperazine, pyrazine, pyrimidine, pyridine, pyridazine, etc.).

L² and L³ may also be taken together to form a bidentate or multidentate ligand containing two or more, generally two, coordinating heteroatoms such as N, O, S, or P, such as diimine ligands of the Brookhart type. One representative bidentate ligand has the structure of formula (VI)

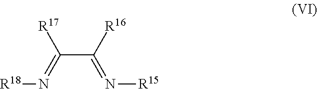

wherein R¹⁵, R¹⁶, R¹⁷, and R¹⁸ hydrocarbyl (e.g., C₁-C₂₀ alkyl, C₂-C₂₀ alkenyl, C₂-C₂₀ alkynyl, C₅-C₂₄ aryl, C₆-C₂₄ alkaryl, or C₆-C₂₄ aralkyl), substituted hydrocarbyl (e.g., substituted C₁-C₂₀ alkyl, C₂-C₂₀ alkenyl, C₂-C₂₀ alkynyl, C₅-C₂₄ aryl, C₆-C₂₄ alkaryl, or C₆-C₂₄ aralkyl), heteroatom-containing hydrocarbyl (e.g., C₁-C₂₀ heteroalkyl, C₅-C₂₄heteroaryl, heteroatom-containing C₆-C₂₄ aralkyl, or heteroatom-containing C₆-C₂₄ alkaryl), or substituted heteroatom-containing hydrocarbyl (e.g., substituted C₁-C₂₀ heteroalkyl, C₅-C₂₄ heteroaryl, heteroatom-containing C₆-C₂₄ aralkyl, or heteroatom-containing C₆-C₂₄ alkaryl), or (1) R¹⁵ and R¹⁶, (2) R¹⁷ and R¹⁸, (3) R¹⁶ and R¹⁷, or (4) both R¹⁵ and R¹⁶, and R¹⁷ and R¹⁸, may be taken together to form a ring, i.e., an N-heterocycle. Cyclic groups in such a case may be five- and six-membered rings, typically aromatic rings.

In a fourth group of catalysts that have the structure of formula (I), two of the substituents are taken together to form a bidentate ligand or a tridentate ligand. Examples of bidentate ligands include, but are not limited to, bisphosphines, dialkoxides, alkyldiketonates, and aryldiketonates. Specific examples include P(Ph)₂CH₂CH₂P(Ph)₂-, As(Ph)₂CH₂CH₂As(Ph₂)-, —P(Ph)₂CH₂CH₂C(CF₃)₂O—, binaphtholate dianions, pinacolate dianions, —P(CH₃)₂(CH₂)₂P(CH₃)₂—, and —OC(CH₃)₂(CH₃)₂CO—. Bidentate ligands may be P(Ph)₂ CH₂CH₂P(Ph)₂- and P(CH₃)₂(CH₂)₂P(CH₃)₂-. Tridentate ligands include, but are not limited to, (CH₃)₂NCH₂CH₂P(Ph)CH₂CH₂N(CH₃)₂. Other tridentate ligands are those in which any three of X¹, X², L¹, L², L³, R¹, and R² (e.g., X¹, L¹, and L²) are taken together to be cyclopentadienyl, indenyl, or fluorenyl, each optionally substituted with C₂-C₂₀ alkenyl, C₂C₂₀ alkynyl, C₁-C₂₀ alkyl, C₅-C₂₀ aryl, C₁-C₂₀ alkoxy, C₂-C₂₀ alkenyloxy, C₂-C₂₀ alkynyloxy, C₅C₂₀ aryloxy, C₂-C₂₀ alkoxycarbonyl, C₁-C₂₀ alkylthio, C₁-C₂₀ alkylsulfonyl, or C₁-C₂₀ alkylsulfinyl, each of which may be further substituted with C₁-C₆ alkyl, halide, C₁-C₆ alkoxy or with a phenyl group optionally substituted with halide, C₁-C₆ alkyl, or C₁-C₆ alkoxy. In compounds of this type, X, L¹, and L² may be taken together to be cyclopentadienyl or indenyl, each optionally substituted with vinyl, C₁-C₁₀ alkyl, C₅-C₂₀ aryl, C₁-C₁₀ carboxylate, C₂-C₁₀ alkoxycarbonyl, C₁-C₁₀ alkoxy, or C₅-C₂₀ aryloxy, each optionally substituted with C₁-C₆ alkyl, halide, C₁-C₆ alkoxy or with a phenyl group optionally substituted with halide, C₁-C₆ alkyl or C₁C₆ alkoxy. X, L¹ and L² may be taken together to be cyclopentadienyl, optionally substituted with vinyl, hydrogen, methyl, or phenyl. Tetradentate ligands include, but are not limited to O₂C(CH₂)₂P(Ph)(CH₂)₂P(Ph)(CH₂)₂CO₂, phthalocyanines, and porphyrins.

Complexes wherein Y is coordinated to the metal are examples of a fifth group of catalysts, and are commonly called “Grubbs-Hoveyda” catalysts. Grubbs-Hoveyda metathesis-active metal carbene complexes may be described by the formula (VII)

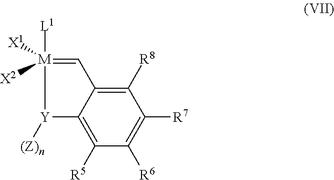

wherein:
M is a Group 8 transition metal, particularly Ru or Os, or, more particularly, Ru;
X¹, X², and L¹ are as previously defined herein for the first and second groups of catalysts;
Y is a heteroatom selected from N, O, S, and P; for example, Y is O or N;
R⁵, R⁶, R⁷, and R⁸ are each, independently, selected from the group consisting of hydrogen, halogen, alkyl, alkenyl, alkynyl, aryl, heteroalkyl, heteroatom containing alkenyl, heteroalkenyl, heteroaryl, alkoxy, alkenyloxy, aryloxy, alkoxycarbonyl, carbonyl, alkylamino, alkylthio, aminosulfonyl, monoalkylaminosulfonyl, dialkylaminosulfonyl, alkylsulfonyl, nitrile, nitro, alkylsulfnyl, trihaloalkyl, perfluoroalkyl, carboxylic acid, ketone, aldehyde, nitrate, cyano, isocyanate, hydroxyl, ester, ether, amine, imine, amide, halogen-substituted amide, trifluoroamide, sulfide, disulfide, sulfonate, carbamate, silane, siloxane, phosphine, phosphate, borate, or -A-Fn, wherein “A” and Fn have been defined above; and any combination of Y, Z, R⁵, R⁶, R⁷, and R⁸ can be linked to form one or more cyclic groups;
n is 0, 1, or 2, such that n is 1 for the divalent heteroatoms O or S, and n is 2 for the trivalent heteroatoms N or P; and
   Z is a group selected from hydrogen, alkyl, aryl, functionalized alkyl, functionalized aryl where the functional group(s) may independently be one or more or the following: alkoxy, aryloxy, halogen, carboxylic acid, ketone, aldehyde, nitrate, cyano, isocyanate, hydroxyl, ester, ether, amine, imine, amide, trifluoroamide, sulfide, disulfide, carbamate, silane, siloxane, phosphine, phosphate, or borate; methyl, isopropyl, sec-butyl, t-butyl, neopentyl, benzyl, phenyl and trimethylsilyl; and wherein any combination or combinations of X¹, X², L¹,Y, Z, R⁵, R⁶, R⁷, and R⁸ may be linked to a support. Additionally, R⁵, R⁶, R⁷, R⁸, and Z may independently be thioisocyanate, cyanato, or thiocyanato.

Examples of complexes comprising Grubbs-Hoveyda ligands suitable in the invention include:

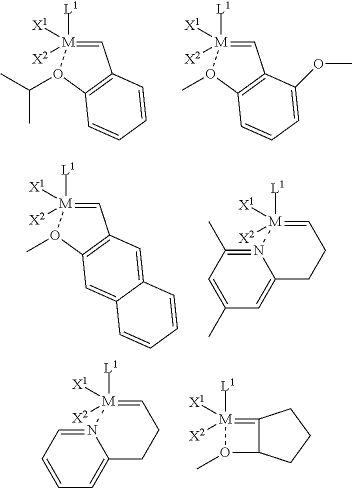

wherein L¹, X¹, X², and M are as described for any of the other groups of catalysts. Suitable chelating carbenes and carbene precursors are further described by Pederson et al. (U.S. Pat. Nos. 7,026,495 and 6,620,955, the disclosure of both of which is incorporated herein by reference) and Hoveyda et al. (U.S. Pat. No. 6,921,735 and WO0214376, the disclosure of both of which is incorporated herein by reference).

Other useful complexes include structures wherein L² and R² according to formulae (I), (III), or (V) are linked, such as styrenic compounds that also include a functional group for attachment to a support. Examples in which the functional group is a trialkoxysilyl functionalized moiety include, but are not limited to, the following:

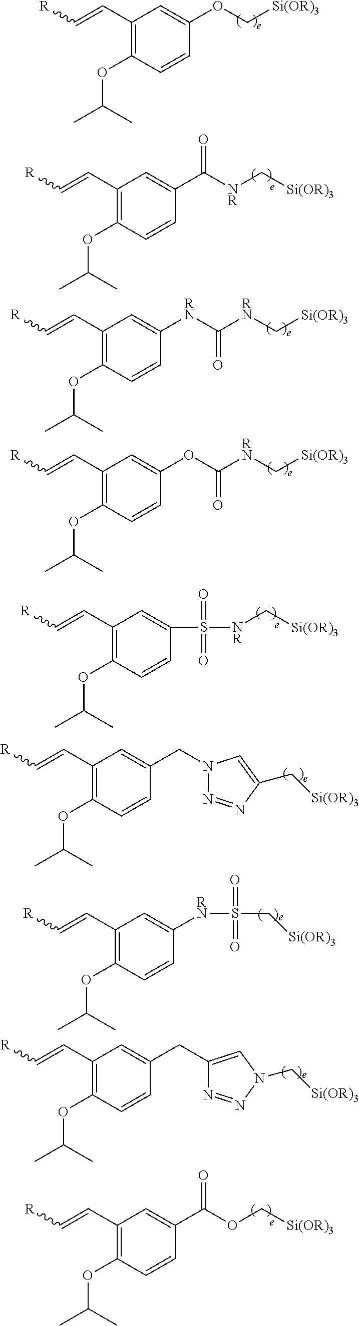

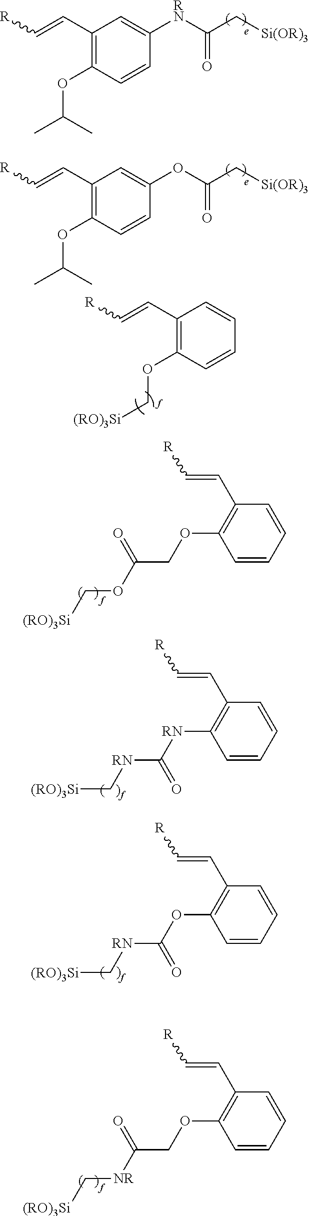

Further examples of complexes having linked ligands include those having linkages between a neutral NHC ligand and an anionic ligand, a neutral NHC ligand and an alkylidine ligand, a neutral NHC ligand and an L² ligand, a neutral NHC ligand and an L³ ligand, an anionic ligand and an alkylidine ligand, and any combination thereof. While the possible structures are too numerous to list herein, some suitable structures based on formula (III) include:

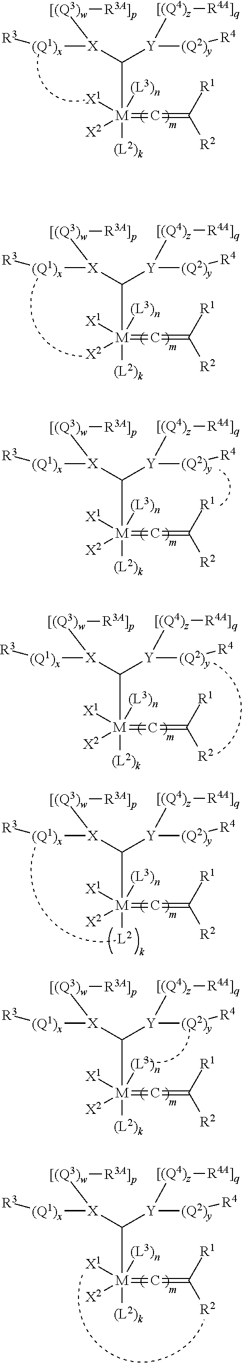

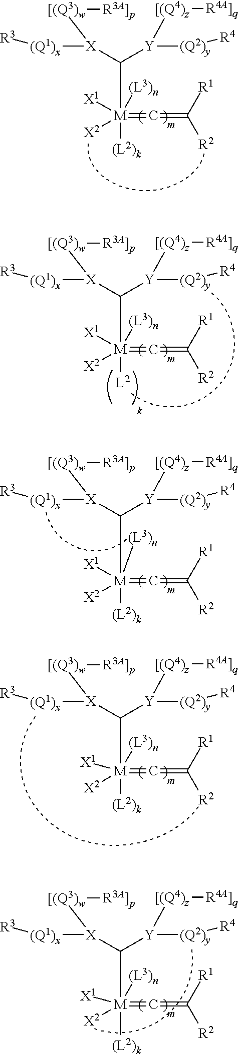

In addition to the catalysts that have the structure of formula (I), as described above, other transition metal carbene complexes include, but are not limited to:
neutral ruthenium or osmium metal carbene complexes containing metal centers that are formally in the +2 oxidation state, have an electron count of 16, are penta-coordinated, and are of the general formula (IX);
neutral ruthenium or osmium metal carbene complexes containing metal centers that are formally in the +2 oxidation state, have an electron count of 18, are hexa-coordinated, and are of the general formula (X);
cationic ruthenium or osmium metal carbene complexes containing metal centers that are formally in the +2 oxidation state, have an electron count of 14, are tetra-coordinated, and are of the general formula (XI); and
cationic ruthenium or osmium metal carbene complexes containing metal centers that are formally in the +2 oxidation state, have an electron count of 14 or 16, are tetra-coordinated or penta-coordinated, respectively, and are of the general formula (XII)

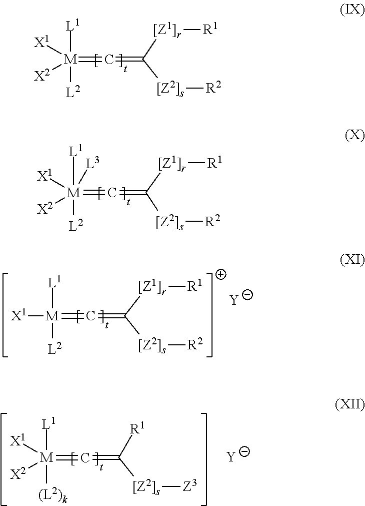

wherein:
M, X¹, X², L¹, L², L, R¹, and R² are as defined for any of the previously defined four groups of catalysts;
r and s are independently 0 or 1;
t is an integer in the range of 0 to 5;
k is an integer in the range of 0 to 1;
Y is any non-coordinating anion (e.g., a halide ion, BF₄⁻, etc.);
Z¹ and Z² are independently selected from —O—, —S—, —NR²—, —PR²—, —P(═O)R²—, —P(OR²)—, —P(═O)(OR²)—, —C(═O)—, —C(═O)O—, —OC(═O)—, —OC(═O)O—, —S(═O)—, —S(═O)₂—, -, and an optionally substituted and/or optionally heteroatom-containing C₁-C₂₀ hydrocarbylene linkage;
Z³ is any cationic moiety such as —P(R²)₃⁺ or —N(R²)₃⁺; and
   any two or more of X¹, X², L¹, L², L³, Z¹, Z², Z³, R¹, and R² may be taken together to form a cyclic group, e.g., a multidentate ligand, and wherein any one or more of X X², L¹, L², L³, Z¹, Z², Z³, R¹, and R² may be attached to a support.

Additionally, another group of metal carbene olefin metathesis catalysts that may be used in the catalyst composition of the invention disclosed herein, is a Group 8 transition metal complex having the structure of formula (XIII):

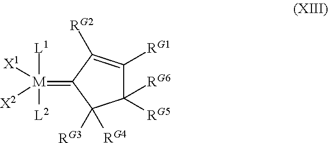

wherein:
M is a Group 8 transition metal, particularly ruthenium or osmium, or more particularly, ruthenium;
X¹, X², L¹ and L² are as defined for the first and second groups of catalysts defined above; and
   R^{G1}, R^{G2}, R^{G3}, R^{G4}, R^{G5}, and R^{G6} are each independently selected from the group consisting of hydrogen, halogen, alkyl, alkenyl, alkynyl, aryl, heteroalkyl, heteroatom containing alkenyl, heteroalkenyl, heteroaryl, alkoxy, alkenyloxy, aryloxy, alkoxycarbonyl, carbonyl, alkylamino, alkylthio, aminosulfonyl, monoalkylaminosulfonyl, dialkylaminosulfonyl, alkylsulfonyl, nitrile, nitro, alkylsulfinyl, trihaloalkyl, perfluoroalkyl, carboxylic acid, ketone, aldehyde, nitrate, cyano, isocyanate, thioisocyanate, cyanato, thiocyanato, hydroxyl, ester, ether, thioether, amine, alkylamine, imine, amide, halogen-substituted amide, trifluoroamide, sulfide, disulfide, sulfonate, carbamate, silane, siloxane, phosphine, phosphate, borate, or -A-Fn, wherein “A” is a divalent hydrocarbon moiety selected from alkylene and arylalkylene, wherein the alkyl portion of the alkylene and arylalkylene groups can be linear or branched, saturated or unsaturated, cyclic or acyclic, and substituted or unsubstituted, wherein the aryl portion of the arylalkylene can be substituted or unsubstituted, and wherein hetero atoms and/or functional groups may be present in either the aryl or the alkyl portions of the alkylene and arylalkylene groups, and Fn is a functional group, or any one or more of the R^{G1}, R^{G2}, R^{G3}, R^{G4}, R^{G5}, and R^{G6} may be linked together to form a cyclic group, or any one or more of the R^{G1}, R^{G2}, R^{G3}, R^{G4}, R^{G5}, and R^{G6} may be attached to a support.

Additionally, one Group 8 transition metal complex of formula XIII is a Group 8 transition metal complex of formula (XIV):

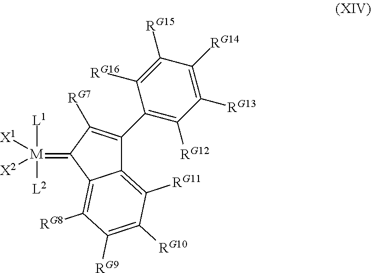

wherein:
M, X¹, X², L¹, L², are as defined above for Group 8 transition metal complex of formula XIII; and R^{G7}, R^{G8}, R^{G9}, R^{G10}, R^{G11}, R^{G12}, R^{G13} R^{G14}, R^{G15}, and R^{G16} are as defined above for R^{G1}, R^{G2} R^{G3}, R^{G4}, R^{G5}, and R^{G6} for Group 8 transition metal complex of formula XIII or any one or more of the R^{G7}, R^{G8}, R^{G9}, R^{G10}, R^{G11}, R^{G12}, R^{G13}, R^{G14}, R^{G15}, and R^{G16} may be linked together to form a cyclic group, or any one or more of the R^{G7}, R^{G8}, R^{G9}, R^{G10}, R^{G11}, R^{G12}, R^{G13}, R^{G14}, R^{G15}, and R^{G16} may be attached to a support.

Additionally, another Group 8 transition metal complex of formula XIII is a Group 8 transition metal complex of formula (XV):

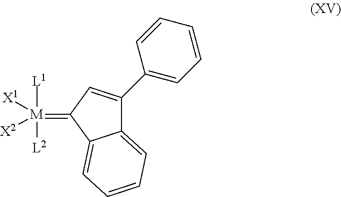

wherein M, X¹, X², L¹, and L² are as defined above for Group 8 transition metal complex of formula XIII.

Additionally, another group of olefin metathesis catalysts that may be used in the catalyst composition of the invention disclosed herein, is a Group 8 transition metal complex comprising a Schiff base ligand having the structure of formula (XVI):

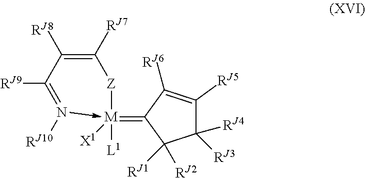

wherein:
M is a Group 8 transition metal, particularly ruthenium or osmium, or more particularly, ruthenium;
X¹ and L¹ are as defined for the first and second groups of catalysts defined above;
Z is selected from the group consisting of oxygen, sulfur, selenium, NR^{J11}, PR^{J11}, AsR^{J11}, and SbR^{J11}; and
R^{J1}, R^{J2}, R^{J3}, R^{J4}, R^{J5}, R^{J6}, R^{J7}, R^{J8}, R^{J9}, R^{J10}, and R^{J11} are each independently selected from the group consisting of hydrogen, halogen, alkyl, alkenyl, alkynyl, aryl, heteroalkyl, heteroatom containing alkenyl, heteroalkenyl, heteroaryl, alkoxy, alkenyloxy, aryloxy, alkoxycarbonyl, carbonyl, alkylamino, alkylthio, aminosulfonyl, monoalkylaminosulfonyl, dialkylaminosulfonyl, alkylsulfonyl, nitrile, nitro, alkylsulfinyl, trihaloalkyl, perfluoroalkyl, carboxylic acid, ketone, aldehyde, nitrate, cyano, isocyanate, thioisocyanate, cyanato, thiocyanato, hydroxyl, ester, ether, thioether, amine, alkylamine, imine, amide, halogen-substituted amide, trifluoroamide, sulfide, disulfide, sulfonate, carbamate, silane, siloxane, phosphine, phosphate, borate, or -A-Fn, wherein “A” is a divalent hydrocarbon moiety selected from alkylene and arylalkylene, wherein the alkyl portion of the alkylene and arylalkylene groups can be linear or branched, saturated or unsaturated, cyclic or acyclic, and substituted or unsubstituted, wherein the aryl portion of the arylalkylene can be substituted or unsubstituted, and wherein hetero atoms and/or functional groups may be present in either the aryl or the alkyl portions of the alkylene and arylalkylene groups, and Fn is a functional group, or any one or more of the R^{J1}, R^{J2}, R^{J3}, R^{J4}, R^{J5}, R^{J6}, R^{J7}, R^{J8}, R^{J9}, R^{J10}, and R^{J11} may be linked together to form a cyclic group, or any one or more of the R^{J1}, R^{J2}, R^{J3}, R^{J4}, R^{J5}, R^{J6}, R^{J7}, R^{J8}, R^{J9}, R^{J10}, and R^{J11} may be attached to a support.

Additionally, one Group 8 transition metal complex of formula (XVI) is a Group 8 transition metal complex comprising a Schiff base ligand having the structure of formula (XVII):

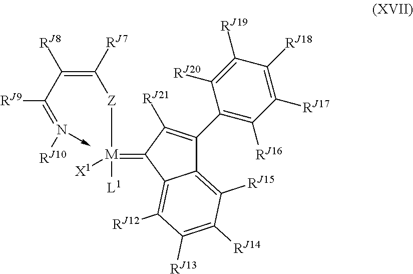

wherein:
M, X¹, L¹, Z, R^{J7}, R^{J8}, R^{J9}, R^{J10}, and R^{J11} are as defined above for Group 8 transition metal complex of formula XVI; and R^{J12}, R^{J13}, R^{J14}, R^{J15}, R^{J16}, R^{J17}, R^{J18}, R^{J19}, R^{J20}, and R^{J21} are as defined above for R^{J1}, R^{J2}, R^{J3}, R^{J4}, R^{J5}, and R^{J6} for Group 8 transition metal complex of formula XVI, or any one or more of the R^{J7}, R^{J8}, R^{J9}, R^{J10}, R^{J11}, R^{J12}, R^{J13}, R^{J14}, R^{J15}, R^{J16} R^{J17}, R^{J18}, R^{J19}, R^{J20}, and R^{J21} may be linked together to form a cyclic group, or any one or more of the R^{J7}, R^{J8}, R^{J9}, R^{J10}, R^{J11}, R^{J12}, R^{J13}, R^{J14}, R^{J15}, R^{J16}, R^{J17}, R^{J18}, R^{J19}, R^{J20}, and R^{J21} may be attached to a support.

Additionally, another Group 8 transition metal complex of formula (XVI) is a Group 8 transition metal complex comprising a Schiff base ligand having the structure of formula (XVIII):

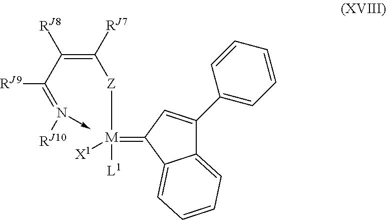

wherein M, X¹, L¹, Z, R^{J7}, R^{J8}, R^{J9}, R^{J10}, and R^{J11} are as defined above for Group 8 transition metal complex of formula (XVI).

Additionally, another group of olefin metathesis catalysts that may be used in the catalyst composition of the invention disclosed herein, is a Group 8 transition metal complex comprising a Schiff base ligand having the structure of formula (XIX):

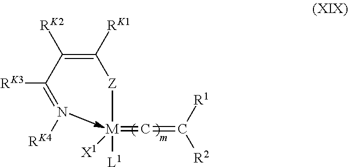

wherein:
M is a Group 8 transition metal, particularly ruthenium or osmium, or more particularly, ruthenium;
X¹, L¹, R¹, and R² are as defined for the first and second groups of catalysts defined above;
Z is selected from the group consisting of oxygen, sulfur, selenium, NR^{K5}, PR^{K5}, AsR^{K5}, and SbR^{K5};
m is 0, 1, or 2; and
   R^{K1}, R^{K2}, R^{K3}, R^{K4}, and R^{K5} are each independently selected from the group consisting of hydrogen, halogen, alkyl, alkenyl, alkynyl, aryl, heteroalkyl, heteroatom containing alkenyl, heteroalkenyl, heteroaryl, alkoxy, alkenyloxy, aryloxy, alkoxycarbonyl, carbonyl, alkylamino, alkylthio, aminosulfonyl, monoalkylaminosulfonyl, dialkylaminosulfonyl, alkylsulfonyl, nitrile, nitro, alkylsulfinyl, trihaloalkyl, perfluoroalkyl, carboxylic acid, ketone, aldehyde, nitrate, cyano, isocyanate, thioisocyanate, cyanato, thiocyanato, hydroxyl, ester, ether, thioether, aminc, alkylanine, imine, amide, halogen-substituted amide, trifluoroamide, sulfide, disulfide, sulfonate, carbamate, silane, siloxane, phosphine, phosphate, borate, or -A-Fn, wherein “A” is a divalent hydrocarbon moiety selected from alkylene and arylalkylene, wherein the alkyl portion of the alkylene and arylalkylene groups can be linear or branched, saturated or unsaturated, cyclic or acyclic, and substituted or unsubstituted, wherein the aryl portion of the arylalkylene can be substituted or unsubstituted, and wherein hetero atoms and/or functional groups may be present in either the aryl or the alkyl portions of the alkylene and arylalkylene groups, and Fn is a functional group, or any one or more of the R^{K1}, R^{K2}, R^{K3}, R^{K4} and R^{K5} may be linked together to form a cyclic group, or any one or more of the R¹, R(, R(, R¹⁴, and R(may be attached to a support.

In addition, catalysts of formulas (XVI) to (XIX) may be optionally contacted with an activating compound, where at least partial cleavage of a bond between the Group 8 transition metal and at least one Schiff base ligand occurs, wherein the activating compound is either a metal or silicon compound selected from the group consisting of copper (I) halides; zinc compounds of the formula Zn(R^{Y1})₂, wherein R^{Y1} is halogen, C₁-C₇ alkyl or aryl; tin compounds represented by the formula SnR^{Y2}R^{Y3}R^{Y4}R^{Y5} wherein each of R^{Y2}, R^{Y3}, R^{Y4} and R^{Y5} is independently selected from the group consisting of halogen, C₁-C₂₀ alkyl, C₃-C₁₀ cycloalkyl, aryl, benzyl and C₂-C₇ alkenyl; and silicon compounds represented by the formula SiR^{Y6}R^{Y7}R^{Y8}R^{Y9} wherein each of R^{Y6}, R^{Y7}, R^{Y8}, R^{Y9} is independently selected from the group consisting of hydrogen, halogen, C₁-C₂₀ alkyl, halo, C₁-C₇ alkyl, aryl, heteroaryl, and vinyl. In addition, catalysts of formulas (XVI) to (XIX) may be optionally contacted with an activating compound where at least partial cleavage of a bond between the Group 8 transition metal and at least one Schiff base ligand occurs, wherein the activating compound is an inorganic acid such as hydrogen iodide, hydrogen bromide, hydrogen chloride, hydrogen fluoride, sulfuric acid, nitric acid, iodic acid, periodic acid, perchloric acid, HOClO, HOClO₂ and HOIO₃. In addition, catalysts of formulas (XVI) to (XIX) may be optionally contacted with an activating compound where at least partial cleavage of a bond between the Group 8 transition metal and at least one Schiff base ligand occurs, wherein the activating compound is an organic acid such as sulfonic acids including but not limited to methanesulfonic acid, aminobenzenesulfonic acid, benzenesulfonic acid, napthalenesulfonic acid, sulfanilic acid and trifluoromethanesulfonic acid; monocarboxylic acids including but not limited to acetoacetic acid, barbituric acid, bromoacetic acid, bromobenzoic acid, chloroacetic acid, chlorobenzoic acid, chlorophenoxyacetic acid, chloropropionic acid, cis-cinnamic acid, cyanoacetic acid, cyanobutyric acid, cyanophenoxyacetic acid, cyanopropionic acid, dichloroacetic acid, dichloroacetylacetic acid, dihydroxybenzoic acid, dihydroxymalic acid, dihydroxytartaric acid, dinicotinic acid, diphenylacetic acid, fluorobenzoic acid, formic acid, furancarboxylic acid, furoic acid, glycolic acid, hippuric acid, iodoacetic acid, iodobenzoic acid, lactic acid, lutidinic acid, mandelic acid, α-naphtoic acid, nitrobenzoic acid, nitrophenylacetic acid, o-phenylbenzoic acid, thioacetic acid, thiophene-carboxylic acid, trichloroacetic acid, and trihydroxybenzoic acid; and other acidic substances such as but not limited to picric acid and uric acid.

In addition, other examples of catalysts that may be used in the catalyst composition of the invention are located in the following disclosures, the disclosure of each of which is incorporated herein by reference, U.S. Pat. Nos. 7,687,635; 7,671,224; 6,284,852; 6,486,279; and 5,977,393; International Publication Number WO2010/037550; and U.S. patent application Ser. Nos. 12/303,615; 10/590,380; 11/465,651 (Publication No.: US 2007/0043188); and Ser. No. 11/465,651 (Publication No.: US 2008/0293905 Corrected Publication); and European Pat. Nos. EP1757613B1 and EP1577282B1.

Non-limiting examples of catalysts that may be used to prepare supported complexes and in the reactions disclosed herein include the following, some of which for convenience are identified throughout this disclosure by reference to their molecular weight:

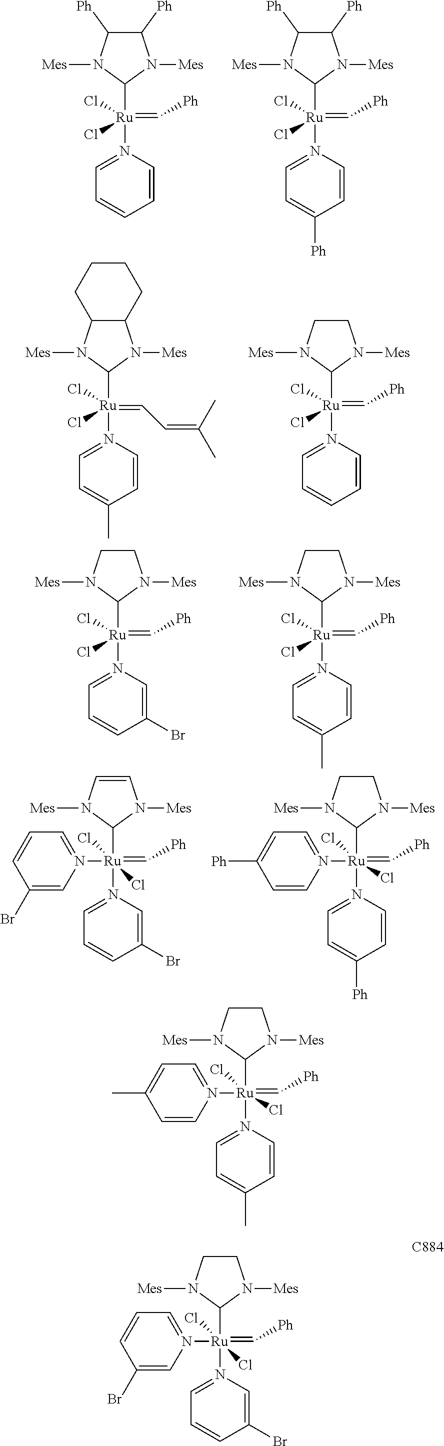

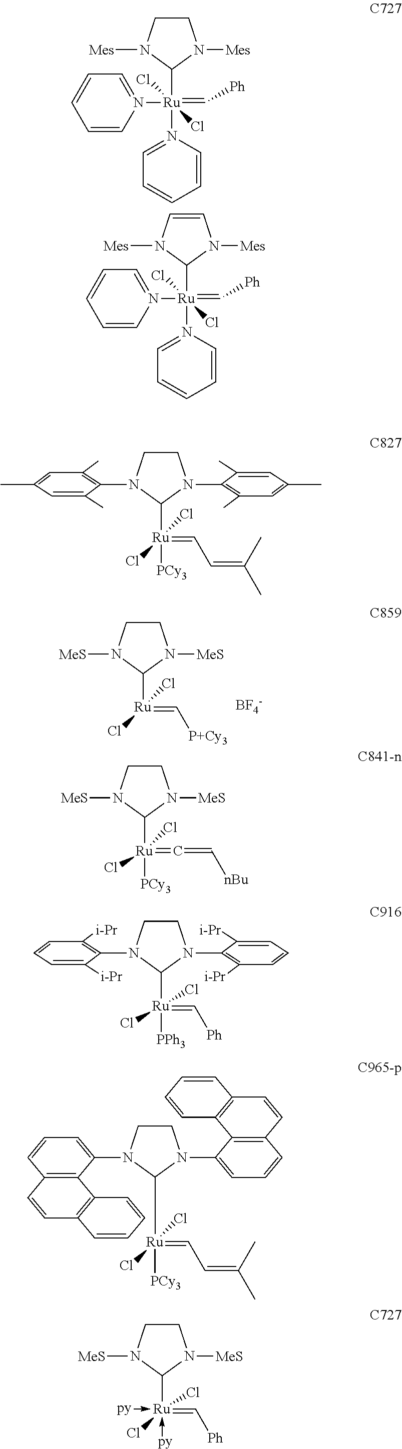

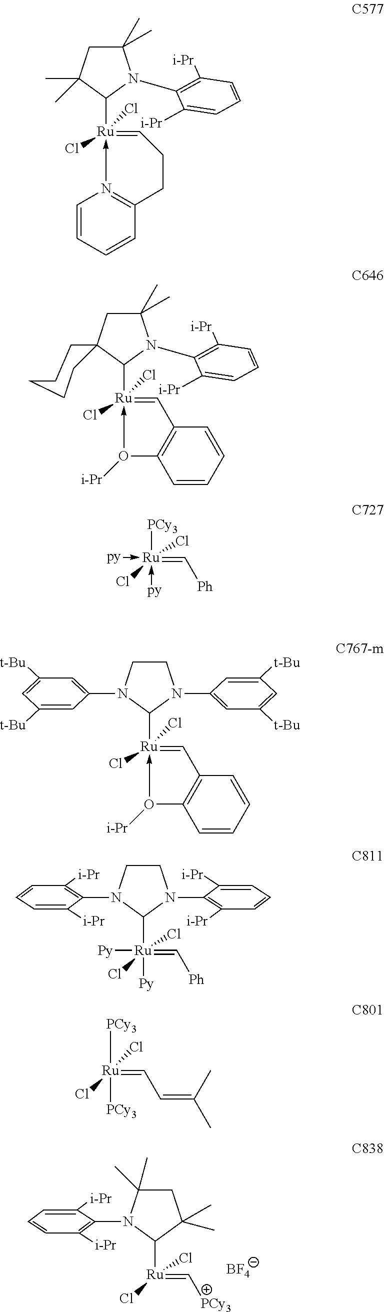

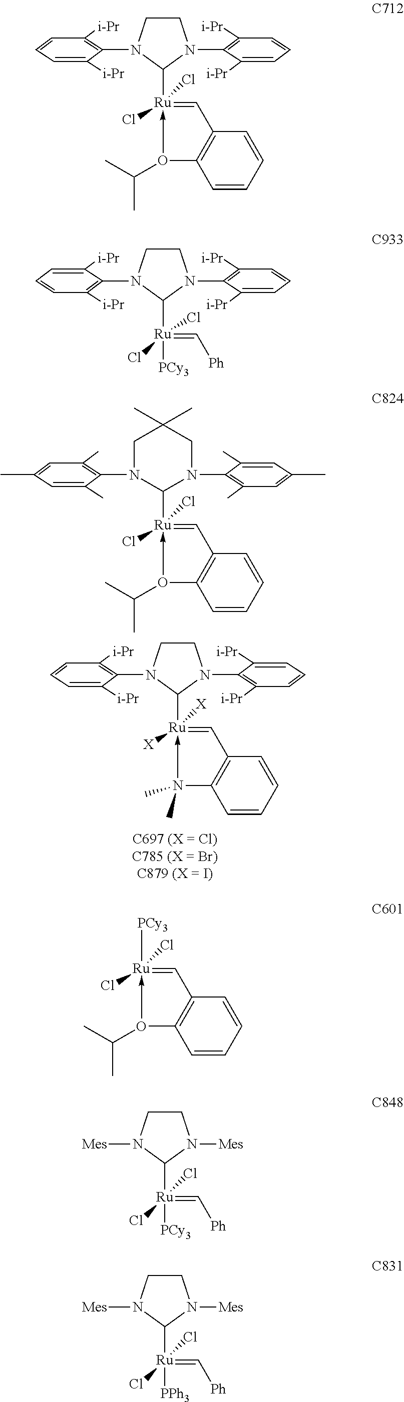

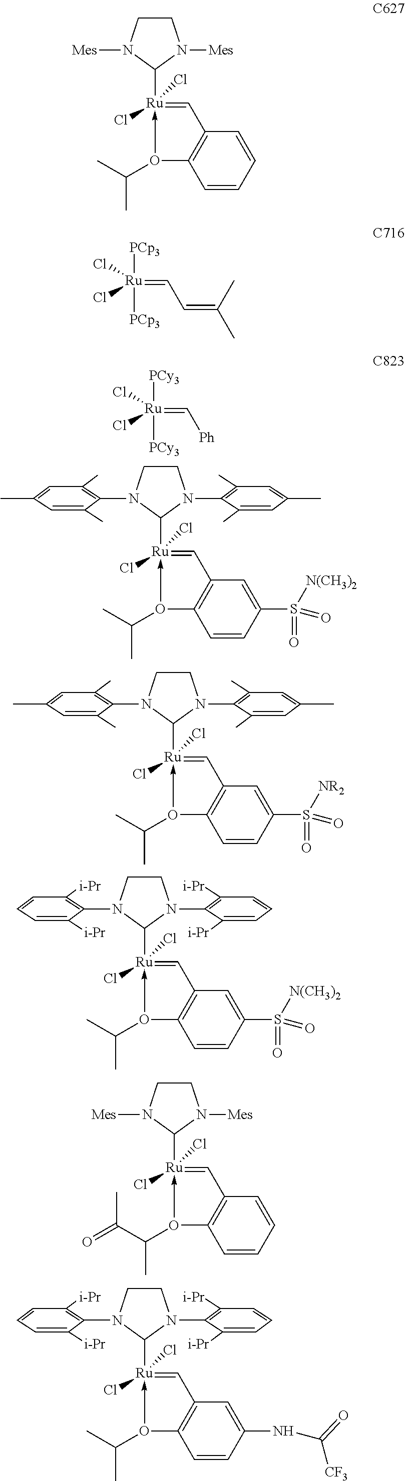

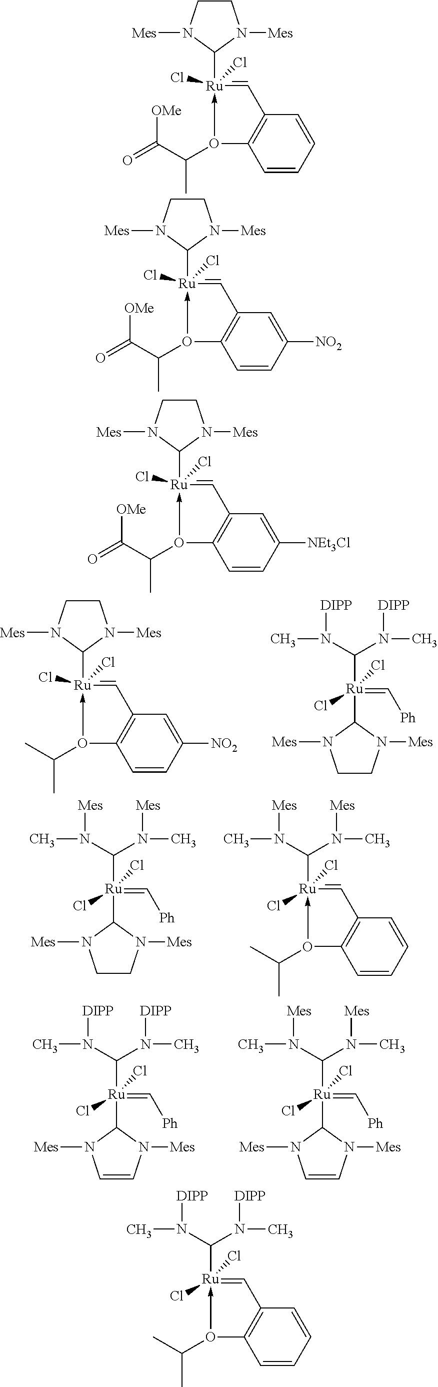

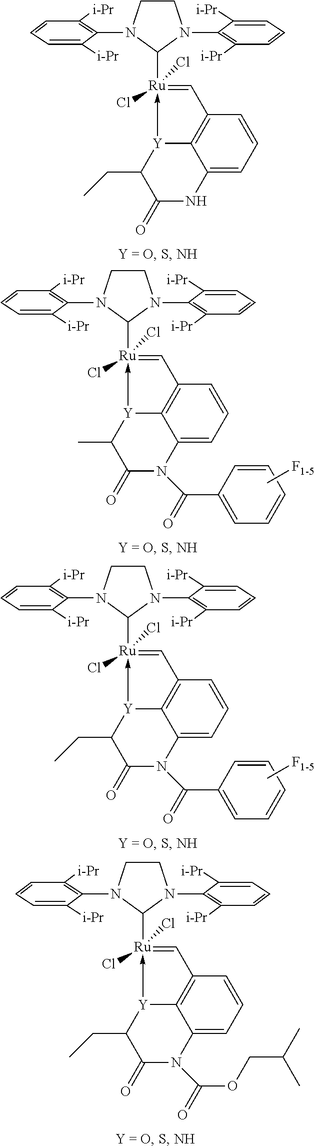

In the foregoing molecular structures and formulae, Ph represents phenyl, Cy represents cyclohexyl, Cp represents cyclopentyl, Me represents methyl. Bu represents n-butyl, t-Bu represents tert-butyl, i-Pr represents isopropyl, py represents pyridine (coordinated through the N atom), Mes represents mesityl (i.e., 2,4,6trimethylphenyl), DiPP and DIPP represents 2,6-diisopropylphenyl, and MiPP represents 2isopropylphenyl.

Further examples of catalysts useful to prepare supported complexes and in the reactions disclosed herein include the following: ruthenium (II) dichloro (3-methyl-2-butenylidene) bis(tricyclopentylphosphine) (C716): ruthenium (II) dichloro (3-methyl-2butenylidene) bis(tricyclohexylphosphine) (C801); ruthenium (II) dichloro(phenylmethylene) bis(tricyclohexylphosphine) (C823); ruthenium (II) (1,3-bis-(2,4,6-trimethylphenyl)-2-imidazolidinylidene) dichloro (phenylmethylene) (triphenylphosphine) (C830); ruthenium (II) dichloro (phenylvinylidene) bis(tricyclohexylphosphine) (C835); ruthenium (II) dichloro (tricyclohexylphosphine) (o-isopropoxyphenylmethylene) (C601); ruthenium (II) (1,3-bis-(2, 4,6-trimethylphenyl)-2-imidazolidinylidene) dichloro (phenylmethylene) bis(3bromopyridine) (C884): [1,3-bis-(2,4,6-trimethylphenyl)-2-imidazolidinylidene]dichloro(o-isopropoxyphenylmethylene)ruthenium(II) (C627); [1,3-bis-(2,4,6-trimethylphenyl)-2-imidazolidinylidene]dichloro (benzylidene) (triphenylphosphine) ruthenium(II) (C831); [1,3-bis-(2,4,6-trimethylphenyl)-2-imidazolidinylidene]dichloro (benzylidene)(methyldiphenylphosphine)ruthenium(II) (C769); [1,3-bis-(2,4,6-trimethylphenyl)-2-imidazolidinylidene]dichloro(benzylidene)(tricyclohexylphosphine)ruthenium(II) (C848); [1,3-bis-(2,4,6-trimethylphenyl)-2-imidazolidinylidene]dichloro(benzylidene) (diethylphenylphosphine) ruthenium(II) (C735); [1,3-bis-(2,4,6-trimethylphenyl)-2-imidazolidinylidene]dichloro(benzylidene)(tri-n-butylphosphine)ruthenium(II) (C771); [1,3-bis-(2,4,6-trimethylphenyl)-2-imidazolidinylidene]dichloro(3-methyl-2-butenylidene)(triphenylphosphine)ruthenium(II) (C809); [1,3-bis-(2,4,6-trimethylphenyl)-2-imidazolidinylidene]dichloro(3-methyl-2-butenylidene)(methyldiphenylphosphine)ruthenium(II) (C747); [1,3-bis-(2,4,6-trimethylphenyl)-2-imidazolidinylidene]dichloro(3-methyl-2-butenylidene) (tricyclohexylphosphine) ruthenium(II) (C827); [1,3-bis-(2,4,6-trimethylphenyl)-2-imidazolidinylidene]dichloro(3-methyl-2-butenylidene)(diethylphenylphosphine)ruthenium(II) (C713); [1,3-bis-(2,4,6-trimethylphenyl)-2-imidazolidinylidene]dichloro (3-methyl-2-butenylidene) (tri-n-butylphosphine)ruthenium(II) (C749); [1,3-bis-(2,4,6-trimethylphenyl)-2-imidazolidinylidene]dichloro(phenylindenylidene)(triphenylphosphine)ruthenium(II) (C931); [1,3-bis-(2,4,6-trimethylphenyl)-2-imidazolidinylidene]dichloro (phenylindenylidene) (methylphenylphosphine) ruthenium(II) (C869); [1,3-bis-(2,4,6-trimethylphenyl)-2-imidazolidinylidene]dichloro (phenylindenylidene) (tricyclohexylphosphine) ruthenium(II) (C949); [1,3-bis-(2,4,6-trimethylphenyl)-2-imidazolidinylidene]dichloro(phenylindenylidene)(diethylphenylphosphine)ruthenium(II) (C835); and [1,3-bis-(2,4,6-trimethylphenyl)-2-imidazolidinylidene]dichloro(phenylindenylidene)(tri-n-butylphosphine)ruthenium(II) (C871).

Still further catalysts useful in ROMP reactions, and/or in other metathesis reactions, such as ring-closing metathesis, cross metathesis, ring-opening cross metathesis, self-metathesis, ethenolysis, alkenolysis, acyclic diene metathesis polymerization, and combinations thereof, include the following structures:

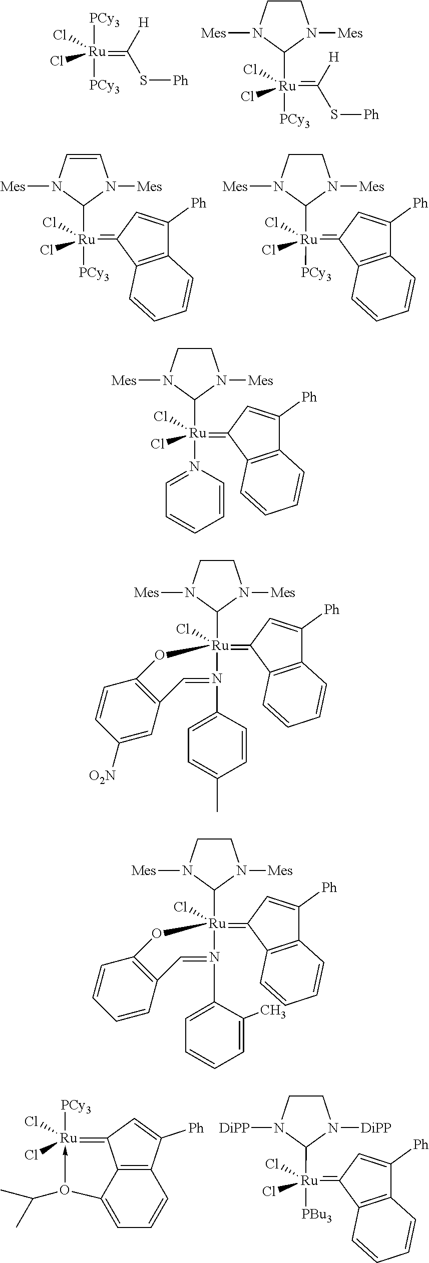

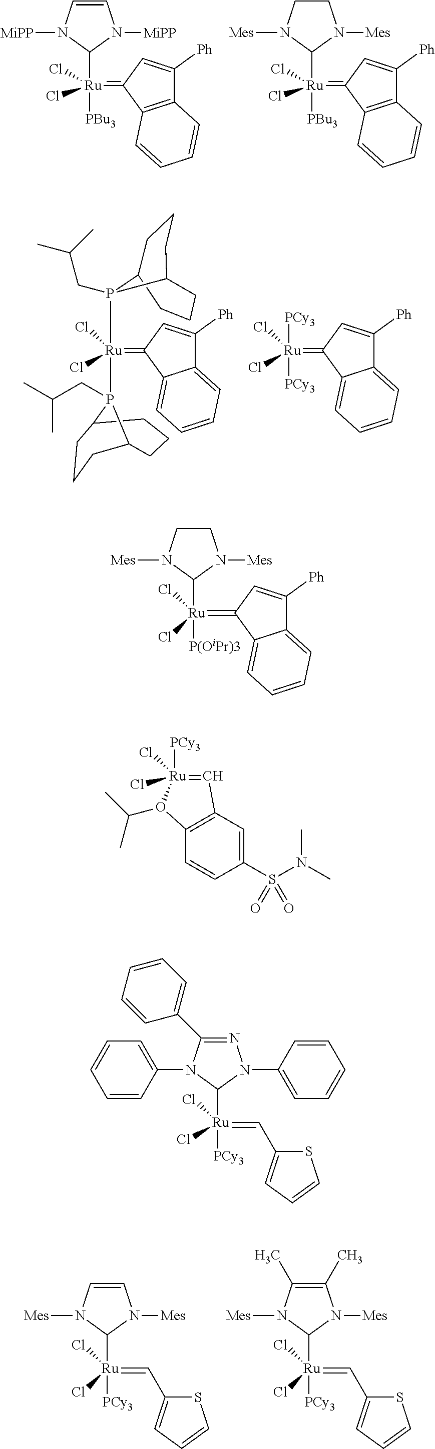

In general, the transition metal complexes used as catalysts herein can be prepared by several different methods, such as those described by Schwab et al. (1996) J Am. Chem. Soc. 118:100-110, Scholl et al. (1999) Org. Lett. 6:953-956, Sanford et al. (2001) J Am. Chem. Soc. 123:749-750, U.S. Pat. Nos. 5,312,940, and 5,342,909, the disclosure of each of which are incorporated herein by reference. Also see U.S. Pat. Pub. No. 2003/0055262 to Grubbs et al., WO 02/079208, and U.S. Pat. No. 6,613,910 to Grubbs et al., the disclosure of each of which are incorporated herein by reference. Synthetic methods are described in WO 03/11455A1 to Grubbs et al., the disclosure of which is incorporated herein by reference.

Metal carbene olefin metathesis catalysts may be Group 8 transition metal complexes having the structure of formula (I) commonly called “First Generation Grubbs” catalysts, formula (III) commonly called “Second Generation Grubbs” catalysts, or formula (VII) commonly called “Grubbs-Hoveyda” catalysts.

Metal carbene olefin metathesis catalysts may have the structure of formula (I)

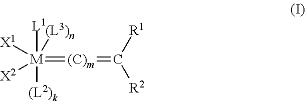

wherein:
M is a Group 8 transition metal;
L¹, L², and L³ are neutral electron donor ligands;
n is0 or 1;
m is 0, 1, or 2;
k is0 or 1;
X¹ and X² are anionic ligands;
R¹ and R² are independently selected from hydrogen, hydrocarbyl, substituted hydrocarbyl, heteroatom-containing hydrocarbyl, substituted heteroatom-containing hydrocarbyl, and functional groups,
wherein any two or more of X¹, X², L¹, L², L³, R¹, and R² can be taken together to form one or more cyclic groups, and further wherein any one or more of X¹, X², L¹, L², L³, R¹, and R² may be attached to a support;
   and formula (VII)

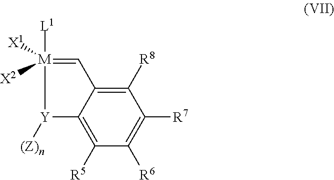

wherein:
M is a Group 8 transition metal;
L¹ is a neutral electron donor ligand;
X¹ and X² are anionic ligands;
Y is a heteroatom selected from O or N;
R⁵, R⁶, R⁷, and R⁸ are independently selected from hydrogen, hydrocarbyl, substituted hydrocarbyl, heteroatom-containing hydrocarbyl, substituted heteroatom-containing hydrocarbyl, and functional groups;
n is 0,1, or 2; and
   Z is selected from hydrogen, hydrocarbyl, substituted hydrocarbyl, heteroatom-containing hydrocarbyl, substituted heteroatom-containing hydrocarbyl, and functional groups,
   wherein any combination of Y, Z, R⁵, R⁶, R⁷, and R⁸ can be linked to form one or more cyclic groups, and further wherein any combination of X¹, X², L¹, Y, Z, R⁵, R⁶, R⁷, and R⁸ may be attached to a support.

Metal carbene olefin metathesis catalysts may have the structure of formula (I)

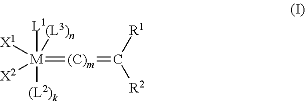

wherein.
M is ruthenium;
n is 0;
m is 0;
k is 1;
L¹ and L² are trisubstituted phosphines independently selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ is an N-heterocyclic carbene selected from the group consisting of 1,3-bis(2,4,6-trimethylphenyl)-2-imidazolidinylidene, 1,3-bis(2,4,6-trimethylphenyl)imidazol-2-ylidene, 1,3-bis(2,6-di-isopropylphenyl)-2-imidazolidinylidene, and 1,3-bis(2,6-di-isopropylphenyl)imidazol-2-ylidene and L² is a trisubstituted phosphine selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ and L² are N-heterocyclic carbenes independently selected from the group consisting of 1,3-bis(2,4,6-trimethylphenyl)-2-imidazolidinylidene, 1,3-bis(2,4,6-trimethylphenyl)imidazol-2-ylidene, 1,3-bis(2,6-di-isopropylphenyl)-2-imidazolidinylidene, and 1,3-bis(2,6-di-isopropylphenyl)imidazol-2-ylidene;
X¹ and X² are chloride; and
R¹ is hydrogen and R² is phenyl or —CH═C(CH₃)₂ or thienyl; or R¹ and R² are taken together to form 3-phenyl-1H-indene;
   and formula (VII)

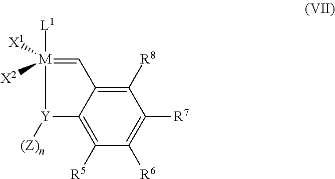

wherein:
M is ruthenium;
L¹ is a trisubstituted phosphine selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ is an N-heterocyclic carbene selected from the group consisting of 1,3-bis(2,4,6-trimethylphenyl)-2-imidazolidinylidene, 1,3-bis(2,4,6-trimethylphenyl)imidazol-2-ylidene, 1,3-bis(2,6-di-isopropylphenyl)-2-imidazolidinylidene, and 1,3-bis(2,6-di-isopropylphenyl)imidazol-2-ylidene;
X¹ and X² are chloride;
Y is oxygen;
R⁵, R⁶, R⁷, and R⁸ are each hydrogen;
n is 1; and
   Z is isopropyl.

An example of metal carbene olefin metathesis catalysts having the structure of formula (I)

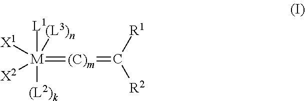

wherein:
M is ruthenium;
n is 0;
m is 0;
k is 1;
L¹ and L² are trisubstituted phosphines independently selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ is an N-heterocyclic carbene selected from the group consisting of 1,3-bis(2,4,6-trimethylphenyl)-2-imidazolidinylidene, 1,3-bis(2,4,6-trimethylphenyl)imidazol-2-ylidene, 1,3-bis(2,6-di-isopropylphenyl)-2-imidazolidinylidene, and 1,3-bis(2,6-di-isopropylphenyl)imidazol-2-ylidene and L² is a trisubstituted phosphine selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ and L² are N-heterocyclic carbenes independently selected from the group consisting of 1,3-bis(2,4,6-trimethylphenyl)-2-imidazolidinylidene, 1,3-bis(2,4,6-trimethylphenyl)imidazol-2-ylidene, 1,3-bis(2,6-di-isopropylphenyl)-2-imidazolidinylidene, and 1,3-bis(2,6-di-isopropylphenyl)imidazol-2-ylidene;
X¹ and X² are chloride; and
R¹ is hydrogen and R² is phenyl or —CH═C(CH₃)₂ or thienyl; or R¹ and R² are taken together to form an indenylidene moiety.

An example of metal carbene olefin metathesis catalysts having the structure of formula (I)

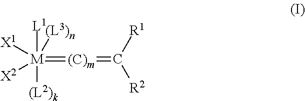

wherein:
M is ruthenium;
n is 0;
m is 0;
k is 1;
L¹ and L² are trisubstituted phosphines independently selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ is an N-heterocyclic carbene selected from the group consisting of 1,3-bis(2,4,6-trimethylphenyl)-2-imidazolidinylidene, 1,3-bis(2,4,6-trimethylphenyl)imidazol-2-ylidene, 1,3-bis(2,6-di-isopropylphenyl)-2-imidazolidinylidene, and 1,3-bis(2,6-di-isopropylphenyl)imidazol-2-ylidene and L² is a trisubstituted phosphine selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ and L² are N-heterocyclic carbenes independently selected from the group consisting of 1,3-bis(2,4,6-trimethylphenyl)-2-imidazolidinylidene, 1,3-bis(2,4,6-trimethylphenyl)imidazol-2-ylidene, 1,3-bis(2,6-di-isopropylphenyl)-2-imidazolidinylidene, and 1,3-bis(2,6-di-isopropylphenyl)imidazol-2-ylidene;
X¹ and X² are chloride; and
R¹ is hydrogen and R² is phenyl or —CH═C(CH₃)₂ or thienyl; or R¹ and R² are taken together to form an indenylidene moiety, where the indenylidene moiety is phenylindenylidene.

An example of metal carbene olefin metathesis catalysts having the structure of formula (I)

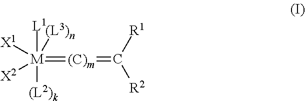

wherein:
M is ruthenium;
n is 0;
m is 0;
k is 1;
L¹ and L² are trisubstituted phosphines independently selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ is an N-heterocyclic carbene selected from the group consisting of 1,3-bis(2,4,6-trimethylphenyl)-2-imidazolidinylidene, 1,3-bis(2,4,6-trimethylphenyl)imidazol-2-ylidene, 1,3-bis(2,6-di-isopropylphenyl)-2-imidazolidinylidene, and 1,3-bis(2,6-di-isopropylphenyl)imidazol-2-ylidene and L² is a trisubstituted phosphine selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ and L² are N-heterocyclic carbenes independently selected from the group consisting of 1,3-bis(2,4,6-trimethylphenyl)-2-imidazolidinylidene, 1,3-bis(2,4,6-trimethylphenyl)imidazol-2-ylidene, 1,3-bis(2,6-di-isopropylphenyl)-2-imidazolidinylidene, and 1,3-bis(2,6-di-isopropylphenyl)imidazol-2-ylidene;
X¹ and X² are chloride; and
R¹ is hydrogen and R² is phenyl or —CH═C(CH₃)₂; or R¹ and R² are taken together to form an indenylidene moiety.

An example of metal carbene olefin metathesis catalysts having the structure of formula (I)

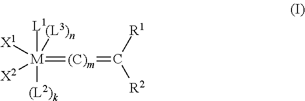

wherein:
M is ruthenium;
n is 0;
m is 0;
k is 1;
L¹ and L² are trisubstituted phosphines independently selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ is an N-heterocyclic carbene selected from the group consisting of 1,3-bis(2,4,6-trimethylphenyl)-2-imidazolidinylidene, 1,3-bis(2,4,6-trimethylphenyl)imidazol-2-ylidene, 1,3-bis(2,6-di-isopropylphenyl)-2-imidazolidinylidene, and 1,3-bis(2,6-di-isopropylphenyl)imidazol-2-ylidene and L² is a trisubstituted phosphine selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ and L² are N-heterocyclic carbenes independently selected from the group consisting of 1,3-bis(2,4,6-trimethylphenyl)-2-imidazolidinylidene, 1,3-bis(2,4,6-trimethylphenyl)imidazol-2-ylidene, 1,3-bis(2,6-di-isopropylphenyl)-2-imidazolidinylidene, and 1,3-bis(2,6-di-isopropylphenyl)imidazol-2-ylidene;
X¹ and X² are chloride; and
R¹ is hydrogen and R² is phenyl or —CH═C(CH₃)₂; or R and R² are taken together to form an indenylidene moiety, where the indenylidene moiety is phenylindenylidene.

An example of metal carbene olefin metathesis catalysts having the structure of formula (I)

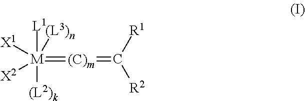

wherein:
M is ruthenium;
n is 0;
m is 0;
k is 1;
L¹ and L² are trisubstituted phosphines independently selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ is an N-heterocyclic carbene selected from the group consisting of 1,3-bis(2,4,6-trimethylphenyl)-2-imidazolidinylidene and 1,3-bis(2,4,6-trimethylphenyl)imidazol-2-ylidene, and L² is a trisubstituted phosphine selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ and L² are N-heterocyclic carbenes independently selected from the group consisting of 1,3-bis(2,4,6-trimethylphenyl)-2-imidazolidinylidene and 1,3-bis(2,4,6-trimethylphenyl)imidazol-2-ylidene;
X¹ and X² are chloride; and
R¹ is hydrogen and R² is phenyl or —CH═C(CH₃)₂; or R¹ and R² are taken together to form an indenylidene moiety.

An example of metal carbene olefin metathesis catalysts having the structure of formula (I)

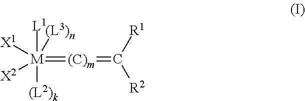

wherein:
M is ruthenium;
n is 0;
m is 0;
k is 1;
L¹ and L² are trisubstituted phosphines independently selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ is an N-heterocyclic carbene selected from the group consisting of 1,3-bis(2,4,6-trimethylphenyl)-2-imidazolidinylidene and 1,3-bis(2,4,6-trimethylphenyl)imidazol-2-ylidene, and L² is a trisubstituted phosphine selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ and L² are N-heterocyclic carbenes independently selected from the group consisting of 1,3-bis(2,4,6-trimethylphenyl)-2-imidazolidinylidene and 1,3-bis(2,4,6-trimethylphenyl)imidazol-2-ylidene;
X¹ and X² are chloride; and
R¹ is hydrogen and R² is phenyl or —CH═C(CH₃)₂; or R¹ and R² are taken together to form an indenylidene moiety, where the indenylidene moiety is phenylindenylidene.

An example of metal carbene olefin metathesis catalysts having the structure of formula (I)

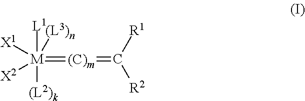

wherein:
M is ruthenium;
n is 0;
m is 0;
k is 1;
L¹ and L² are trisubstituted phosphines independently selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ is an N-heterocyclic carbene selected from 1,3-bis(2,4,6-trimethylphenyl)-2-imidazolidinylidene, and L² is a trisubstituted phosphine selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ and L² are N-heterocyclic carbenes selected from 1,3-bis(2,4,6-trimethylphenyl)-2-imidazolidinylidene;
X¹ and X² are chloride; and
R¹ is hydrogen and R² is phenyl or —CH═C(CH₃)₂; or R¹ and R² are taken together to form an indenylidene moiety.

An example of metal carbene olefin metathesis catalysts having the structure of formula (I)

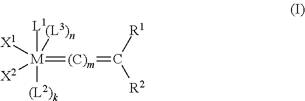

wherein:
M is ruthenium;
n is 0;
m is 0;
k is 1;
L¹ and L² are trisubstituted phosphines independently selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ is an N-heterocyclic carbene selected from 1,3-bis(2,4,6-trimethylphenyl)-2-imidazolidinylidene, and L² is a trisubstituted phosphine selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ and L² are N-heterocyclic carbenes selected from 1,3-bis(2,4,6-trimethylphenyl)-2-imidazolidinylidene;
X¹ and X² are chloride; and
R¹ is hydrogen and R² is phenyl or —CH═C(CH₃)₂; or R¹ and R² are taken together to form an indenylidene moiety, where the indenylidene moiety is phenylindenylidene.

An example of metal carbene olefin metathesis catalysts having the structure of formula (I)

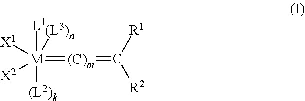

wherein:
M is ruthenium;
n is 0;
m is 0;
k is 1;
L¹ and L² are trisubstituted phosphines independently selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ is an N-heterocyclic carbene selected from 1,3-bis(2,4,6-trimethylphenyl)imidazol-2-ylidene, and L² is a trisubstituted phosphine selected from the group consisting of tri-n-butylphosphine (Pn-Bu3), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ and L² are N-heterocyclic carbenes selected from 1,3-bis(2,4,6-trimethylphenyl)imidazol-2-ylidene;
X¹ and X² are chloride; and
R¹ is hydrogen and R² is phenyl or —CH═C(CH₃)₂ or thienyl; or R¹ and R² are taken together to form an indenylidene moiety.

An example of metal carbene olefin metathesis catalysts having the structure of formula (I)

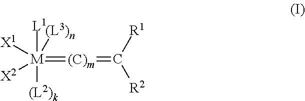

wherein:
M is ruthenium;
n is 0;
m is 0;
k is 1;
L¹ and L² are trisubstituted phosphines independently selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ is an N-heterocyclic carbene selected from 1,3-bis(2,4,6-trimethylphenyl)imidazol-2-ylidene, and L² is a trisubstituted phosphine selected from the group consisting of tri-n-butylphosphine (Pn-Bu3), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ and L² are N-heterocyclic carbenes selected from 1,3-bis(2,4,6-trimethylphenyl)imidazol-2-ylidene;
X¹ and X² are chloride; and
R¹ is hydrogen and R² is phenyl or —CH═C(CH₃)₂ or thienyl; or R¹ and R² are taken together to form an indenylidene moiety, where the indenylidene moiety is phenylindenylidene.

An example of metal carbene olefin metathesis catalysts having the structure of formula (I)

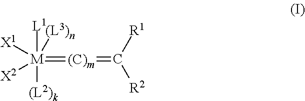

wherein:
M is ruthenium;
n is 0;
m is 0;
k is 1;
L¹ and L² are trisubstituted phosphines independently selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ is an N-heterocyclic carbene selected from 1,3-bis(2,4,6-trimethylphenyl)-2-imidazolidinylidene, and L² is a trisubstituted phosphine selected from the group consisting of tri-n-butylphosphine (Pn-Bu3), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ and L² are N-heterocyclic carbenes selected from 1,3-bis(2,4,6-trimethylphenyl)-2-imidazolidinylidene;
X¹ and X² are chloride; and
R¹ is hydrogen and R² is phenyl or —CH═C(CH₃)₂ or thienyl; or R¹ and R² are taken together to form an indenylidene moiety.

An example of metal carbene olefin metathesis catalysts having the structure of formula (I)

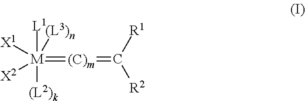

wherein:
M is ruthenium;
n is 0;
n is 0;
k is 1:
L¹ and L² are trisubstituted phosphines independently selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMcPh₂), dimethylphenylphosphine (PMe₂Ph), and diethylphenylphosphine (PEt₂Ph); or L¹ is an N-heterocyclic carbene selected from 1,3-bis(2,4,6-trimethylphenyl)-2-imidazolidinylidene, and L² is a trisubstituted phosphine selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ and L² are N-heterocyclic carbenes selected from 1,3-bis(2,4,6-trimethylphenyl)-2-imidazolidinylidene;
X¹ and X² are chloride; and
R¹ is hydrogen and R² is phenyl or —CH═C(CH₃)₂ or thienyl; or R¹ and R² are taken together to form an indenylidene moiety, where the indenylidene moiety is phenylindenylidene.

An example of metal carbene olefin metathesis catalysts having the structure of formula (VII)

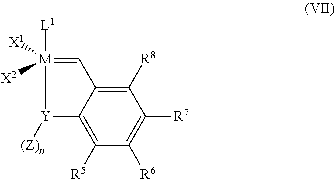

wherein:
M is ruthenium:
L¹ is a trisubstituted phosphine selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ is an N-heterocyclic carbene selected from the group consisting of 1,3-bis(2,4,6-trimethylphenyl)-2-imidazolidinylidene, 1,3-bis(2,4,6-trimethylphenyl)imidazol-2-ylidene, 1,3-bis(2,6-di-isopropylphenyl)-2-imidazolidinylidene, and 1,3-bis(2,6-di-isopropylphenyl)imidazol-2-ylidene;
X¹ and X² are chloride;
Y is oxygen;
R⁵, R⁶, R⁷, and R⁸ are each hydrogen;
n is 1; and
Z is isopropyl.

An example of metal carbene olefin metathesis catalysts having the structure of formula (I)

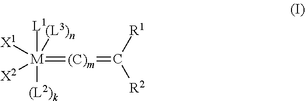

wherein:
M is ruthenium;
n is 0;
m is 0;
k is 1;
L¹ and L² are trisubstituted phosphines independently selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ is an N-heterocyclic carbene selected from the group consisting of 1,3-bis(2,4,6-trimethylphenyl)-2-imidazolidinylidene, 1,3-bis(2,4,6-trimethylphenyl)imidazol-2-ylidene, 1,3-bis(2,6-di-isopropylphenyl)-2-imidazolidinylidene, and 1,3-bis(2,6-di-isopropylphenyl)imidazol-2-ylidene and L² is a trisubstituted phosphine selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ and L² are N-heterocyclic carbenes independently selected from the group consisting of 1,3-bis(2,4,6-trimethylphenyl)-2-imidazolidinylidene, 1,3-bis(2,4,6-trimethylphenyl)imidazol-2-ylidene, 1,3-bis(2,6-di-isopropylphenyl)-2-imidazolidinylidene, and 1,3-bis(2,6-di-isopropylphenyl)imidazol-2-ylidene;
X¹ and X² are chloride; and
R¹ is hydrogen and R² is phenyl or —CH═C(CH₃)₂ or thienyl.

An example of metal carbene olefin metathesis catalysts having the structure of formula (I)

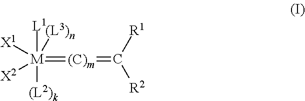

wherein:
M is ruthenium;
n is 0;
m is 0;
k is 1;
L¹ and L² are trisubstituted phosphines independently selected from the group consisting of tri-n-butylphosphine (Pn-Bu3), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ is an N-heterocyclic carbene selected from the group consisting of 1,3-bis(2,4,6-trimethylphenyl)-2-imidazolidinylidene and 1,3-bis(2,4,6-trimethylphenyl)imidazol-2-ylidene, and L² is a trisubstituted phosphine selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ and L² are N-heterocyclic carbenes independently selected from the group consisting of 1,3-bis(2,4,6-trimethylphenyl)-2-imidazolidinylidene and 1,3-bis(2,4,6-trimethylphenyl)imidazol-2-ylidene;
X¹ and X² are chloride; and
R¹ is hydrogen and R² is phenyl or —CH═C(CH₃)₂ or thienyl.

An example of metal carbene olefin metathesis catalysts having the structure of formula (I)

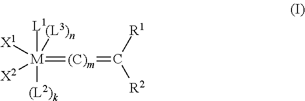

wherein:
M is ruthenium;
n is 0;
m is 0;
k is 1;
L¹ and L² are trisubstituted phosphines independently selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ is an N-heterocyclic carbene selected from 1,3-bis(2,4,6-trimethylphenyl)-2-imidazolidinylidene, and L² is a trisubstituted phosphine selected from the group consisting of tri-n-butylphosphine (Pn-Bu3), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ and L² are N-heterocyclic carbenes selected from 1,3-bis(2,4,6-trimethylphenyl)-2-imidazolidinylidene;
X¹ and X² are chloride; and
R¹ is hydrogen and R² is phenyl or —CH═C(CH₃)₂ or thienyl.

An example of metal carbene olefin metathesis catalysts having the structure of formula (I)

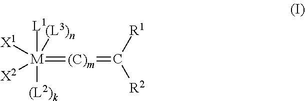

wherein:
M is ruthenium;
n is 0;
m is 0;
k is 1;
L¹ and L² are trisubstituted phosphines independently selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ is an N-heterocyclic carbene selected from 1,3-bis(2,4,6-trimethylphenyl)imidazol-2-ylidene, and L² is a trisubstituted phosphine selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ and L² are N-heterocyclic carbenes selected from 1,3-bis(2,4,6-trimethylphenyl)imidazol-2-ylidene;
X¹ and X² are chloride; and
R¹ is hydrogen and R² is phenyl or —CH═C(CH₃)₂ or thienyl.

An example of metal carbene olefin metathesis catalysts having the structure of formula (I)

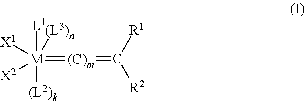

wherein:
M is ruthenium;
n is 0;
m is 0;
k is 1;
L¹ and L² are trisubstituted phosphines independently selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ is an N-heterocyclic carbene selected from the group consisting of 1,3-bis(2,4,6-trimethylphenyl)-2-imidazolidinylidene, 1,3-bis(2,4,6-trimethylphenyl)imidazol-2-ylidene, 1,3-bis(2,6-di-isopropylphenyl)-2-imidazolidinylidene, and 1,3-bis(2,6-di-isopropylphenyl)imidazol-2-ylidene and L² is a trisubstituted phosphine selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ and L² are N-heterocyclic carbenes independently selected from the group consisting of 1,3-bis(2,4,6-trimethylphenyl)-2-imidazolidinylidene, 1,3-bis(2,4,6-trimethylphenyl)imidazol-2-ylidene, 1,3-bis(2,6-di-isopropylphenyl)-2-imidazolidinylidene, and 1,3-bis(2,6-di-isopropylphenyl)imidazol-2-ylidene;
X¹ and X² are chloride; and
R¹ is hydrogen and R² is phenyl or —CH═C(CH₃)₂.

An example of metal carbene olefin metathesis catalysts having the structure of formula (I)

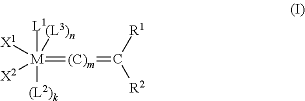

wherein:
M is ruthenium;
n is 0;
m is 0;
k is 1;
L¹ and L² are trisubstituted phosphines independently selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ is an N-heterocyclic carbene selected from the group consisting of 1,3-bis(2,4,6-trimethylphenyl)-2-imidazolidinylidene and 1,3-bis(2,4,6-trimethylphenyl)imidazol-2-ylidene, and L² is a trisubstituted phosphine selected from the group consisting of tri-n-butylphosphine (Pn-Bu3), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ and L² are N-heterocyclic carbenes independently selected from the group consisting of 1,3-bis(2,4,6-trimethylphenyl)-2-imidazolidinylidene, and 1,3-bis(2,4,6-trimethylphenyl)imidazol-2-ylidene;
X¹ and X² are chloride; and
R¹ is hydrogen and R² is phenyl or —CH═C(CH₃)₂.

An example of metal carbene olefin metathesis catalysts having the structure of formula (I)

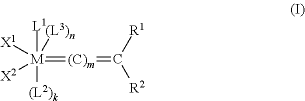

wherein:
M is ruthenium;
n is 0;
m is 0;
k is 1;
L¹ and L² are trisubstituted phosphines independently selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ is an N-heterocyclic carbene selected from 1,3-bis(2,4,6-trimethylphenyl)-2-imidazolidinylidene, and L² is a trisubstituted phosphine selected from the group consisting of tri-n-butylphosphine (Pn-Bus), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ and L² are N-heterocyclic carbenes selected from 1,3-bis(2,4,6-trimethylphenyl)-2-imidazolidinylidene;
X¹ and X² are chloride; and
R¹ is hydrogen and R² is phenyl or —CH═C(CH₃)₂.

An example of metal carbene olefin metathesis catalysts having the structure of formula (I)

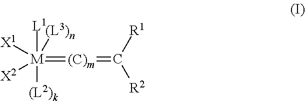

wherein:
M is ruthenium;
n is 0;
m is 0;
k is 1;
L¹ and L² are trisubstituted phosphines independently selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ is an N-heterocyclic carbene selected from 1,3-bis(2,4,6-trimethylphenyl)imidazol-2-ylidene, and L² is a trisubstituted phosphine selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ and L² are N-heterocyclic carbenes selected from 1,3-bis(2,4,6-trimethylphenyl)imidazol-2-ylidene;
X¹ and X² are chloride; and
R¹ is hydrogen and R² is phenyl or —CH═C(CH₃)₂.

An example of a metal carbene olefin metathesis catalyst having the structure of formula (XV):

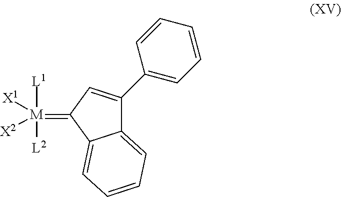

wherein:
M is ruthenium;
X¹ and X² are chloride; and
L¹ and L² are trisubstituted phosphines independently selected from the group consisting of tri-n-butylphosphine (Pn-B13), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ is an N-heterocyclic carbene selected from the group consisting of 1,3-bis(2,4,6-trimethylphenyl)-2-imidazolidinylidene, 1,3-bis(2,4,6-trimethylphenyl)imidazol-2-ylidene, 1,3-bis(2,6-di-isopropylphenyl)-2-imidazolidinylidene, and 1,3-bis(2,6-di-isopropylphenyl)imidazol-2-ylidene and L² is a trisubstituted phosphine selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ and L² are N-heterocyclic carbenes independently selected from the group consisting of 1,3-bis(2,4,6-trimethylphenyl)-2-imidazolidinylidene, 1,3-bis(2,4,6-trimethylphenyl)imidazol-2-ylidene, 1,3-bis(2,6-di-isopropylphenyl)-2-imidazolidinylidene, and 1,3-bis(2,6-di-isopropylphenyl)imidazol-2-ylidene.

An example of a metal carbene olefin metathesis catalyst having the structure of formula (XV):

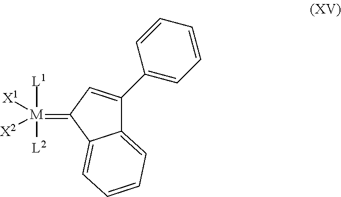

wherein:
M is ruthenium;
X¹ and X² are chloride; and
L¹ and L² are trisubstituted phosphines independently selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ is an N-heterocyclic carbene selected from the group consisting of 1,3-bis(2,4,6-trimethylphenyl)-2-imidazolidinylidene and 1,3-bis(2,4,6-trimethylphenyl)imidazol-2-ylidene, and L² is a trisubstituted phosphine selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ and L² are N-heterocyclic carbenes independently selected from the group consisting of 1,3-bis(2,4,6-trimethylphenyl)-2-imidazolidinylidene, and 1,3-bis(2,4,6-trimethylphenyl)imidazol-2-ylidene.

An example of a metal carbene olefin metathesis catalyst having the structure of formula (XV):

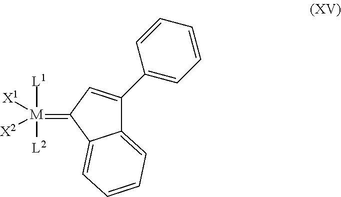

wherein:
M is ruthenium;
X¹ and X² are chloride; and
L¹ and L² are trisubstituted phosphines independently selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ is an N-heterocyclic carbene selected from 1,3-bis(2,4,6-trimethylphenyl)-2-imidazolidinylidene, and L² is a trisubstituted phosphine selected from the group consisting of tri-n-butylphosphine (Pn-Bus), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ and L² are N-heterocyclic carbenes selected from 1,3-bis(2,4,6-trimethylphenyl)-2-imidazolidinylidene.

An example of a metal carbene olefin metathesis catalyst having the structure of formula (XV):

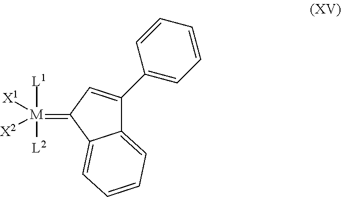

wherein:
M is ruthenium;
X¹ and X² are chloride; and
L¹ and L² are trisubstituted phosphines independently selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ is an N-heterocyclic carbene selected from 1,3-bis(2,4,6-trimethylphenyl)imidazol-2-ylidene, and L² is a trisubstituted phosphine selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ and L² are N-heterocyclic carbenes selected from 1,3-bis(2,4,6-trimethylphenyl)-2-imidazolidinylidene.

Suitable supports for any of the catalysts described herein may be of synthetic, semi-synthetic, or naturally occurring materials, which may be organic or inorganic, e.g., polymeric, ceramic, or metallic. Attachment to the support will generally, although not necessarily, be covalent, and the covalent linkage may be direct or indirect. Indirect covalent linkages are typically, though not necessarily, through a functional group on a support surface. Ionic attachments are also suitable, including combinations of one or more anionic groups on the metal complexes coupled with supports containing cationic groups, or combinations of one or more cationic groups on the metal complexes coupled with supports containing anionic groups.

When utilized, suitable supports may be selected from silicas, silicates, aluminas, aluminum oxides, silica-aluminas, aluminosilicates, zeolites, titanias, titanium dioxide, magnetite, magnesium oxides, boron oxides, clays, zirconias, zirconium dioxide, carbon, polymers, cellulose, cellulosic polymers amylose, anylosic polymers, or a combination thereof. The support may comprise silica, a silicate, or a combination thereof.

It is also possible to use a support that has been treated to include functional groups, inert moieties, and/or excess ligands. Any of the functional groups described herein are suitable for incorporation on the support, and may be generally accomplished through techniques known in the art. Inert moieties may also be incorporated on the support to generally reduce the available attachment sites on the support, e.g., to control the placement, or amount, of a complex linked to the support.

The catalyst compositions comprising at least one metal carbene olefin metathesis catalyst may be utilized in olefin metathesis reactions according to techniques known in the art. The catalyst compositions of the invention are typically added to the ROMP composition as a solid, a solution, or as a suspension. When the catalyst composition of the invention is added to the ROMP composition as a suspension, the at least one metal carbene olefin metathesis catalyst is suspended in a dispersing carrier such as mineral oil, paraffin oil, soybean oil, tri-isopropylbenzene, or any hydrophobic liquid which has a sufficiently high viscosity so as to permit effective dispersion of the catalyst(s), and which is sufficiently inert and which has a sufficiently high boiling point so that is does not act as a low-boiling impurity in the olefin metathesis reaction. It will be appreciated that the amount of catalyst that is used (i.e., the “catalyst loading”) in the reaction is dependent upon a variety of factors such as the identity of the reactants and the reaction conditions that are employed. It is therefore understood that catalyst loading may be optimally and independently chosen for each reaction. In general, however, the catalyst will be present in an amount that ranges from a low of about 0.1 ppm, 1 ppm, or 5 ppm, to a high of about 10 ppm, 15 ppm, 25 ppm, 50 ppm, 100 ppm, 200 ppm, 500 ppm, or 1000 ppm relative to the amount of an olefinic substrate.

The catalyst will generally be present in an amount that ranges from a low of about 0.00001 mol %, 0.0001 mol %, or 0.0005 mol %, to a high of about 0.001 mol %, 0.0015 mol %, 0.0025 mol %, 0.005 mol %, 0.01 mol %, 0.02 mol %, 0.05 mol %, or 0.1 mol % relative to the cyclic olefin(s) present in the cyclic olefin composition.

When expressed as the molar ratio of monomer to catalyst, the catalyst (the “monomer to catalyst ratio”), loading will generally be present in an amount that ranges from a low of about 10,000,000:1, 1,000,000:1, or 200,00:1, to a high of about 100,000:1 66,667:1, 40,000:1, 20,000:1, 10,000:1, 5,000:1, or 1,000:1.

The metathesis reactions disclosed herein may be carried out under a dry, inert atmosphere. Such an atmosphere may be created using any inert gas, including such gases as nitrogen and argon. The use of an inert atmosphere is optimal in terms of promoting catalyst activity, and reactions performed under an inert atmosphere typically are performed with relatively low catalyst loading. The reactions disclosed herein may also be carried out in an oxygen-containing and/or a water-containing atmosphere, and the reactions may be carried out under ambient conditions. The presence of oxygen or water in the reaction may, however, necessitate the use of higher catalyst loadings as compared with reactions performed under an inert atmosphere. Where the vapor pressure of the reactants allows, the reactions disclosed herein may also be carried out under reduced pressure.

The reactions disclosed herein may be carried out in a solvent, and any solvent that is inert towards cross-metathesis may be employed. Generally, solvents that may be used in the metathesis reactions include organic, protic, or aqueous solvents, such as aromatic hydrocarbons, chlorinated hydrocarbons, ethers, aliphatic hydrocarbons, alcohols, water, or mixtures thereof. Example solvents include benzene, toluene, p-xylene, methylene chloride, 1,2-dichloroethane, dichlorobenzene, chlorobenzene, tetrahydrofuran, diethyl ether, pentane, methanol, ethanol, water, or mixtures thereof. The reactions disclosed herein may be carried out neat, i.e., without the use of a solvent.

It will be appreciated that the temperature at which a metathesis reaction according to methods disclosed herein is conducted can be adjusted as needed, and may be at least about 78° C., 40° C., −10° C., 0° C., 10° C., 20° C. 25° C., 35° C. 50° C., 70° C., 100° C., or 150° C., or the temperature may be in a range that has any of these values as the upper or lower bounds. The reactions may be carried out at a temperature of at least about 35° C., or the reactions are carried out at a temperature of at least about 50° C.

### Adhesion Promoters

The optional adhesion promoter used in the ROMP composition of the invention disclosed herein may be an acid-functionalized polyolefin.

The acid-functionalized polyolefin that may be used as the adhesion promoter includes those disclosed in U.S. Pat. No. 7,465,773, the disclosure of which is incorporated herein by reference. For example, adhesion promoters that may be used in the invention may be an acid-functionalized polyolefin, such as a polyolefin comprising maleic anhydride. The polyolefin may be unsaturated, comprising alkene moieties, such as polybutadiene. The polyolefin may have a vinyl content of no greater than 40, 35, or 30 wt. %. The polyolefin may have an average anhydride equivalent weight ranging from 200-5000 g/mole per anhydride group (e.g., no greater than 4000, 3000, 2000, 1000, or 500 g/mole per anhydride group). The polyolefin comprising maleic anhydride is a liquid, typically having a viscosity at 20 or 25° C. of at least 2000, 3000, 4000, or 5000 mPas. (DIN EN ISO 3219). The viscosity at 20 or 25° C. may be no greater than 75,000 mPas (e.g., no greater than 30.000, 25,000, 20,000, or 15,000 or 10,000 mPas: less than 1000 or 500 mPas). The polyolefin may have a viscosity of at least 50,000; 75,000; 100,000; 125.000; or 150,000 mPas at 45, 50, or 55° C. The viscosity is indicative of the molecular weight. The polyolefin may have a molecular weight (Mn) of no greater than 10,000; 9,000; 8,000; 7,000; 6,000; 5,000; 4,500; 4,000; 3,500; or 3,000 g/mole. The polyolefin may have a molecular weight (Mn) of at least 1,000, 1,100, 1,200, 1,300, 1,400, 1,500, 1,600, 1,700, 1,800, 1,900, or 2,000 g/mole. An acid-functionalized polyolefin that may be used as an adhesion promoter is polybutadiene comprising maleic anhydride (e.g., Ricobond 1731, Polyvest EP MA 100. Ricon 130MA8. Ricon 130MA20. Ricon 131MA5. Ricon 131MA10. Ricon 131MA20, Ricon 184MA6, Ricobond 1731, Ricobond 1756 from Cray Valley, Polyvest EP MA 100, MA 75, EP MV MA 60 from Evonik, Lithene Ultra PM4-7.5MA, N4-B-10MA, N4-5000-10 MA, AL-15MA from Synthomer (polybutadiene modified with maleic anhydride)).

Other adhesion promoters that may be used in the invention may be any compound having at least two isocyanate groups. The compound containing at least two isocyanate groups may be selected from the group consisting of at least one diisocyanate, at least one triisocyanate, or at least one polyisocyanate (i.e., containing four or more isocyanate groups), and mixtures thereof. In a more particular aspect of the invention, the adhesion promoter comprises, or is limited to, a diisocyanate compound, or mixtures of diisocyanate compounds.

The compounds of the isocyanate compounds comprising at least two isocyanate groups may be selected from hydrocarbyl, substituted hydrocarbyl, heteroatom-containing hydrocarbyl, substituted heteroatom-containing hydrocarbyl, and functionalized hydrocarbyl compounds. As described above, suitable hydrocarbyl adhesion promoter compounds generally include alkyl, cycloalkyl, alkylene, alkenyl, alkynyl, aryl, cycloalkyl, alkaryl, and aralkyl compounds. Substituted heteroatom-containing, and functionalized hydrocarbyl adhesion promoter compounds include the aforementioned hydrocarbyl compounds, as well as the variations thereof noted hereinabove.

Adhesion promoters that may be used in the invention may be an alkyl diisocyanate. An alkyl diisocyanate refers to a linear, branched, or cyclic saturated or unsaturated hydrocarbon group typically although not necessarily containing 1 to about 24 carbon atoms, such as a diisocyanate containing 2 to about 12 carbon atoms (e.g., 6 to 12 carbon atoms such as hexamethylene diisocyanate (HDI), octamethylene diisocyanate, decamethylene diisocyanate, and the like). Cycloalkyl diisocyanates contain cyclic alkyl group, typically having 4 to 16 carbon atoms. A cycloalkyl diisocyanate containing 6 to about 12 carbon atoms are cyclohexyl, cyclooctyl, cyclodecyl, and the like. A cycloalkyl diisocyanate may originate as a condensation product of acetone called 5-isocyanato-1-(isocyanatomethyl)-1,3,3-trimethyl-cyclohexane, commonly known as Isophorone diisocyanate (IPDI) and the isomers of isocyanato-[(isocyanatocyclohexyl)methyl]cyclohexane (H₁₂MDI). H12MDI is derived from the hydrogenated form of the aryl diisocyanate methylene diphenyl diisocyanate (MDI).

Adhesion promoters that may be used in the invention may be an aryl diisocyanate. Aryl diisocyanates refers to aromatic diisocyanates containing a single aromatic ring or multiple aromatic rings that are fused together, directly linked, or indirectly linked (such that the different aromatic rings are bound to a common group such as a methylene or ethylene moiety). Aryl diisocyanates may contain 5 to 24 carbon atoms (e.g., 5 to 14 carbon atoms). Exemplary aryl diisocyanates contain one aromatic ring or two fused or linked aromatic rings, e.g., phenyl, tolyl, xylyl, naphthyl, biphenyl, diphenylether, benzophenone, and the like. Aromatic diisocyanates include toluene diisocyanates, tetramethylxylene diisocyanate (TMXDI), and methylene diphenyl diisocyanate (MDI), which may comprise any mixture of its three isomers, 2,2′-MDI, 2,4′-MDI, and 4,4′-MDI.

Adhesion promoters that may be used in the invention may be a polymer-containing isocyanate, such as, for example, diisocyanates. Polymer-containing isocyanates refers to a polymer-containing two or more terminal and/or pendant alkyl or aryl isocyanate groups. The polymer-containing isocyanates generally have a minimal solubility in the ROMP composition to provide improved mechanical properties. Polymer-containing isocyanates include, but are not limited to, PM200 (poly MDI), Lupranate® (poly MDI from BASF), Krasol® isocyanate terminated polybutadiene prepolymers, such as, for example, Krasol® LBD2000 (TDI based), Krasol® LBD3000 (TDI based), Krasol® NN-22 (MDI based), Krasol® NN-23 (MDI based), Krasol® NN-25 (MDI based), and the like. Krasol® isocyanate terminated polybutadiene prepolymers are available from Cray Valley.

Adhesion promoters that may be used in the invention may be a trimer of alkyl diisocyanates and aryl diisocyanates. In its simplest form, any combination of polyisocyanate compounds may be trimerized to form an isocyanurate ring containing isocyanate functional groups. Trimers of alkyl diisocyanate and aryl diisocyanates may also be referred to as isocyanurates of alkyl diisocyanate or aryl diisocyanate. Alkyl diisocyanate and aryl diisocyanate timers include, but are not limited to, hexamethylene diisocyanate trimer (HDIt), isophorone diisocyanate trimer, toluene diisocyanate trimer, tetramethylxylene diisocyanate trimer, methylene diphenyl diisocyanate trimers, and the like. Adhesion promoters include, but are not limited to, toluene diisocyanates, tetramethylxylene diisocyanate (TMXDI), and methylene diphenyl diisocyanate (MDI) including any mixture of its three isomers 2,2′-MDI, 2,4′-MDI and 4,4′-MDI; liquid MDI; solid MDI; hexamethylenediisocyanatetrimer (HDIt); hexamethylenediisocyanate (HDI); isophorone diisocyanate (IPDI); 4,4′-methylene bis(cyclohexyl isocyanate) (H12MDI); polymeric MDI (PM200); MDI prepolymer (Lupranate® 5080); liquid carbodiimide modified 4,4′-MDI (Lupranate® MM103); liquid MDI (Lupranate® MI); liquid MDI (Mondur® ML); and liquid MDI (Mondur® MLQ). Adhesion promoters may be methylene diphenyl diisocyanate (MDI) including any mixture of its three isomers 2,2′-MDI, 2,4′-MDI and 4,4′-MDI; liquid MDI; solid MDI; hexamethylenediisocyanatetrimer (HDIt); hexamethylene diisocyanate (HDI); isophorone diisocyanate (IPDI); 4,4′-methylene bis(cyclohexyl isocyanate) (H12MDI); polymeric MDI (PM200); MDI prepolymer (Lupranate® 5080); liquid carbodiimide modified 4,4′-MDI (Lupranate® MM103); liquid MDI) (Lupranate® MI); liquid MDI (Mondur® ML); liquid MDI (Mondur® MLQ).

Additional adhesion promoters that may be used in the invention include compositions comprising at least one compound containing at least two isocyanate groups (e.g., methylene diphenyl diisocyanate, hexamethylene diisocyanate) and at least one compound comprising a heteroatom-containing functional group with a metathesis active olefin (e.g., 2-hydroxyethyl bicyclo[2.2.1]hept-2-ene-5-carboxylate (HENB), 2-hydroxyethyl acrylate (HEA), oleyl alcohol, 9-decen-1-ol), where the compounds may be combined in various ratios to form a pre-reacted mixture, For example, the pre-reacted mixtures include liquid MDI (Mondur® MLQ) and 2-hydroxyethyl bicycle[2.2.1]hept-2-ene-carboxylate (HENB); pre-reacted mixtures of liquid MDI (Mondur® MLQ) and 2-hydroxyethyl acrylate (HEA); pre-reacted mixtures of liquid MDI (Mondur® MLQ) and oleyl alcohol; and pre-reacted mixtures of liquid MDI (Mondur® MLQ) and 9-decen-1-ol. The pre-reacted mixture may be used as the adhesion promoter in the invention. Further examples of such adhesion promoters are described in U.S. Pat. No. 9,527,982, the disclosure of which is incorporated herein by reference. It is also possible to use a mixture of HENB-MDI and excess, unreacted MDI as the adhesion promoter in the invention.

In some embodiments, such as when a polyolefin comprising maleic anhydride is used as the adhesion promoter, the adhesion promoter may not comprise any isocyanate moieties. Furthermore, in some embodiments, the adhesion promoter does not contain any compound containing at least two isocyanate groups. And in other embodiments, the ROMP composition does not contain any compound containing at least two isocyanate groups.

Additional adhesion promoters suitable for use in the invention comprise functionalized silanes of the formula Fn-(A)ₙ-Si(Y*)₃, wherein Y* is selected from halide (e.g., chloride) or OR; Fn is a functional group selected from acrylate, methacrylate, allyl, vinyl, alkene, cycloalkene, or norbornene; A is a divalent linking group selected from hydrocarbylene, substituted hydrocarbylene, heteroatom-containing hydrocarbylene, or substituted heteroatom-containing hydrocarbylene: n is 0 or 1; and R is selected from hydrocarbyl, substituted hydrocarbyl, heteroatom-containing hydrocarbyl, or substituted heteroatom-containing hydrocarbyl, such as lower alkyl (e.g., methyl, ethyl, or isopropyl); and a peroxide selected from dialkyl and diaryl peroxides.

Additional adhesion promoters for use in the invention include those disclosed in International Pat. App. Nos. PCT/US2012/042850 and PCT/US2016/017449, the disclosure of which are incorporated herein by reference.

An additional adhesion promoter that may be used in the invention is at least one polyoctenamer, such as Vestenamer® (e.g., Vestenamer 8012, Vestenamer CS10). Polyoctenamers may be present in the ROMP composition in an amount ranging from 0.1 to 3 phr (e.g., 0.5 to 2 phr, 0.75 to 1.5 phr), for example I phr.

One or more of any of the aforementioned adhesion promoters, in any combination, may be used in the ROMP composition of the invention. For example, at least one acid-functionalized polyolefin may be used in combination with at least one polyoctenamer.

If present, any concentration of adhesion promoter is sufficient for the invention. For example, the at least one adhesion promoter may be present in the ROMP composition in an amount ranging from 0.05 to 15 wt. % (e.g., 0.1 to 13 wt. %, 0.5 to 10 wt. %, 1 to 8 wt. %, 2 to 6 wt. %, 3 to 5 wt. %), based on the total weight of the ROMP composition. For example, the adhesion promoter may comprise 0.1 to 10 wt. % (e.g., 0.5 to 9 wt. %, 1 to 8 wt. %, 2 to 7 wt. %, 3 to 6 wt. %, 4 to 5 wt. %), based on the total weight of the ROMP composition, of the at least one acid-functionalized polyolefin, and 0.05 to 5 wt. % (e.g., 0.1 to 4 wt. %, 0.5 to 3 wt. %, 1 to 2 wt. %), based on the total weight of the ROMP composition, of at least one polyoctenamer.

### Plasticizer Compound

The plasticizer compound used in the ROMP composition of the invention disclosed herein comprise, consist essentially of, or consist of any compound or substance that improves the flexibility, workability, or distensibility of a plastic or elastomer.

For example, the plasticizer compound may be selected from the group consisting of a polybutene oil (PB), a polyalphaolefin oil, a hydrocarbon resin, and mixtures thereof. The plasticizer compound may be a PB oil.

PB oil is an oligomer or polymer made from butene monomers, such as 1-butene and isobutene, or a mixture of butene monomers. PB oils possess the general repeat unit structure of (C₄H₈)ₙ. PB oil made from isobutene monomer may be referred to as polyisobutene or polyisobutylene. PB oil made from 1-butene may be referred to as poly(1-butene). Commercial sources of polybutene oil that may be used in the invention include, for example, Indopol® H-15, H-25, H-50, H-100, H-300, H-1200, H-1500, H-1900, H-2100). Higher molecular weight polybutene oils may be semi solid at room temperature.

The polyalphaolefin oil may comprise oligomers of C5 to C18 olefins (e.g., C6 to C14, C8 to C12, C10); having a kinematic viscosity of 3 to 30 cSt or more at 100° C. (e.g., 20 cSt or less, 4 cSt or more at 100° C.); and a pour point of −10° C. or less (e.g., −20° C. or less, −30° C. or less). For example, the polyalphaolefin oil may be Group IV hydrocarbon oil basestocks, polyisobutenes, wax isomerate lubricant oil basestocks, ethylene/butene copolymers, or mixtures thereof. For example, the polyalphaolefin oil may be Group IV hydrocarbon basestocks, such as those derived from linear alpha olefins. For example, polyalphaolefin oils derived from oligomerization of linear alpha olefins such as, but not limited to. C8, C10, C12, C14, C16, and C18. Typical molecular weights, as defined by number average molecular weight, Mₙ, defining polyalphaolefin oil are 250 g/mol to 10000 g/mol (e.g., 300 g/mol, 500 g/mol, 1000 g/mol, 2000 g/mol, 4000 g/mol, 6000 g/mol, 7000 g/mol, 9000 g/mol, 9500 g/mol). Commercial polyalphaolefin oils include SpectraSyn 100, SpectraSyn 40, SpectraSyn 10, SpectraSyn 8, SpectraSyn 6, SpectraSyn 5, SpectraSyn 4, SpectraSyn 2, and SpectraSyn Elite 300.

The at least one plasticizer compound may be present in the ROMP composition in an amount ranging from 1 to 40 wt. % (e.g., 5 to 45 wt. %, 10 to 40 wt. %, 25 to 35 wt. %), based on the total weight of the ROMP composition.

### Rubber Toughener Compound

The rubber tougher compound (also referred to herein as impact modifiers or elastomers) used in the ROMP composition of the invention disclosed herein, include, without limitation, butyl rubber, polyisobutylene, ethylene-propylene copolymer, styrene-ethylene/butylene-styrene copolymer, styrene-ethylene/propylene-styrene copolymer, ethylene-propylene-diene terpolymers, ethylene-vinyl acetate, and nitrile rubbers. Impact modifiers or elastomers may be polybutadiene Diene 55AC10 (Firestone), polybutadiene Diene 55AM5 (Firestone), EPDM Royalene 301T, EPDM Buna T9650 (Bayer), styrene-ethylene/butylene-styrene copolymer Kraton G1651H, Polysar Butyl 301 (Bayer), polybutadiene Taktene 710 (Bayer), styrene-ethylene/butylene-styrene Kraton G1726M, styrene-ethylene/butylene-styrene Kraton G1650, Ethylene-Octene Engage 8150 (DuPont-Dow), styrene-butadiene Kraton D1184, EPDM Nordel 1070 (DuPont-Dow), and polyisobutylene Vistanex MML-140 (Exxon). Various polar impact modifiers or elastomers can also be used.

The at least one rubber toughener compound may be selected from the group consisting of a poly(styrene-ethylene-butylene-styrene), an ethylene-propylene copolymer, an ethylene-propylene diene terpolymer, and mixtures thereof. The rubber toughener compound may be an ethylene-propylene copolymer (e.g., Vistalon 501, Vistalon 3702). The rubber toughener compound may be a poly(styrene-ethylene-butylene-styrene (e.g., Kraton 1650, Kraton 1651, Taipol 6151).

The at least one rubber toughener compound may be present in an amount ranging from 0.01 to 30 wt. % (e.g., 0.1 to 25 wt. %, 1 to 20 wt. %, 5 to 15 wt. %, 7 to 12 wt. %), based on the total weight of the ROMP composition.

### ROMP Composition

As disclosed herein, the ROMP composition of the invention comprises, consists essentially of or consists of
a) the cyclic olefin composition disclosed herein;
b) the catalyst composition disclosed herein;
c) optionally, the at least one adhesion promoter disclosed herein;
d) the at least one plasticizer compound disclosed herein; and
e) the at least one rubber toughener compound disclosed herein,
wherein the cyclic olefin composition does not contain, or is substantially free of, a monounsaturated cyclic olefin,
wherein the at least one multiunsaturated cyclic olefin may be substituted or unsubstituted,
wherein the monounsaturated cyclic olefin is selected from ONB, or wherein the monounsaturated cyclic olefin is selected from at least one substituted norbornene, including, but not limited to, the monounsaturated substituted norbornenes encompassed by cyclic olefin structures (D), (E), or (F) (as defined above), or wherein the monounsaturated cyclic olefin is selected from any monounsaturated cyclic olefin.

The ROMP composition of the invention may also comprise at least one substrate material. Additionally, the ROMP composition may be applied to at least one substrate material. The substrate material may be functionalized substrate material, such as, for example, a heteroatom-functionalized substrate, such as, for example, an amino-functionalized substrate. Additionally, the at least one substrate material may be, for example, a glass substrate material or carbon substrate material. Substrate materials may advantageously comprise an aminosilane-treated substrate.

The ROMP composition of the invention may additionally comprise an exogenous inhibitor. Exogenous inhibitors, or “gel modification additives,” for use in the invention are disclosed in U.S. Pat. No. 5,939,504, the disclosure of which is incorporated herein by reference. The ROMP composition of the invention may additionally comprise a hydroperoxide gel modifier. Hydroperoxide gel modifiers (e.g., cumene hydroperoxide) for use in the invention are disclosed in International Pat. App. No. PCT/US2012/042850.

The ROMP composition of the invention may be optionally formulated with additives. Suitable additives include, but are not limited to, gel modifiers, hardness modulators, antioxidants, antiozonants, stabilizers, crosslinkers, fillers, binders, coupling agents, thixotropes, wetting agents, biocides, additional plasticizers, pigments, flame retardants, dyes. Furthermore, the amount of additives present in the ROMP compositions may vary depending on the particular type of additive used. The concentration of the additives in the ROMP compositions typically ranges from, for example, 0.001 to 85 wt. % (e.g., 0.01 to 75 wt. %, 0.1 to 65 wt. %, 1 to 55 wt. %, 5 to 45 wt. %, 10 to 35 wt. %, 15 to 25 wt. %), based on the total weight of the ROMP composition.

The ROMP composition of the invention may be optionally formulated with or without a crosslinker, for example, a crosslinker selected from dialkyl peroxides, diacyl peroxides, and peroxyacids.

Antioxidants and antiozonants include any antioxidant or antiozonant used in the rubber or plastics industry. An “Index of Commercial Antioxidants and Antiozonants, Fourth Edition” is available from Goodyear Chemicals, The Goodyear Tire and Rubber Company, Akron, Ohio 44316. Suitable stabilizers (i.e., antioxidants or antiozonants) include without limitation: 2,6-di-tert-butyl-4-methylphenol (BHT); styrenated phenol, such as Wingstay® S (Goodyear); 2- and 3-tert-butyl-4-methoxyphenol; alkylated hindered phenols, such as Wingstay C (Goodyear); 4-hydroxymethyl-2,6-di-tert-butylphenol: 2,6-di-tert-butyl-4-sec-butylphenol; 2,2′-methylenebis(4-methyl-6-tert-butylphenol); 2,2′-methylenebis(4-ethyl-6-tert-butylphenol); 4,4′-methylenebis(2,6-di-tert-butylphenol); miscellaneous bisphenols, such as Cyanox® 53 (Cytec Industries Inc.) and Permanax WSO; 2,2′-ethylidenebis(4,6-di-tert-butylphenol); 2,2′-methylenebis(4-methyl-6-(1-methylcyclohexyl)phenol); 4,4′-butylidenebis(6-tert-butyl-3-methylphenol); polybutylated Bisphenol A; 4,4′-thiobis(6-tert-butyl-3-methylphenol); 4,4′-methylenebis(2,6-dimethylphenol); 1,1′-thiobis(2-naphthol): methylene bridged polyalkylphenol, such as Ethyl antioxidant 738; 2,2′-thiobis(4-methyl-6-tert-butylphenol); 2,2′-isobutylidenebis(4,6-dimethylphenol): 2,2′-methylenebis(4-methyl-6-cyclohexylphenol); butylated reaction product of p-cresol and dicyclopentadiene, such as Wingstay L; tetrakis(methylene-3,5-di-tert-butyl-4-hydroxyhydrocinnamate)methane, i.e., Irganox® 1010 (BASF): 1,3,5-trimethyl-2,4,6-tris(3,5-di-tert-butyl-4-hydroxybenzyl)benzene, e.g., Ethanox® 330 (Albemarle Corporation); 4,4′-methylenebis (2,6-di-tertiary-butylphenol), e.g., Ethanox 4702 or Ethanox 4710; 1,3,5-tris(3,5-di-tert-butyl-4-hydroxybenzyl)isocyanurate, i.e., Good-rite® 3114 (Emerald Performance Materials), 2,5-di-tert-amylhydroquinone, tert-butylhydroquinone, tris(nonylphenylphosphite), bis(2,4-di-tert-butyl)pentaerythritol)diphosphite, distearyl pentaerythritol diphosphite, phosphited phenols and bisphenols, such as Naugard® 492 (Chemtura Corporation), phosphite/phenolic antioxidant blends, such as Irganox B215; di-n-octadecyl(3,5-di-tert-butyl-4-hydroxybenzyl)phosphonate, such as Irganox 1093; 1,6-hexamethylene bis(3-(3,5-di-tert-butyl-4-hydroxyphenylpropionate), such as Irganox 259, and octadecyl-3,5-di-tert-butyl-4-hydroxyhydrocinnamate, i.e., Irganox 1076, tetrakis(2,4-di-tert-butylphenyl)4,4′-biphenylylenediphosphonite, diphenylamine, and 4,4′-diemthoxydiphenylamine. Such materials are normally employed in the ROMP composition at levels of about 0.10 phr to 10 phr, such as at levels of about 0.1 phr to 5 phr.

Suitable fillers include, for example, metallic density modulators, microparticulate density modulators, such as, for example, microspheres, and macroparticulate density modulators, such as, for example, glass or ceramic beads. Metallic density modulators include, but are not limited to, powdered, sintered, shaved, flaked, filed, particulated, or granulated metals, metal oxides, metal nitrides, and/or metal carbides, and the like. Metallic density modulators include, among others, tungsten, tungsten carbide, aluminum, titanium, iron, lead, silicon oxide, aluminum oxide, boron carbide, and silicon carbide. Microparticulate density modulators include, but are not limited to, glass, metal, thermoplastic (either expandable or pre-expanded) or thermoset, and/or ceramic/silicate microspheres. Macroparticulate density modulators include, but are not limited to, glass, plastic, or ceramic beads; metal rods, chunks, pieces, or shot; hollow glass, ceramic, plastic, or metallic spheres, balls, or tubes; and the like.

The ROMP composition of the invention may be made by combining the cyclic olefin composition, the catalyst composition, the optional adhesion promoter, the plasticizer compound, and the rubber toughener compound using any method known in the art.

The ROMP compositions of the invention are generally less sensitive to air and/or moisture than resins used to prepare polyurethane and epoxy-based polymers and DCPD polymers prepared from molybdenum and tungsten catalyzed DCPD resins (e.g., Telene(@DCPD Resin, Metton® DCPD Resin, Pentam® DCPD Resin). Therefore, ROMP compositions of the invention are generally more robust to a wider array of environmental conditions (e.g., temperature, humidity, etc.). Resin systems that are less sensitive to air and/or moisture offer a benefit over more sensitive resin systems, particularly if objects are to be coated (thermally insulated) at on-site marine environments, such as on boats, offshore oil rigs, offshore oil platforms, etc.

Furthermore, ROMP compositions of the invention offer improved ease of application over prior art ROMP compositions, particularly polypropylene systems. Unlike polypropylene systems, which are primarily limited to extrusion, ROMP compositions of the invention can be applied to an object and/or object surface by a variety of means including but not limited to pouring, casting, infusing, injecting, molding, spraying, rotationally molding, centrifugally casting, pultrusion, extrusion, etc. Moreover, ROMP compositions of the invention also offer improved ease of application over prior art ROMP compositions based on epoxy resins (e.g., elastomeric amine cured epoxy materials). Unlike epoxy-based resin systems (e.g., elastomeric amine cured epoxy materials), which are synthesized in at least two steps, ROMP compositions of the invention simply require a single mixing step (e.g., a ROMP composition of the invention is mixed with the catalyst composition of the invention) prior to application to an object surface or addition to a mold. Unlike DCPD resin systems containing molybdenum or tungsten two-component catalyst systems (e.g., Telene® DCPD Resin, Metton® DCPD Resin, Pentam® DCPD Resin), which require specialized and expensive processing and handling conditions and equipment, including specialized and expensive molds, injection equipment, and storage tanks, ROMP compositions of the invention can be applied to an object and/or object surface by a variety of means including but not limited to simple casting.

A particular benefit of the ROMP compositions of the invention is that they are easy to handle and can be easily formulated such that the resultant ROMP polymer and ROMP polymer composites, discussed below, meet the needs/requirements of the application or service. For example, ROMP compositions of the invention used to prepare ROMP polymers or ROMP polymer composites of the invention can be easily formulated such that the resultant ROMP polymers or ROMP polymer composites may exhibit a range of physical, mechanical and/or thermal properties spanning the range from elastomeric behavior and/or properties to rigid thermoset behavior and/or properties depending on the needs/requirements of the application.

### ROMP Polymers and ROMP Polymer Composites

The invention is also directed to ROMP polymers or ROMP polymer composites comprising, consisting essentially of, or consisting of the reaction product of the ROMP composition of the invention, wherein the ROMP composition is subjected to conditions effective to polymerize the ROMP composition.

The invention also relates to the ROMP polymer or ROMP polymer composite of the invention for use as thermal insulation materials.

The invention also relates to the use of the ROMP polymer or the ROMP polymer composite for thermally insulating an object. For example, ROMP polymers and/or ROMP polymer composites of the invention can be used to thermally insulate any object from a surrounding environment or surrounding material, where the surrounding environment or surrounding material may be a gas (e.g., air), a fluid (liquid) (e.g., sea water, fresh water), or a solid (e.g., ice or subterranean solids as in the case of a buried pipeline), or a mixture thereof.

In particular, the ROMP polymer and ROMP polymer composite of the invention are suitable for thermal insulation of objects, such as oil pipelines in cold water (e.g., cold sea water, cold fresh water) and for insulating wellhead equipment. The ROMP polymer and ROMP polymer composite of the invention may also be used for insulating other objects including but not limited to pipes, sub-sea pipes, pipelines, oil pipelines, subsea oil pipelines, subsea pipelines, pipe fittings, hose, hose fitting, tanks, containers, drums, manifolds, risers, field joints, configurations designated as Christmas tree (oil field Christmas tree, subsea Christmas tree), jumpers, spool pieces, configurations designated as pipeline end termination (PLET), configurations designated as pipeline end manifolds (PLEM), and other sub-sea architectures and equipment. The ROMP polymers and ROMP polymer composites of the invention may also be used to coat other objects such as robotic parts, devices and vehicles used in sub-sea applications. Moreover, the ROMP polymer and ROMP polymer composite of the invention may be used to construct thermal insulation structures such as configurations designated as subsea dog houses.

The invention also relates to a process for a ROMP polymer coating for offshore applications, the process comprising, providing an object surface to be at least partially coated, encased, or insulated, contacting the object surface with the ROMP composition or applying the ROMP composition to the object surface, and subjecting the ROMP composition to conditions effective to polymerize the ROMP composition.

While the ROMP polymer and ROMP polymer composite of the invention are well suited for coating, encasing, or insulating objects which are to be submerged in water (e.g., fresh water, salt water, sea water, etc.) the ROMP polymers and ROMP polymer composites may also be used to coat, encase, or thermally insulate objects which are not exposed to an aqueous environment.

ROMP polymers and ROMP polymer composites of the invention may be used for coating, encasing, or insulating objects (e.g., pipes and/or other subsea structures) where the temperature of materials (e.g., hydrocarbons, oil, gas, etc.) transported by the objects (e.g., pipes and/or other structures) is greater than or equal to 160° C. Therefore, by default, ROMP polymers and/or ROMP polymer composites of the invention may also be used for coating, encasing, or insulating objects (e.g., pipes and/or other subsea structures) where the temperature of materials (e.g., hydrocarbons, oil, gas, etc.) transported by the objects (e.g., pipes and/or other subsea structures) is less than 160° C.

The application of the ROMP composition of the invention to the object surface to be at least partially coated is carried out by methods known in the art, examples include, but are not limited to casting, centrifugal casting, pultrusion, molding, rotational molding, open molding, reaction injection molding (RIM), resin transfer molding (RTM), pouring, vacuum impregnation, surface coating, filament winding, cell casting, dip casting, continuous casting, embedding, potting, encapsulation, film casting or solvent casting, gated casting, mold casting, slush casting, extrusion, mechanical foaming, chemical foaming, physical foaming, compression molding or matched die molding, spray up, spraying, Vacuum Assisted Resin Transfer Molding (VARTM), Seeman's Composite Resin Infusion Molding Process (SCRIMP), blow molding, in mold coating, in-mold painting or injection, vacuum forming, Reinforced Reaction Injection Molding (RRIM), Structural Reaction Injection Molding (SRIM), thermal expansion transfer molding (TERM), resin injection recirculation molding (RICM), controlled atmospheric pressure resin infusion (CAPRI), hand-layup. For manufacturing techniques requiring the use of a RIM or impingement style mixhead, including without limitation RIM, SRIM, and RRIM, articles of manufacture may be molded using a single mixhead or a plurality of mixheads as well as a plurality of material injection streams (e.g., two resin streams and one catalyst stream).

The ROMP polymer and/or ROMP polymer composite of the invention need not necessarily be molded around an object to be insulated. In the alternative, a ROMP polymer article and a ROMP polymer composite article may be independently prepared by a variety of methods known in the art and then subsequently affixed to or placed around an object to thermally insulate the object from the surrounding environment. Moreover, the means for affixing the ROMP polymer article and ROMP polymer composite article to an object may be by any known means including an adhesive means and/or mechanical means such as fasteners, bolts, screws, etc. For example, the ROMP polymer and a ROMP polymer composite can be pre-made into sections which are shaped to complement the object to be insulated. The pre-made sections may then be secured or affixed to the object using any known means.

Additionally, the object to be insulated may be pretreated with any known tie coat or primer, which is suitable to improve and/or enhance the adhesion of the ROMP polymer and ROMP polymer composite of the invention to the object. For example, the tie coat or primer may be first applied to the object to be insulated, then the ROMP composition of the invention may be applied to the object, and the ROMP composition is subsequently subjected to conditions effective to polymerize the ROMP composition. Furthermore, the tie coat or primer may be applied to the object to be insulated, and a pre-made ROMP polymer or pre-made ROMP polymer composite of the invention may be subsequently affixed to the object.

ROMP polymers, ROMP polymer composites, and thermal insulation materials (discussed herein) of the invention may have, independent of one another, thermal conductivity values at a mean temperature of 25° C. of less than 0.180 W/m*K (e.g., less than 0.170 W/m*K, less than 0.160 W/m*K), as determined by ASTM C518, as tested on heat flow instrument (FOX-50, LaserComp). ROMP polymers, ROMP polymer composites, and thermal insulation materials of the invention may be further reduced by the addition of glass microspheres.

ROMP polymers, ROMP polymer composites, and thermal insulation materials of the invention may have, independent of one another, a pull-off adhesion strength to fusion bonded epoxy (FBE) greater than 2 MPa (e.g., greater than 4, greater than 5), as determined by the following method described in the general procedure section. The FBE may be, for example. PipeClad HOT 150.

### Thermal Insulation Materials

The invention is also directed to a thermal insulation material comprising, consisting essentially of, or consisting of the ROMP composition, ROMP polymer, or ROMP polymer composite of the invention.

The ROMP polymer and ROMP polymer composite of the invention offer improved thermal stability and/or improved hydrolytic stability over prior art thermal insulation materials. Thermal insulation materials made from ROMP polymers of the invention offer an advantage over prior art thermal insulation materials made from polypropylene in such ROMP polymers possess improved thermal stability.

The invention also relates to a thermal insulation material for use in coating, encasing, or insulating (1) an object; (2) at least a portion of an object; and/or (3) at least a portion of at least one surface of an object, wherein the thermal insulation material comprises the ROMP composition, ROMP polymer, or ROMP polymer composite of the invention.

The invention also relates to the use of a thermal insulation material for coating, encasing, or insulating (1) an object; (2) at least a portion of an object; and/or (3) at least a portion of at least one surface of an object, wherein the thermal insulation material comprises the ROMP composition, ROMP polymer, or ROMP polymer composite of the invention.

The invention also relates to a method of thermally insulating an object from a surrounding fluid, the method comprising interposing a thermal insulation material between the object and the fluid where the thermal insulation material comprises the ROMP composition, ROMP polymer, or ROMP polymer composite of the invention.

The invention also relates to a method for coating, encasing, or insulating (1) an object; (2) at least a portion of an object; and/or (3) at least a portion of at least one surface of an object, with a thermal insulation material, wherein the thermal insulation material comprises the ROMP composition, ROMP polymer, or ROMP polymer composite of the invention.

The invention also relates to a method for coating, encasing, or insulating (1) an object; (2) at least a portion of an object; and/or (3) at least a portion of at least one surface of an object, with a thermal insulation material, comprising: contacting the ROMP composition of the invention with, or applying the ROMP composition of the invention to, (1) the object: (2) at least a portion of the object; and/or (3) at least a portion of at least one surface of the object; and subjecting the ROMP composition to conditions effective to promote a ROMP reaction of the ROMP composition to form the ROMP polymer or ROMP polymer composite of the invention, wherein the thermal insulation material is the ROMP polymer or ROMP polymer composite.

The invention also relates to a process for applying a thermal insulation material to an object, comprising: placing a mold around an object to define a cavity between an internal surface of the mold and the object: injecting a thermal insulation material in the cavity, wherein the thermal insulation material composition comprises the ROMP composition of the invention; and subjecting the thermal insulation material composition to conditions effective to promote a ROMP reaction of the ROMP composition to form the ROMP polymer or ROMP polymer composite of the invention.

The invention relates to an object at least partially coated, encased, or insulated with a thermal insulation material of the invention.

The objects to be encased, coated and/or insulated may be of any configuration, weight, size, thickness, or geometric shape. For example, pipe coated with the ROMP polymer and/or ROMP polymer composite of the invention can have any outer diameter, inner diameter, and length.

Furthermore, the objects to be encased, coated and/or insulated may be constructed of any material including but not limited to metal, metal alloys, plastic, rubber, polymer, wood, ceramic, glass, carbon, cement, concrete, etc.

The objects to be encased, coated, and/or insulated may be partially or fully encased, coated, and/or insulated.

The thermal insulation material may be of any configuration, weight, size, thickness, or geometric shape. Furthermore, the thermal insulation material is not limited to a single polymer layer, but also include multiple polymer layers, where each polymer layer may comprise the same or different composition.

The invention also relates to a thermal insulation material comprising the ROMP polymer of the invention, where the ROMP polymer has an elongation at break that ranges from at least 20%, from at least 50%, from at least 75%, from at least 100%, from at least 125%, from at least 150%, from at least 175%, from at least 200%, from at least 225%, from at least 250%, from at least 275%, from at least 300%, or from at least 400%.

The invention also relates to a thermal insulation material comprising the ROMP polymer of the invention, where the ROMP polymer has an elongation at break that ranges from 20% to 400%, 20% to 300%, 20% to 275%, 20% to 250%, 20% to 225%, 20% to 200%, 20% to 175%, 20% to 150%, 20% to 125%, 20% to 100%, 20% to 75%, 20% to 50%, 50% to 300%, 50% to 275%, 50% to 250%, 50% to 225%, 50% to 200%, 50% to 175%, 50% to 150%, 50% to 125%, 50% to 100%, 50% to 75%, 75% to 400%, 75% to 300%, 75% to 275%, 75% to 250%, 75% to 225%, 75% to 200%, 75% to 175%, 75% to 150%, 75% to 125%,75% to 100%, 100% to 400%, 100% to 300%, 100% to 275%, 100% to 250%, 100% to 225%, 100% to 200%, 100% to 175%, 100% to 150%, 100% to 125%, 125% to 400%, 125% to 300%, 125% to 275%, 125% to 250%, 125% to 225%, 125% to 200%, 125% to 175%, 125% to 150%, 150% to 400%, 150% to 300%, 150% to 275%, 150% to 250%, 150% to 225%, 150% to 200%, 150% to 175%, 175% to 400%, 175% to 300%, 175% to 275%, 175% to 250%, 175% to 225%, 175% to 200%, 200% to 400%, 200% to 300%, 200% to 275%, 200% to 250%, 200% to 225%, 225% to 400%, 225% to 300%, 225% to 275%, 225% to 250%, 250% to 400%, 250% to 300%, 250% to 275%, 275% to 400%, or 275% to 300%.

Thermal insulation materials made from ROMP polymers of the invention offer an advantage over prior art thermal insulation materials made from polyurethane and epoxy-based materials, including elastomeric amine cured epoxy materials, in that cyclic olefins (cyclic olefin monomers) used to make such ROMP polymers may be selected so that the resultant ROMP polymers do not contain carbon-heteroatom bonds in the polymer backbone. Therefore, ROMP polymers of the invention are generally more hydrolytically stable than polyurethanes and/or epoxy-based polymers, each of which possess carbon-heteroatom bonds in the polymer backbone. Preferentially, ROMP polymers of the invention possess a polymer backbone containing only carbon-carbon single bonds and carbon-carbon double bonds, where the carbon atoms may be substituted or unsubstituted. ROMP polymers of the invention may be optionally hydrogenated by any known method, to provide a hydrogenated ROMP polymer for use as thermal insulation.

Unexpectedly, the ROMP polymers, ROMP polymer composites, and thermal insulation materials of the invention possessed some or all the desired characteristics and/or properties specified above for thermal insulation materials, in particular thermal insulation materials used in offshore drilling (e.g., subsea applications). As such, the ROMP polymer, ROMP polymer composites, and thermal insulation materials of the invention satisfy this need in the industry.

It is to be understood that while the invention has been described in conjunction with specific embodiments thereof, the description above as well as the examples that follow are intended to illustrate and not limit the scope of the invention. Other aspects, advantages, and modifications within the scope of the invention will be apparent to those skilled in the art to which the invention pertains.

### Articles of Manufacture

The invention is also directed to an article of manufacture manufactured from the ROMP composition, ROMP polymer. ROMP polymer composite, or thermal insulation material of the invention.

The invention also relates to an article of manufacture comprising an object, wherein at least a portion of at least one surface of the object is coated, encased, or insulated with the ROMP composition, ROMP polymer, ROMP polymer composite, or thermal insulation material of the invention.

The invention is also directed to articles manufactured from the ROMP composition of the invention, wherein the ROMP composition is applied to at least one substrate material.

The invention is also directed to articles manufactured from the ROMP composition of the invention and at least one substrate material, wherein the article is a thermal insulation material. Additionally, the invention relates to articles manufactured from the ROMP composition of the invention, wherein the ROMP composition is applied to at least one substrate material, which may be, for example, a functionalized substrate, such as, for example, a heteroatom-functionalized substrate, such as, for example, an amino-functionalized substrate, wherein the article is a thermal insulation material.

The invention also relates to an article of manufacture made by any of the methods described herein.

### Exemplary Embodiments of the Invention

E1. A ROMP composition comprising, consisting essentially of, or consisting of:
a) a cyclic olefin composition comprising, consisting essentially of, or consisting of at least one multiunsaturated cyclic olefin;
b) a catalyst composition comprising, consisting essentially of, or consisting of at least one metal carbene olefin metathesis catalyst;
c) optionally, at least one adhesion promoter;
d) at least one plasticizer compound; and
e) at least one rubber toughener compound,
wherein the cyclic olefin composition does not contain, or is substantially free of, a monounsaturated cyclic olefin,
wherein the at least one multiunsaturated cyclic olefin may be substituted or unsubstituted,
wherein the monounsaturated cyclic olefin is selected from 5-octyl-2-norbornene (ONB).
E2. The ROMP composition of E1, wherein the monounsaturated cyclic olefin is selected from at least one monounsaturated substituted norbornene.
E3. The ROMP composition of E1 or E2, wherein the monounsaturated cyclic olefin is selected from any monounsaturated cyclic olefin.
E4. The ROMP composition of any one of E1-E3, wherein the cyclic olefin composition comprises, consists essentially of, or consists of 90 to 100 wt. % (e.g., 91 to 99.9 wt. %, 92 to 99 wt. %, 93 to 98 wt. %, 94 to 97 wt. %, 95 to 96 wt. %) of the at least one multiunsaturated cyclic olefin and 10 wt. % or less (e.g., 9 wt. % or less, 8 wt. % or less, 7 wt. % or less, 6 wt. % or less, 5 wt. % or less, 4 wt. % or less, 3 wt. % or less, 2 wt. % or less, 1 wt. % or less, 0.5 wt. % or less, 0.1 wt. % or less, 0.01 wt. % or less, 0 wt. %) of the monounsaturated cyclic olefin, based on the total weight of the cyclic olefin composition.
E5. The ROMP composition of any one of E1-E4, wherein the ROMP composition does not contain, or is substantially free of (e.g., 10 wt. % or less, 9 wt. % or less, 8 wt. % or less, 7 wt. % or less, 6 wt. % or less, 5 wt. % or less, 4 wt. % or less, 3 wt. % or less, 2 wt. % or less. I wt. % or less, 0.5 wt. % or less, 0.1 wt. % or less, 0.01 wt. % or less: based on the total weight of the ROMP composition) the monounsaturated cyclic olefin.
E6. The ROMP composition of any one of E1-E5, wherein the cyclic olefin composition does not contain the monounsaturated cyclic olefin.
E7. The ROMP composition of any one of E1-E6, wherein the ROMP composition does not contain the monounsaturated cyclic olefin.
E8. The ROMP composition of any one of E1-E7, wherein the at least one multiunsaturated cyclic olefin is selected from the group consisting of dicyclopentadiene, tricyclopentadiene, 5-vinyl-2-norbornene, 5-ethylidene-2-norbornene, 5-isopropenyl-2-norbornene, 5-propenyl-2-norbornene, 5-butenyl-2-norbornene, and mixtures thereof.
E9. The ROMP composition of any one of E1-E8, wherein the at least one multiunsaturated cyclic olefin is selected from the group consisting of dicyclopentadiene, tricyclopentadiene, 5-ethylidene-2-norbornene, and mixtures thereof.
E10. The ROMP composition of any one of E1-E9, wherein the at least one multiunsaturated cyclic olefin is selected from the group consisting of dicyclopentadiene, tricyclopentadiene, and mixtures thereof.
E11. The ROMP composition of any one of E1-E10, wherein the cyclic olefin composition comprises, consists essentially of, or consists of 90 to 100 wt. % dicyclopentadiene (e.g., 91 to 99.9 wt. %, 92 to 99 wt. %, 93 to 98 wt. %, 94 to 97 wt. %, 95 to 96 wt. %) and 0 to 10 wt. % tricyclopentadiene and/or 5-ethylidene-2-norbornene (e.g., 0.1 to 9 wt. %, I to 8 wt. %, 2 to 7 wt. %, 3 to 6 wt. %, 4 to 5 wt. %), based on the total weight of the cyclic olefin composition.
E12. The ROMP composition of any one of E1-E11, wherein the at least one at least one metal carbene olefin metathesis catalyst is a Group 8 transition metal complex having the structure of formula (I):

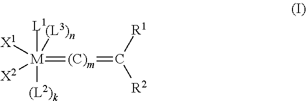

wherein:
M is a Group 8 transition metal;
L¹, L², and L³ are neutral electron donor ligands;
n is 0 or 1, such that L³ may or may not be present;
m is 0, 1, or 2:
k is0 or 1;
X¹ and X² are anionic ligands; and
R¹ and R² are independently selected from hydrogen, hydrocarbyl, substituted hydrocarbyl, heteroatom-containing hydrocarbyl,
wherein any two or more of X¹, X², L¹, L², L, R¹, and R² can be taken together to form one or more cyclic groups, and further wherein any one or more of X % X², L¹, L², L³, R¹, and R² may be attached to a support.
E13. The ROMP composition of E12, wherein the at least one at least one metal carbene olefin metathesis catalyst is a Group 8 transition metal complex having the structure of formula (I), wherein:
M is ruthenium:
n is O;
m is O;
k is 1;
L¹ and L² are trisubstituted phosphines independently selected from the group consisting of tri-nbutylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or
L¹ is an N-heterocyclic carbene selected from 1,3-bis(2,4,6-trimethylphenyl)-2-imidazolidinylidene, 1,3-bis(2,6-di-isopropylphenyl)-2-imidazolidinylidene, 1,3-bis(2,4,6-trimethylphenyl)-2-imidazol-2-ylidene, and 1,3-bis(2,6-di-isopropylphenyl)-2-imidazol-2-ylidene; and L² is a trisubstituted phosphine selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or
L¹ and L² are N-heterocyclic carbenes independently selected from the group consisting of 1,3-bis(2,4,6-trimethylphenyl)-2-imidazolidinylidene, 1,3-bis(2,6-di-isopropylphenyl)-2-imidazolidinylidene, 1,3-bis(2,4,6-trimethylphenyl)-2-imidazol-2-ylidene, and 1,3-bis(2,6-di-isopropylphenyl)-2-imidazol-2-ylidene;
X¹ and X² are chlorine; and
R¹ is hydrogen and R² is phenyl or —CH═C(CH₃)₂; or R¹ and R² are taken together to form an indenylidene moiety.
E14. The ROMP composition of any one of E1-E11, wherein the at least one at least one metal carbene olefin metathesis catalyst is a Group 8 transition metal complex having the structure of formula (VII):

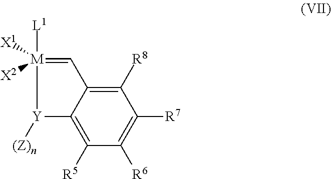

wherein:
M is a Group 8 transition metal;
X¹ and X² are anionic ligands;
L¹ is a neutral electron donor ligand;
Y is a heteroatom selected from N, O, S, and P;
R⁵, R⁶, R⁷, and R⁸ are each, independently, selected from the group consisting of hydrogen, halogen, alkyl, alkenyl, alkynyl, aryl, heteroalkyl, heteroatom containing alkenyl, heteroalkenyl, heteroaryl, alkoxy, alkenyloxy, aryloxy, alkoxycarbonyl, carbonyl, alkylamino, alkylthio, aminosulfonyl, monoalkylaminosulfonyl, dialkylaminosulfonyl, alkylsulfonyl, nitrile, nitro, alkylsulfinyl, trihaloalkyl, perfluoroalkyl, carboxylic acid, ketone, aldehyde, nitrate, isocyanate, hydroxyl, ester, ether, amine, imine, amide, trifluoroamide, sulfide, disulfide, sulfonate, carbamate, silane, siloxane, phosphine, phosphate, borate, or -A-Fn, wherein A is a divalent hydrocarbon moiety selected from alkylene and arylalkylene, wherein the alkyl portion of the alkylene and arylalkylene groups can be linear or branched, saturated or unsaturated, cyclic or acyclic, and substituted or unsubstituted, wherein the aryl portion of the of arylalkylene can be substituted or unsubstituted, and wherein hetero atoms and/or functional groups may be present in either the aryl or the alkyl portions of the alkylene and arylalkylene groups, and Fn is a functional group; and any combination of R⁵, R⁶, R⁷, and R⁸ can be linked to form one or more cyclic groups;
n is 1 or 2, such that n is 1 for the divalent heteroatoms O or S, and n is 2 for the trivalent heteroatoms N or P; and
Z is a group selected from hydrogen, alkyl, aryl, functionalized alkyl, functionalized aryl where the functional group may independently be one or more or the following: alkoxy, aryloxy, halogen, carboxylic acid, ketone, aldehyde, nitrate, isocyanate, hydroxyl, ester, ether, amine, imine, amide, trifluoroamide, sulfide, disulfide, carbamate, silane, siloxane, phosphine, phosphate, or borate; methyl, isopropyl, sec-butyl, t-butyl, neopentyl, benzyl, phenyl and trimethylsilyl; and
wherein any combination or combinations of X¹, X¹, L¹, V, Z, R¹, R⁶, R⁷, and R⁸ may be linked to a support.
E15. The ROMP composition of any one of E1-E14, wherein the at least one adhesion promoter composition is present and is selected from the group consisting of an acid-functionalized polyolefin, a compound containing at least two isocyanate groups, a composition comprising at least one compound containing at least two isocyanate groups and at least one compound comprising a heteroatom-containing functional group with a metathesis active olefin, at least one polyoctenamer, and mixtures thereof.
E16. The ROMP composition of E15, wherein the acid-functionalized polyolefin is a polyolefin comprising maleic anhydride.
E17. The ROMP composition of E16, wherein the polyolefin comprises polybutadiene.
E18. The ROMP composition of any one of E1-E17, wherein the ROMP composition does not contain a compound containing at least two isocyanate groups.
E19. The ROMP composition of any one of E1-E17, wherein the at least one compound containing at least two isocyanate groups is a diisocyanate, a triisocyanate, or a polyisocyanate.
E20. The ROMP composition of E19, wherein the at least one compound containing at least two isocyanate groups is selected from the group consisting of a toluene diisocyanate; tetramethylxylene diisocyanate (TMXDI); methylene diphenyl diisocyanate (MDI); a mixture of the three MDI isomers 2,2′-MDI, 2,4′-MDI, and 4,4′-MDI: liquid MDI; solid MDI: hexamethylenediisocyanatetrimer (HDIt); hexamethylenediisocyanate (HDI); isophorone diisocyanate (IPDI): 4,4′-methylene bis(cyclohexyl isocyanate) (H12MDI); polymeric MDI (PM200); MDI prepolymer; liquid carbodiimide modified 4,4′-MDI; and mixtures thereof.
E21. The ROMP composition of E20, wherein the at least one compound containing at least two isocyanate groups is 4,4′-methylene diphenyl diisocyanate (MDI).
E22. The ROMP composition of E15, wherein the composition comprising at least one compound containing at least two isocyanate groups and at least one compound comprising a heteroatom-containing functional group with a metathesis active olefin is selected from the group consisting of liquid MDI and 2-hydroxyethyl bicycle[2.2.1]hept-2-ene-carboxylate (HENB); liquid MDI and 2-hydroxyethyl acrylate (HEA); liquid MDI and oleyl alcohol; and liquid MDI and 9-decen-1-ol.
E23. The ROMP composition of E22, wherein the composition comprising at least one compound containing at least two isocyanate groups and at least one compound comprising a heteroatom-containing functional group with a metathesis active olefin is selected from liquid MDI and HENB.
E24. The ROMP composition of E22 or E23, wherein the at least one compound containing at least two isocyanate groups and at least one compound comprising a heteroatom-containing functional group with a metathesis active olefin are pre-reacted.
E25. The ROMP composition of E24, wherein the liquid MDI and HENB are pre-reacted to form a mixture of HENB-MDI.
E26. The ROMP composition of E25, wherein the pre-reacted mixture of HENB-MDI further comprises excess, unreacted MDI.
E27. The ROMP composition of any one of E1-E26, wherein the at least one adhesion promoter composition is present in an amount ranging from 0.05 to 15 wt. % (e.g., 0.1 to 13 wt. %, 0.5 to 10 wt. %, 1 to 8 wt. %, 2 to 6 wt. %, 3 to 5 wt. %), based on the total weight of the ROMP composition.
E28. The ROMP composition of E13, wherein the at least one adhesion promoter composition comprises, consists essentially of, or consists of the composition comprising at least one compound containing at least two isocyanate groups and at least one compound comprising a heteroatom-containing functional group with a metathesis active olefin and the at least one acid-functionalized polyolefin,
wherein the at least one acid-functionalized polyolefin is present in an amount ranging from 0.025 to 10 wt. % (e.g., 0.5 to 9 wt. %, 1 to 8 wt. %, 2 to 7 wt. %, 3 to 6 wt. %, 4 to 5 wt. %), based on the total weight of the ROMP composition,
wherein the composition comprising at least one compound containing at least two isocyanate groups and at least one compound comprising a heteroatom-containing functional group with a metathesis active olefin is present in an amount ranging from 0.025 to 5 wt. % (e.g., 0.1 to 4 wt. %, 0.5 to 3 wt. %. I to 2 wt. %), based on the total weight of the ROMP composition.
E29. The ROMP composition of E26, wherein the composition comprising at least one compound containing at least two isocyanate groups and at least one compound comprising a heteroatom-containing functional group with a metathesis active olefin is a pre-reacted mixture of liquid MDI and 2-hydroxyethyl bicycle[2.2.1]hept-2-ene-carboxylate (HENB),
wherein the at least one acid-functionalized polyolefin is a polybutadiene comprising maleic anhydride.
E30. The ROMP composition of E29, wherein the pre-reacted mixture of liquid MDI and HENB further comprises excess, unreacted MDI.
E31. The ROMP composition of any one of E l-E14, wherein the at least one adhesion promoter composition comprises, consists essentially of or consists of at least one acid-functionalized polyolefin and at least one polyoctenamer,
wherein the at least one acid-functionalized polyolefin is present in an amount ranging from 0.025 to 10 wt. % (e.g., 0.5 to 9 wt. %, 1 to 8 wt. %, 2 to 7 wt. %, 3 to 6 wt. %, 4 to 5 wt. %), based on the total weight of the ROMP composition,
wherein the at least one polyoctenamer is present in an amount ranging from 0.025 to 5 wt. % (e.g., 0.1 to 4 wt. %, 0.5 to 3 wt. %, i to 2 wt. %), based on the total weight of the ROMP composition.
E32. The ROMP composition of any one of E1-E31, wherein the at least one plasticizer compound is selected from the group consisting of a polybutene oil, a polyalphaolefin oil, a hydrocarbon resin, and mixtures thereof.
E33. The ROMP composition of E32, wherein the at least one plasticizer compound is a polybutene oil.
E34. The ROMP composition of E32 or E33, wherein the at least one plasticizer compound is present in an amount ranging from 1 to 40 wt. % (e.g., 5 to 35 wt. %, 10 to 30 wt. %, 25 to 30 wt. %), based on the total weight of the ROMP composition.
E35. The ROMP composition of any one of E1-E34, wherein the at least one rubber toughener compound is selected from the group consisting of a poly(styrene-ethylene-butylene-styrene), an ethylene-propylene copolymer, an ethylene-propylene diene terpolymer, and mixtures thereof.
E36. The ROMP composition of E35, wherein the at least one rubber toughener compound is a poly(styrene-ethylene-butylene-styrene).
E37. The ROMP composition of E35 or E36, wherein the at least one rubber toughener compound is present in an amount ranging from 0.01 to 30 wt. % (e.g., 0.1 to 25 wt. %, 1 to 20 wt. %, 5 to 15 wt. %, 7 to 12 wt. %), based on the total weight of the ROMP composition.
E38. The ROMP composition of any one of E1-E37, further comprising, consisting essentially of, or consisting of at least one additive.
E39. The ROMP composition of E38, wherein the at least one additive is selected from the group consisting of gel modification additives, hardness modulators, antioxidants, antiozonants, stabilizers, crosslinkers, fillers, binders, coupling agents, thixotropes, wetting agents, biocides, additional plasticizers, chain terminating agent, pigments, flame retardants, dyes, fibers, and reinforcement materials.
E40. The ROMP composition of any one of E38 or E39, wherein the at least one additive is present in the ROMP composition in an amount ranging from 0.001 to 85 wt. % (e.g., 0.01 to 75 wt. %, 0.1 to 65 wt. %, 1 to 55 wt. %, 5 to 45 wt. %, 10 to 35 wt. %, 15 to 25 wt. %), based on the total weight of the ROMP composition.
E41. A ROMP polymer, comprising the reaction product of the ROMP composition of any one of E1-E40, wherein the ROMP composition is subjected to conditions effective to polymerize the ROMP composition.
E42. A ROMP polymer composite, comprising the reaction product of the ROMP composition of any one of E1-E40, wherein the ROMP composition is subjected to conditions effective to polymerize the ROMP composition.
E43. A thermal insulation material, comprising the ROMP composition of any one of E1-E40, the ROMP polymer of E41, or the ROMP polymer composite of E42.
E44. The ROMP polymer of E41, the ROMP polymer composite of E42, or the thermal insulation material of E43, wherein the ROMP polymer, polymer composite, and thermal insulation material have, independent of one another, a thermal conductivity at a mean temperature of 25° C. of less than 0.180 W/m-K (e.g., less than 0.170, less than 0.165, less than 0.160).
E45. The ROMP polymer of E41, the ROMP polymer composite of E42, or the thermal insulation material of E43, wherein the ROMP polymer, polymer composite, and thermal insulation material have, independent of one another, a pull-off adhesion strength to fusion bonded epoxy (FBE) greater than 2 MPa (e.g., greater than 3, greater than 4, greater than 5).
E46. The ROMP polymer, the ROMP polymer composite, or the thermal insulation material of E45, wherein the FBE is PipcClad HOT 150.
E47. A method of coating, encasing, or insulating at least a portion of at least one surface of an object with the ROMP polymer of E41 or ROMP polymer composite of E42, comprising:
combining the cyclic olefin composition, the catalyst composition, the at least one adhesion promoter, the at least one plasticizer compound, and the rubber toughener compound to form the ROMP composition;
contacting the ROMP composition with at least a portion of at least one surface of the object; and subjecting the ROMP composition to conditions effective to polymerize the ROMP composition to form a ROMP polymer or ROMP polymer composite.
E48. A method of coating, encasing, or insulating at least a portion of at least one surface of an object with the thermal insulation material of E43, comprising:
combining the cyclic olefin composition, the catalyst composition, the at least one adhesion promoter, the at least one plasticizer compound, and the rubber toughener compound to form the ROMP composition:
contacting the ROMP composition with at least a portion of at least one surface of the object; and
subjecting the ROMP composition to conditions effective to polymerize the ROMP composition to form a ROMP polymer or ROMP polymer composite,
wherein the ROMP polymer or the ROMP polymer composite is the thermal insulation material.
E49. The method of E47 of E48, wherein the object is selected from the group consisting of a pipe, pipeline, pipe fitting, hose, hose fitting, tank, container, drum, manifold, riser, field joint, a subsea Christmas tree, jumper, spool piece, pipeline end termination, pipeline end manifold, robotic part, a robotic device, a robotic vehicle, wellhead equipment, a subsea dog house, and a combination thereof.
E50. An article of manufacture comprising an object, wherein at least a portion of at least one surface of the object is coated or insulated with the ROMP polymer of E41, the ROMP polymer composite of E42, or the thermal insulation material of E43.
E51. The article of manufacture of E50, wherein the object is selected from the group consisting of a pipe, pipeline, pipe fitting, hose, hose fitting, tank, container, drum, manifold, riser, field joint, a subsea Christmas tree, jumper, spool piece, pipeline end termination, pipeline end manifold, robotic part, a robotic device, a robotic vehicle, wellhead equipment, a subsea dog house, and combinations thereof.

### EXPERIMENTAL

In the following examples, efforts have been made to ensure accuracy with respect to numbers used (e.g., amounts, temperature, etc.) but some experimental error and deviation should be accounted for. Unless indicated otherwise, temperature is in degrees Celsius (° C.), pressure is at or near atmospheric, viscosity is in centipoise (cP). Additives added to the ROMP compositions are reported as ppm, which is defined as the weight in grams of additive per million grams of cyclic olefin composition, or as phr, which is defined as the weight in grams of the additive per hundred grams of cyclic olefin composition.

The following examples are to be considered as not being limiting of the invention as described herein, and are instead provided as representative examples of compositions of the invention and methods for their use, and articles made from such compositions and methods.

### EXAMPLES

### Materials and Methods

All glassware was oven dried and reactions were performed under ambient conditions unless otherwise noted. All solvents and reagents were purchased from commercial suppliers and used as received unless otherwise noted.

Cyclic olefin composition “DCPD” was obtained from Cymetech Corporation (ULTRENE™ 99) and is typically >99% dicyclopentadiene (DCPD). Cyclic olefin composition “DCPD-6T” was obtained from Cymetech Corporation (ULTRENE™ 99-6) and is typically >91% DCPD and 5-9% tricyclopentadiene (TCPD). Cyclic olefin compositions containing higher amounts of TCPD were prepared as generally described in U.S. Pat. No. 4,899,005. Cyclic olefin composition “DCPD-6ENB” was prepared by blending ULTRENE™ 99 and 5-ethylidene-2-norbornene (ENB) to a final 6 wt % ENB. ENB was obtained from Nippon Chemical Texas Inc. Indopol H100 and Indopol H300 were obtained from Ineos. Vistalon 501, Vistalon 3702, and Spectrasyn 10 were obtained from ExxonMobil. Kraton 1650 was obtained from Kraton. Vestenamer 8012, Vestenamer CS10 (powder form), Polyvest EP MA 100, and Polyvest STE-60 were obtained from Evonik. Ricobond 1731 was obtained from Cray Valley. HENB-MDI adhesion promoter was prepared as generally described in U.S. Pat. No. 9,527,982 B2. Mondur MLQ was obtained from Covestro. Octadecyl 3-(3,5-di-tert-butyl-4-hydroxyphenyl)propionate was obtained from BASF (Irganox® 1076) or M Chemical (GUARD DOG™ 1076). Vinyl norbornene was obtained from JX Nippon. Triphenylphosphine was used as received from PMC Organometallix. Black pigment (PC-80002) and Burnt Orange (PC-60109) were obtained from American Colors. Crystal Plus 500 FG mineral oil was obtained from STE Oil Company, Inc. CAB-O-SIL® TS610 fumed silica was obtained from Cabot Corporation.

Metal carbene olefin metathesis catalysts were purchased from Umicore and include [1,3-bis-(2,4,6-trimethylphenyl)-2-imidazolidinylidene]dichloro(3-methyl-2-butenylidene)(tricyclohexylphosphine)ruthenium(II) (Umicore Grubbs Catalyst M207) and [1,3-bis(2,4,6-trimethylphenyl)-2-imidazolidinylidene]dichloro(3-phenyl-1H-inden-1-ylidene)(triphenylphosphine)ruthenium(II) (Umicore Grubbs Catalyst M200). Catalyst Composition (A) was prepared by suspending Umicore Grubbs Catalyst M207 (0.7 weight percent) in Crystal Plus 500 FG containing 2 weight percent CAB-O-SIL® TS610. Catalyst Composition (B) was prepared by suspending Umicore Grubbs Catalyst M200 (0.75 weight percent) in Crystal Plus 500 FG containing 2 weight percent CAB-O-SIL® TS610.

### General Procedure

The cyclic olefin composition was added to an appropriate size mixing vessel and then each additive was individually added and mixed into the cyclic olefin composition until the mixture was fully homogeneous. With the complete formulation in hand, 100-1000 grams of resin was added to vessel and warmed to temperature 25-40° C. Then the Catalyst Composition was added with stirring and the mixture was placed into an oven or oil bath at desired temperature of 40-50° C. and allowed to cure. In cases where a prism was desired to obtain test samples for thermomechanical analysis, the catalyzed mixture was added to 2.5″×2.5″×12″ aluminum rectangular prism mold that was pre-equilibrated at 50° C. The mold was then placed into an oven set at 50° C. and allowed to cure.

Thermal conductivity was determined by ASTM C518 at an average temperature of 25° C. (30° C. and 20° C. boundaries) using a Vespel or polycarbonate standard. Thermal conductivity values are from a single or an average of two sample replicates. Tensile testing was performed per IS0527-2 Type 1B on 2-6 specimens and reported values are from a single or an average of 2-5 sample replicates. Impact strength was determined by ASTM D256 on 3-5 specimens conditioned at 23±2° C. and 50%±10% relative humidity for at least 40 h, after which they were transferred to a freezer kept at −18° C. for at least 24 h. The impact strength values are from a single or an average of 2-4 sample replicates.

### Formulation Components

TABLE 1

| | |
|---|---|
| A | Octadecyl 3-(3,5-di-tert-butyl-4- |
| | hydroxyphenyl)propionate |
| B | Indopol H100 |
| C | Indopol H300 |
| D | Kraton 1650 |
| E | Vistalon 501 |
| F | Vistalon 3702 |
| G | Spectrasyn 10 |
| H | Vestenamer 8012 |
| I | Vestenamer CS10 |
| J | HENB-MDI |
| K | Ricobond 1731 |
| L | Polyvest EP MA 100 |
| M | Polyvest STE-60 |
| N | Mondur MLQ |
| O | Triphenylphosphine |
| P | Vinyl norbornene |
| Q | Burnt Orange PC-60109 |
| R | Carbon Black PC-80002 |
| S | Catalyst Composition (A) |
| T | Catalyst Composition (B) |

### Formulations (Values in Phr of Cyclic Olefin)

TABLE 2

| | Cyclic | | | | | | | | | | | | | | | | | | | | |
|---|---|---|---|---|---|---|---|---|---|---|---|---|---|---|---|---|---|---|---|---|---|
| # | Olefin | A | B | C | D | E | F | G | H | I | J | K | L | M | N | O | P | Q | R | S | T |
| 1 | DCPD | 1 | 30 | | | | | | | | | | | | | | | | | 2 | |
| 2 | DCPD | 1 | 35 | | 15 | | | | 1 | | 4 | | | | | 0.05 | | | | 2 | |
| 3 | DCPD | 1 | 35 | | 15 | | | | 1 | | | | 4 | | | 0.05 | | | | 2 | |
| 4 | DCPD | 1 | 35 | | 15 | | | | | 1 | 4 | | | | | 0.05 | | | | 2 | |
| 5 | DCPD-6T | 1 | 2 | | | | | | | | | | | | | | | | | 2 | |
| 6 | DCPD-6T | 1 | 5 | | | | | | | | | | | | | | | | | 2 | |
| 7 | DCPD-6T | 1 | 10 | | 15 | | | | | | 2 | | | | | | | | | 2 | |
| 8 | DCPD-6T | 1 | 10 | | | | | | | | | | | | | | | | | 2 | |
| 9 | DCPD-6T | 1 | 15 | | 15 | | | | 5 | | 2 | | | | | | | | | 2 | |
| 10 | DCPD-6T | 1 | 15 | | 15 | | | | | | 4 | | | | | | | | | 2 | |
| 11 | DCPD-6T | 1 | 15 | | 15 | | | | | | | | 6 | | | 0.05 | | | | 2 | |
| 12 | DCPD-6T | 1 | 20 | | 15 | | | | 5 | | 2 | | | | | | | | | 2 | |
| 13 | DCPD-6T | 1 | 20 | | 15 | | | | | 1 | | | 6 | | | 0.05 | | | | 2 | |
| 14 | DCPD-6T | 1 | 20 | | 15 | | | | | | 4 | | | | | | | | | 2 | |
| 15 | DCPD-6T | 1 | 20 | | | | | | | | | | | | | | | | | 2 | |
| 16 | DCPD-6T | 1 | 25 | | 15 | | | | 5 | | 2 | | | | | | | | | 2 | |
| 17 | DCPD-6T | 1 | 25 | | 15 | | | | | 1 | | | 6 | | | 0.05 | | | | 2 | |
| 18 | DCPD-6T | 1 | 25 | | 15 | | | | | | 2 | | | | | | | | | 2 | |
| 19 | DCPD-6T | 1 | 25 | | 15 | | | | | | 4 | | | | | | | | | 2 | |
| 20 | DCPD-6T | 1 | 30 | | 10 | | | | 5 | | 2 | | | | | | | | | 2 | |
| 21 | DCPD-6T | 1 | 30 | | 10 | | | | | | 2 | | | | | | | | | 2 | |
| 22 | DCPD-6T | 1 | 30 | | 15 | | | | 2.5 | | 2 | | | | | | | | | 2 | |
| 23 | DCPD-6T | 1 | 30 | | 15 | | | | 2.5 | | 4 | | | | | | | | | 2 | |
| 24 | DCPD-6T | 1 | 30 | | 15 | | | | 5 | | 2 | | | | | | | | | 2 | |
| 25 | DCPD-6T | 1 | 30 | | 15 | | | | 5 | | 4 | | | | | | | | | 2 | |
| 26 | DCPD-6T | 1 | 30 | | 15 | | | | | 1 | | | 6 | | | 0.05 | | | | 2 | |
| 27 | DCPD-6T | 1 | 30 | | 15 | | | | | | 2 | | | | | | | 0.5 | | 2 | |
| 28 | DCPD-6T | 1 | 30 | | 15 | | | | | | 2 | | | | | | | | | 2 | |
| 29 | DCPD-6T | 1 | 30 | | 15 | | | | | | 3 | | | | | | | | | 2 | |
| 30 | DCPD-6T | 1 | 30 | | 15 | | | | | | 4 | | | | | | | | | 2 | |
| 31 | DCPD-6T | 1 | 30 | | | | | | | | | | | | | | | | | 2 | |
| 32 | DCPD-6T | 1 | 31.5 | | 10 | | | | 5 | | 2 | | | | | | | | | 2 | |
| 33 | DCPD-6T | 1 | 31.5 | | 10 | | | | 5 | | 2.1 | | | | | | | | | 2 | |
| 34 | DCPD-6T | 1 | 35 | | 10 | | | | 5 | | 4 | | | | | | | | | 2 | |
| 35 | DCPD-6T | 1 | 35 | | 10 | | | | | 1 | 2 | | | | | | | | | 2 | |
| 36 | DCPD-6T | 1 | 35 | | 10 | | | | | 1 | 4 | | | | | | | | | 2 | |
| 37 | DCPD-6T | 1 | 35 | | 15 | | | | 1 | | 4 | | | | | 0.05 | | | | 2 | |
| 38 | DCPD-6T | 1 | 35 | | 15 | | | | 2.5 | | 4 | | | | | 0.05 | 0.05 | | | 2 | |
| 39 | DCPD-6T | 1 | 35 | | 15 | | | | 2.5 | | 4 | | | | | | | | | 1 | 2 |
| 40 | DCPD-6T | 1 | 35 | | 15 | | | | 2.5 | | 4 | | | | | | | | | 1.5 | 0.5 |
| 41 | DCPD-6T | 1 | 35 | | 15 | | | | 2.5 | | 4 | | | | | | | | | 1.6 | 0.4 |
| 42 | DCPD-6T | 1 | 35 | | 15 | | | | 2.5 | | 4 | | | | | | | | | 1.8 | 0.2 |
| 43 | DCPD-6T | 1 | 35 | | 15 | | | | 2.5 | | 4 | | | | | | | | | 2 | |
| 44 | DCPD-6T | 1 | 35 | | 15 | | | | 5 | | 2 | | | | | | | | | 2 | |
| 45 | DCPD-6T | 1 | 35 | | 15 | | | | | 1 | 4 | | | | | 0.05 | 0.05 | | 0.06 | 2 | |
| 46 | DCPD-6T | 1 | 35 | | 15 | | | | | 1 | 4 | | | | | 0.05 | 0.05 | | | 2 | |
| 47 | DCPD-6T | 1 | 35 | | 15 | | | | | 1 | 4 | | | | | 0.05 | | | 0.06 | 2 | |
| 48 | DCPD-6T | 1 | 35 | | 15 | | | | | 1 | 4 | | | | | 0.05 | | | | 2 | |
| 49 | DCPD-6T | 1 | 35 | | 15 | | | | | 1 | 4 | | | | | | | | | 2 | |
| 50 | DCPD-6T | 1 | 35 | | 15 | | | | | 1 | | 2 | | | | 0.05 | | | | 2 | |
| 51 | DCPD-6T | 1 | 35 | | 15 | | | | | 1 | | 6 | | | | 0.05 | | | | 2 | |
| 52 | DCPD-6T | 1 | 35 | | 15 | | | | | 1 | | | 4 | | | 0.05 | | | | 2 | |
| 53 | DCPD-6T | 1 | 35 | | 15 | | | | | 1 | | | 6 | | | 0.05 | | | | 2 | |
| 54 | DCPD-6T | 1 | 35 | | 15 | | | | | 1 | | | 8 | | | 0.05 | | | | 2 | |
| 55 | DCPD-6T | 1 | 35 | | 15 | | | | | 1 | | | | 6 | | 0.05 | | | | 2 | |
| 56 | DCPD-6T | 1 | 35 | | 15 | | | | | 1 | | | | | 4 | 0.05 | | | 0.06 | 2 | |
| 57 | DCPD-6T | 1 | 35 | | 15 | | | | | 1 | | | | | 4 | 0.05 | | | | 2 | |
| 58 | DCPD-6T | 1 | 35 | | 15 | | | | | 1 | | | | | | | | | | 2 | |
| 59 | DCPD-6T | 1 | 35 | | 15 | | | | | 1.5 | 4 | | | | | 0.05 | 0.05 | | 0.06 | 2 | |
| 60 | DCPD-6T | 1 | 35 | | 15 | | | | | 1.5 | 4 | | | | | 0.05 | 0.05 | | | 2 | |
| 61 | DCPD-6T | 1 | 35 | | 15 | | | | | 1.5 | 4 | | | | | 0.05 | | | 0.06 | 2 | |
| 62 | DCPD-6T | 1 | 35 | | 15 | | | | | 1.5 | 4 | | | | | 0.05 | | | | 2 | |
| 63 | DCPD-6T | 1 | 35 | | 15 | | | | | 1.5 | | | | | 4 | 0.05 | | | 0.06 | 2 | |
| 64 | DCPD-6T | 1 | 35 | | 15 | | | | | 1.5 | | | | | 4 | 0.05 | | | | 2 | |
| 65 | DCPD-6T | 1 | 35 | | 15 | | | | | 2 | 4 | | | | | 0.05 | 0.05 | | 0.06 | 2 | |
| 66 | DCPD-6T | 1 | 35 | | 15 | | | | | 2 | 4 | | | | | 0.05 | 0.05 | | | 2 | |
| 67 | DCPD-6T | 1 | 35 | | 15 | | | | | 2 | 4 | | | | | 0.05 | | | 0.06 | 2 | |
| 68 | DCPD-6T | 1 | 35 | | 15 | | | | | 2 | 4 | | | | | 0.05 | | | | 2 | |
| 69 | DCPD-6T | 1 | 35 | | 15 | | | | | 2 | 4 | | | | | | | | | 2 | |
| 70 | DCPD-6T | 1 | 35 | | 15 | | | | | 2 | | | | | 4 | 0.05 | | | 0.06 | 2 | |
| 71 | DCPD-6T | 1 | 35 | | 15 | | | | | 2 | | | | | 4 | 0.05 | | | | 2 | |
| 72 | DCPD-6T | 1 | 35 | | 15 | | | | | 2.5 | 4 | | | | | 0.03 | | | | 2 | |
| 73 | DCPD-6T | 1 | 35 | | 15 | | | | | 2.5 | 4 | | | | | 0.05 | 0.03 | | | 2 | |
| 74 | DCPD-6T | 1 | 35 | | 15 | | | | | 2.5 | 4 | | | | | 0.05 | 0.05 | 0.2 | | 2 | |
| 75 | DCPD-6T | 1 | 35 | | 15 | | | | | 2.5 | 4 | | | | | 0.05 | 0.05 | 0.3 | | 2 | |
| 76 | DCPD-6T | 1 | 35 | | 15 | | | | | 2.5 | 4 | | | | | 0.05 | 0.05 | 0.5 | | 2 | |
| 77 | DCPD-6T | 1 | 35 | | 15 | | | | | 2.5 | 4 | | | | | 0.05 | 0.05 | | 0.06 | 2 | |
| 78 | DCPD-6T | 1 | 35 | | 15 | | | | | 2.5 | 4 | | | | | 0.05 | 0.05 | | 0.3 | 2 | |
| 79 | DCPD-6T | 1 | 35 | | 15 | | | | | 2.5 | 4 | | | | | 0.05 | 0.05 | | | 2 | |
| 80 | DCPD-6T | 1 | 35 | | 15 | | | | | 2.5 | 4 | | | | | 0.05 | | | 0.06 | 2 | |
| 81 | DCPD-6T | 1 | 35 | | 15 | | | | | 2.5 | 4 | | | | | 0.05 | | | | 2 | |
| 82 | DCPD-6T | 1 | 35 | | 15 | | | | | 2.5 | 4 | | | | | | 0.03 | | | 2 | |
| 83 | DCPD-6T | 1 | 35 | | 15 | | | | | 2.5 | 4 | | | | | | 0.05 | | | 2 | |
| 84 | DCPD-6T | 1 | 35 | | 15 | | | | | 2.5 | 4 | | | | | | | | | 2 | |
| 85 | DCPD-6T | 1 | 35 | | 15 | | | | | 2.5 | | | | | 4 | 0.05 | | | 0.06 | 2 | |
| 86 | DCPD-6T | 1 | 35 | | 15 | | | | | 2.5 | | | | | 4 | 0.05 | | | | 2 | |
| 87 | DCPD-6T | 1 | 35 | | 15 | | | | | | 2 | | | | | | | | | 2 | |
| 88 | DCPD-6T | 1 | 35 | | 15 | | | | | | 4 | | | | | 0.05 | | | | 2 | |
| 89 | DCPD-6T | 1 | 35 | | 15 | | | | | | 4 | | | | | | | | | 2 | |
| 90 | DCPD-6T | 1 | 35 | | 15 | | | | | | | 1 | | | | 0.05 | | | | 2 | |
| 91 | DCPD-6T | 1 | 35 | | 15 | | | | | | | 6 | | | | 0.05 | | | | 2 | |
| 92 | DCPD-6T | 1 | 35 | | 15 | | | | | | | | 1 | | | 0.05 | | | | 2 | |
| 93 | DCPD-6T | 1 | 35 | | 15 | | | | | | | | 6 | | | 0.05 | | | | 2 | |
| 94 | DCPD-6T | 1 | 35 | | | 5 | | | | 1 | | | | | | | | | | 2 | |
| 95 | DCPD-6T | 1 | 35 | | | 10 | | | | 1 | | | | | | | | | | 2 | |
| 96 | DCPD-6T | 1 | 35 | | | | 3 | | | 1 | | | | | | | | | | 2 | |
| 97 | DCPD-6T | 1 | 35 | | | | 4 | | | 1 | | | | | | | | | | 2 | |
| 98 | DCPD-6T | 1 | 35 | | | | | | | | | | | | | | | | | 1.5 | 0.5 |
| 99 | DCPD-6T | 1 | 35 | | | | | | | | | | | | | | | | | 2 | |
| 100 | DCPD-6T | 1 | 40 | | 15 | | | | 2.5 | | 4 | | | | | | | | | 2 | |
| 101 | DCPD-6T | 1 | 40 | | 15 | | | | 5 | | 2 | | | | | | | | | 2 | |
| 102 | DCPD-6T | 1 | 40 | | 15 | | | | | 1 | | | | | | | | | | 2 | |
| 103 | DCPD-6T | 1 | 40 | | 15 | | | | | | 2 | | | | | | | | | 2 | |
| 104 | DCPD-6T | 1 | 40 | | | | | | | | | | | | | | | | | 2 | |
| 105 | DCPD-6T | 1 | 45 | | 15 | | | | 2.5 | | 4 | | | | | | | | | 2 | |
| 106 | DCPD-6T | 1 | 45 | | 15 | | | | | 1 | | | | | | | | | | 2 | |
| 107 | DCPD-6T | 1 | 45 | | 15 | | | | | | 2 | | | | | | | | | 2 | |
| 108 | DCPD-6T | 1 | 50 | | 15 | | | | 2.5 | | 4 | | | | | | | | | 2 | |
| 109 | DCPD-6T | 1 | 50 | | 15 | | | | | 1 | | | | | | | | | | 2 | |
| 110 | DCPD-6T | 1 | 50 | | 15 | | | | | | 2 | | | | | | | | | 2 | |
| 111 | DCPD-6T | 1 | 55 | | 15 | | | | | 1 | | | | | | | | | | 2 | |
| 112 | DCPD-6T | 1 | | 30 | 15 | | | | | | 2 | | | | | | | 0.5 | | 2 | |
| 113 | DCPD-6T | 1 | | 30 | 15 | | | | | | 2 | | | | | | | | | 2 | |
| 114 | DCPD-6T | 1 | | | 10 | | | | 5 | | | | | | | | | | | 2 | |
| 115 | DCPD-6T | 1 | | | 15 | | | 35 | | 1 | | | | | | | | | | 2 | |
| 116 | DCPD-6T | 1 | | | 15 | | | | 2.5 | | | | | | | | | | | 2 | |
| 117 | DCPD-6T | 1 | | | 15 | | | | 5 | | 2 | | | | | | | | | 2 | |
| 118 | DCPD-6T | 1 | | | 15 | | | | | | | | 6 | | | 0.05 | | | | 2 | |
| 119 | DCPD-6T | 1 | | | 15 | | | | | | | | | | | | | | | 2 | |
| 120 | DCPD-6T | 1 | | | | | | | | | | | | | | | | | | 2 | |
| 121 | DCPD-6T | 1 | 35 | | 15 | | | | | 1 | | | | | | 0.05 | | | | 2 | |
| 122 | DCPD-6T | | 30 | | | | | | | | | | | | | | | | | 2 | |
| 123 | DCPD-6T | 1 | 35 | | 15 | | | | | 1 | 4 | | | | | 0.02 | | | | 2 | |
| 124 | DCPD-6T | 1 | 35 | | 15 | | | | | 1 | | | | | | 0.02 | | | | 2 | |
| 125 | DCPD-6T | 1 | 35 | | 15 | | | | | 1 | | | 1 | | | 0.05 | | | | 2 | |
| 126 | DCPD-6T | 1 | 35 | | 10 | | | | | 5 | | | 2 | | | 0.05 | | | | 2 | |
| 127 | DCPD-6T | 1 | 35 | | 15 | | | | | | | | 2 | | | 0.05 | | | | 2 | |
| 128 | DCPD-6T | 1 | 35 | | 15 | | | | | 1 | | | 2 | | | 0.05 | | | | 2 | |
| 129 | DCPD-6T | 1 | 35 | | 15 | | | | | 2 | | | 1 | | | 0.05 | | | | 2 | |
| 130 | DCPD-6T | 1 | 35 | | 15 | | | | | 2 | | | 2 | | | 0.05 | | | | 2 | |
| 131 | DCPD-6T | 1 | 35 | | 10 | | | | | 1 | | | 2 | | | 0.05 | | | | 2 | |
| 132 | DCPD-6T | 1 | 35 | | 10 | | | | | 3 | | | 2 | | | 0.05 | | | | 2 | |
| 133 | DCPD-6T | 1 | 35 | | 15 | | | | | | | 2 | | | | 0.05 | | | | 2 | |
| 134 | DCPD-6T | 1 | 35 | | 15 | | | | | 1 | | 1 | | | | 0.05 | | | | 2 | |
| 135 | DCPD-6T | 1 | 35 | | 15 | | | | | 2 | | 1 | | | | 0.05 | | | | 2 | |
| 136 | DCPD-6T | 1 | 35 | | 15 | | | | | 2 | | 2 | | | | 0.05 | | | | 2 | |
| 137 | DCPD-6ENB | 1 | 35 | | 18 | | | | | | 4 | | | | | | | | | 2 | |
| 138 | DCPD-6ENB | 1 | 35 | | 18 | | | | | 1 | 4 | | | | | | | | | 2 | |
| 139 | DCPD-6ENB | 1 | 35 | | 18 | | | | | | | | 2 | | | | | | | 2 | |
| 140 | DCPD-6ENB | 1 | 35 | | 18 | | | | | 1 | | | 2 | | | | | | | 2 | |

TABLE 3
Measured properties of ROMP polymer Example
1 from U.S. Pat. No. 10,711,090

| Property | Method | Units | Example 1 |
|---|---|---|---|
| Thermal Conductivity | ASTM C518 | W/m · K | 0.175 |
| Tensile Modulus | ASTM D638 | MPa | 1302 |
| Elongation @ yield | ASTM D638 | % | 7 |
| Elongation @ break | ASTM D638 | % | 179 |
| Impact Strength | ASTM D256 | J/m (ft-lb/in) | 95 (1.78) |

TABLE 4
Measured properties of ROMP polymers cured at 40° C.

| | | Example # | | | | | | | |
|---|---|---|---|---|---|---|---|---|---|
| Property | Units | 120 | 5 | 6 | 8 | 15 | 31 | 104 | 1 |
| Thermal Conductivity | W/m · K | 0.172 | 0.172 | 0.172 | 0.172 | 0.167 | 0.157 | 0.149 | 0.158 |
| Tensile Modulus | MPa | 2046 | 2031 | 1996 | 1929 | 1639 | 972 | 613 | 899 |
| Elongation @ yield | % | 9 | 9 | 9 | 8 | 7 | 3 | 3 | 3 |
| Elongation @ break | % | 11 | 12 | 11 | 10 | 13 | 82 | 15 | 109 |
| Impact Strength (−10° C.) | ft-lbf/in | 1.35 | 1.18 | 1.75 | 1.28 | 2.00 | 0.55 | 0.19 | 0.71 |

TABLE 5
Measured properties of ROMP polymers cured at 50° C.

| | | Example # | | | | | | | |
|---|---|---|---|---|---|---|---|---|---|
| Property | Units | 120 | 5 | 6 | 8 | 15 | 31 | 104 | 1 |
| Thermal Conductivity | W/m · K | 0.171 | 0.168 | 0.169 | 0.172 | 0.163 | 0.155 | 0.151 | 0.158 |
| Tensile Modulus | MPa | 2049 | 2068 | 2038 | 1950 | 1640 | 1069 | 731 | 1019 |
| Elongation @ yield | % | 9 | 9 | 8 | 8 | 8 | 4 | 3 | 4 |
| Elongation @ break | % | 10 | 11 | 10 | 13 | 48 | 98 | 18 | 145 |
| Impact Strength (−10° C.) | ft-lbf/in | 1.31 | 1.50 | 1.36 | 1.46 | 1.49 | 1.20 | 0.24 | 1.53 |

TABLE 6
Measured properties of ROMP polymers cured at 50° C.

| | | Example # | | | | | | | |
|---|---|---|---|---|---|---|---|---|---|
| Property | Units | 18 | 20 | 22 | 23 | 24 | 28 | 43 | 48/49/123 |
| Thermal Conductivity | W/m · K | | | | | 0.156 | 0.155 | | 0.152 |
| Tensile Modulus | MPa | 736 | 535 | 549 | 590 | 438 | 633 | 445 | 413 |
| Elongation @ yield | % | 8.9 | 9.8 | 11.3 | 11.4 | 14.4 | 10.0 | 13.5 | 6.3 |
| Elongation @ break | % | 114.7 | 124 | 124.4 | 117.4 | 192.7 | 135.2 | 132.4 | 84.7 |
| Impact Strength (−10° C.) | ft-lbf/in | 5.24 | 3.79 | 4.69 | 4.45 | 3.93 | 3.81 | 3.43 | 3.21 |

TABLE 7
Measured properties of ROMP polymers cured at 50° C.

| | | Example # | | | | |
|---|---|---|---|---|---|---|
| Property | Units | 50 | 90 | 92 | 125 | 126 |
| Thermal Conductivity | W/m · K | 0.16 | 0.161 | 0.161 | 0.161 | 0.159 |
| Tensile Modulus | MPa | 261 | 263 | 204 | 252 | 332 |
| Elongation @ yield | % | 6.7 | 7.1 | 8.7 | 8.3 | 4.9 |
| Elongation @ break | % | 55.5 | 46.5 | 61.8 | 74.2 | 49.0 |
| Impact Strength (−10° C.) | ft-lbf/in | 2.41 | 2.40 | 2.55 | 2.75 | 2.40 |

TABLE 8
Measured properties of ROMP polymers cured at 50° C.

| | | Example # | | | |
|---|---|---|---|---|---|
| Property | Units | 137 | 138 | 139 | 140 |
| Thermal Conductivity | W/m · K | 0.161 | 0.160 | 0.162 | 0.163 |
| Tensile Modulus | MPa | 367 | 331 | 148 | 160 |
| Elongation @ yield | % | 8.0 | 11.6 | 13.5 | 13.0 |
| Elongation @ break | % | 91.2 | 100.3 | 47.7 | 69.3 |
| Impact Strength | ft-lbf/in | 3.16 | 5.79 | 2.38 | 2.72 |
| (−10° C.) | | | | | |

It is to be understood that while the invention has been described in conjunction with specific embodiments thereof, that the description above as well as the examples that follow are intended to illustrate and not limit the scope of the invention. Other aspects, advantages, and modifications within the scope of the invention will be apparent to those skilled in the art to which the invention pertains.

1. A ROMP composition comprising:
a) a cyclic olefin composition comprising at least one multiunsaturated cyclic olefin;
b) a catalyst composition comprising at least one metal carbene olefin metathesis catalyst;
c) optionally, at least one adhesion promoter;
d) at least one plasticizer compound; and
e) at least one rubber toughener compound,
wherein the cyclic olefin composition does not contain, or is substantially free of, a monounsaturated cyclic olefin,
wherein the at least one multiunsaturated cyclic olefin may be substituted or unsubstituted, wherein the monounsaturated cyclic olefin is selected from 5-octyl-2-norbornene (ONB).

2. The ROMP composition of claim 1, wherein the monounsaturated cyclic olefin is selected from at least one monounsaturated substituted norbornene.

3. The ROMP composition of claim 1, wherein the monounsaturated cyclic olefin is selected from any monounsaturated cyclic olefin.

4. The ROMP composition of claim 1, wherein the cyclic olefin composition comprises 90 to 100 wt. % of the at least one multiunsaturated cyclic olefin and 10 wt. % or less of the monounsaturated cyclic olefin, based on the total weight of the cyclic olefin composition.

5. (canceled)

6. (canceled)

7. (canceled)

8. The ROMP composition of claim 1, wherein the at least one multiunsaturated cyclic olefin is selected from the group consisting of dicyclopentadiene, tricyclopentadiene, 5-vinyl-2-norbornene, 5-ethylidene-2-norbornene, 5-isopropenyl-2-norbornene, 5-propenyl-2-norbornene, 5-butenyl-2-norbornene, and mixtures thereof.

9. (canceled)

10. (canceled)

11. The ROMP composition of claim 1, wherein the cyclic olefin composition comprises 90 to 100 wt. % dicyclopentadiene and 0 to 10 wt. % tricyclopentadiene and/or 5-ethylidene-2-norbornene, based on the total weight of the cyclic olefin composition.

12. The ROMP composition of claim 1, wherein the at least one at least one metal carbene olefin metathesis catalyst is a Group 8 transition metal complex having the structure of formula (1): 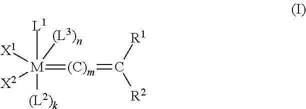
wherein:
M is a Group 8 transition metal;
L¹, L², and L³ are neutral electron donor ligands;
n is 0 or 1, such that L³ may or may not be present;
m is 0, 1, or 2;
k is 0 or 1;
X¹ and X² are anionic ligands; and
R¹ and R² are independently selected from hydrogen, hydrocarbyl, substituted hydrocarbyl, heteroatom-containing hydrocarbyl,
wherein any two or more of X¹, X², L¹, L², L³, R¹, and R² can be taken together to form one or more cyclic groups, and further wherein any one or more of X¹, X², L¹, L², L³, R¹, and R² may be attached to a support, or wherein the at least one at least one metal carbene olefin metathesis catalyst is a Group 8 transition metal complex having the structure of formula (1), wherein:
M is ruthenium;
n is O;
m is O;
k is 1;
L¹ and L² are trisubstituted phosphines independently selected from the group consisting of tri-nbutylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or
L¹ is an N-heterocyclic carbene selected from 1,3-bis(2,4,6-trimethylphenyl)-2-imidazolidinylidene, 1,3-bis(2,6-di-isopropylphenyl)-2-imidazolidinylidene, 1,3-bis(2,4,6-trimethylphenyl)-2-imidazol-2-ylidene, and 1,3-bis(2,6-di-isopropylphenyl)-2-imidazol-2-ylidene;
and L² is a trisubstituted phosphine selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or
L¹ and L² are N-heterocyclic carbenes independently selected from the group consisting of 1,3-bis(2,4,6-trimethylphenyl)-2-imidazolidinylidene, 1,3-bis(2,6-di-isopropylphenyl)-2-imidazolidinylidene, 1,3-bis(2,4,6-trimethylphenyl)-2-imidazol-2-ylidene, and 1,3-bis(2,6-di-isopropylphenyl)-2-imidazol-2-ylidene;
X¹ and X² are chlorine; and
R¹ is hydrogen and R² is phenyl or —CH═C(CH₃)₂; or R¹ and R² are taken together to form an indenylidene moiety.

13. (canceled)

14. The ROMP composition of claim 1, wherein the at least one at least one metal carbene olefin metathesis catalyst is a Group 8 transition metal complex having the structure of formula (VII): 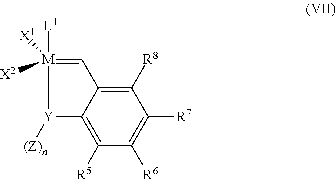
wherein:
M is a Group 8 transition metal;
X¹ and X² are anionic ligands;
L¹ is a neutral electron donor ligand;
Y is a heteroatom selected from N, O, S, and P;
R⁵, R⁶, R⁷, and R⁸ are each, independently, selected from the group consisting of hydrogen, halogen, alkyl, alkenyl, alkynyl, aryl, heteroalkyl, heteroatom containing alkenyl, heteroalkenyl, heteroaryl, alkoxy, alkenyloxy, aryloxy, alkoxycarbonyl, carbonyl, alkylamino, alkylthio, aminosulfonyl, monoalkylaminosulfonyl, dialkylaminosulfonyl, alkylsulfonyl, nitrile, nitro, alkylsulfinyl, trihaloalkyl, perfluoroalkyl, carboxylic acid, ketone, aldehyde, nitrate, isocyanate, hydroxyl, ester, ether, amine, imine, amide, trifluoroamide, sulfide, disulfide, sulfonate, carbamate, silane, siloxane, phosphine, phosphate, borate, or -A-Fn, wherein A is a divalent hydrocarbon moiety selected from alkylene and arylalkylene, wherein the alkyl portion of the alkylene and arylalkylene groups can be linear or branched, saturated or unsaturated, cyclic or acyclic, and substituted or unsubstituted, wherein the aryl portion of the of arylalkylene can be substituted or unsubstituted, and wherein hetero atoms and/or functional groups may be present in either the aryl or the alkyl portions of the alkylene and arylalkylene groups, and Fn is a functional group; and any combination of R⁵, R⁶, R⁷, and R⁸ can be linked to form one or more cyclic groups;
n is 1 or 2, such that n is 1 for the divalent heteroatoms O or S, and n is 2 for the trivalent heteroatoms N or P; and
Z is a group selected from hydrogen, alkyl, aryl, functionalized alkyl, functionalized aryl where the functional group may independently be one or more or the following: alkoxy, aryloxy, halogen, carboxylic acid, ketone, aldehyde, nitrate, isocyanate, hydroxyl, ester, ether, amine, imine, amide, trifluoroamide, sulfide, disulfide, carbamate, silane, siloxane, phosphine, phosphate, or borate; methyl, isopropyl, sec-butyl, t-butyl, neopentyl, benzyl, phenyl and trimethylsilyl; and
wherein any combination or combinations of X¹, X², L¹, V, Z, R⁵, R⁶, R⁷, and R⁸ may be linked to a support.

15. The ROMP composition of claim 1, wherein the at least one adhesion promoter composition is present and is selected from the group consisting of an acid-functionalized polyolefin, a compound containing at least two isocyanate groups, a composition comprising at least one compound containing at least two isocyanate groups and at least one compound comprising a heteroatom-containing functional group with a metathesis active olefin, at least one polyoctenamer, and mixtures thereof.

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. The ROMP composition of claim 1, wherein the at least one adhesion promoter composition is present in an amount ranging from 0.05 to 15 wt. %, based on the total weight of the ROMP composition.

28. (canceled)

29. (canceled)

30. (canceled)

31. (canceled)

32. The ROMP composition of claim 1, wherein the at least one plasticizer compound is selected from the group consisting of a polybutene oil, a polyalphaolefin oil, a hydrocarbon resin, and mixtures thereof.

33. The ROMP composition of claim 32, wherein the at least one plasticizer compound is a polybutene oil.

34. The ROMP composition of claim 32, wherein the at least one plasticizer compound is present in an amount ranging from 1 to 40 wt. %, based on the total weight of the ROMP composition.

35. The ROMP composition of claim 1, wherein the at least one rubber toughener compound is selected from the group consisting of a poly(styrene-ethylene-butylene-styrene), an ethylene-propylene copolymer, an ethylene-propylene diene terpolymer, and mixtures thereof.

36. The ROMP composition of claim 35, wherein the at least one rubber toughener compound is a poly(styrene-ethylene-butylene-styrene).

37. The ROMP composition of claim 35, wherein the at least one rubber toughener compound is present in an amount ranging from 0.01 to 30 wt. %, based on the total weight of the ROMP composition.

38. (canceled)

39. The ROMP composition of claim 1, further comprising at least one additive is selected from the group consisting of gel modification additives, hardness modulators, antioxidants, antiozonants, stabilizers, crosslinkers, fillers, binders, coupling agents, thixotropes, wetting agents, biocides, additional plasticizers, chain terminating agent, pigments, flame retardants, dyes, fibers, and reinforcement materials.

40. (canceled)

41. A ROMP polymer, comprising the reaction product of the ROMP composition of claim 1, wherein the ROMP composition is subjected to conditions effective to polymerize the ROMP composition.

42. (canceled)

43. (canceled)

44. (canceled)

45. (canceled)

46. (canceled)

47. A method of coating, encasing, or insulating at least a portion of at least one surface of an object with the ROMP polymer of claim 41, comprising:
combining the cyclic olefin composition, the catalyst composition, the at least one adhesion promoter, the at least one plasticizer compound, and the rubber toughener compound to form the ROMP composition;
contacting the ROMP composition with at least a portion of at least one surface of the object; and
subjecting the ROMP composition to conditions effective to polymerize the ROMP composition to form a ROMP polymer or ROMP polymer composite.

48. (canceled)

49. (canceled)

50. (canceled)

51. An article of manufacture comprising an object, wherein at least a portion of at least one surface of the object is coated or insulated with the ROMP polymer of claim 41.

52. (canceled)
